(19) United States
(12) Patent Application Publication
(10) Pub. No.: US 2018/0154443 A1
(43) Pub. Date: Jun. 7, 2018

(54) OPTICS, DETECTORS, AND THREE-DIMENSIONAL PRINTING

(71) Applicant: Velo3D, Inc., Campbell, CA (US)

(72) Inventors: Erel MILSHTEIN, Cupertino, CA (US); Benyamin BULLER, Cupertino, CA (US); Alexander BRUDNY, San Jose, CA (US)

(21) Appl. No.: 15/830,470

(22) Filed: Dec. 4, 2017

Related U.S. Application Data
(60) Provisional application No. 62/430,723, filed on Dec. 6, 2016.
(60) Provisional application No. 62/444,150, filed on Jan. 9, 2017.

(51) Int. Cl. B22F 3/105; B29C 64/268; B29C 64/393; B28B 1/00; B28B 17/00; B33Y 30/00; B33Y 50/02; B23K 15/00; B23K 26/03; B23K 26/342

(52) U.S. Cl. CPC B22F 3/1055; B29C 64/268; B29C 64/393; B28B 1/001; B28B 17/0081; B22F 2003/1057; B33Y 50/02; B23K 15/0086; B23K 26/032; B23K 26/342; B33Y 30/00

(57) ABSTRACT

The present disclosure provides three-dimensional (3D) printing methods, apparatuses, software, and systems, some of which utilize one or more detectors that may be used to detect characteristics of the 3D object, e.g., in real-time during its formation. The present disclosure provides methods, apparatuses, software, and systems for generating different cross sections of one or more energy beams used for 3D printing of the 3D object.

### CROSS-REFERENCE

This application claims priority to U.S. Provisional Patent Application Ser. No. 62/430,723, filed Dec. 6, 2016, titled “OPTICS, DETECTORS, AND THREE-DIMENSIONAL PRINTING,” and U.S. Provisional Patent Application Ser. No. 62/444,150, filed Jan. 9, 2017, titled “OPTICS, DETECTORS, AND THREE-DIMENSIONAL PRINTING,” each of which is entirely incorporated herein by reference.

### BACKGROUND

Three-dimensional (3D) printing (e.g., additive manufacturing) is a process for making a three-dimensional (3D) object of any shape from a design. The design may be in the form of a data source such as an electronic data source, or may be in the form of a hard copy. The hard copy may be a two-dimensional representation of a 3D object. The data source may be an electronic 3D model. 3D printing may be accomplished through an additive process in which successive layers of material are laid down one on top of each other. This process may be controlled (e.g., computer controlled, manually controlled, or both). A 3D printer can be an industrial robot.

3D printing can generate custom parts quickly and efficiently. A variety of materials can be used in a 3D printing process including elemental metal, metal alloy, ceramic, elemental carbon, or polymeric material. In a typical additive 3D printing process, a first material-layer is formed, and thereafter, successive material-layers (or parts thereof) are added one by one, wherein each new material-layer is added on a pre-formed material-layer, until the entire designed three-dimensional structure (3D object) is materialized.

3D models may be created utilizing a computer aided design package or via 3D scanner. The manual modeling process of preparing geometric data for 3D computer graphics may be similar to plastic arts, such as sculpting or animating. 3D scanning is a process of analyzing and collecting digital data on the shape and appearance of a real object. Based on this data, 3D models of the scanned object can be produced. The 3D models may include computer-aided design (CAD).

### SUMMARY

A large number of additive processes are currently available. They may differ in the manner layers are deposited to create the materialized structure. They may vary in the material or materials that are used to generate the designed structure. Some methods melt or soften material to produce the layers. Examples for 3D printing methods include selective laser melting (SLM), selective laser sintering (SLS), direct metal laser sintering (DMLS), shape deposition manufacturing (SDM) or fused deposition modeling (FDM). Other methods cure liquid materials using different technologies such as stereo lithography (SLA). In the method of laminated object manufacturing (LOM), thin layers (made inter alia of paper, polymer, metal) are cut to shape and joined together.

At times, the printed 3D object may bend, warp, roll, curl, or otherwise deform during the 3D printing process. Auxiliary supports may be inserted to circumvent the deformation. These auxiliary supports may be subsequently removed from the printed 3D object to produce a desired 3D product (e.g., 3D object). The presence of auxiliary supports may increase the cost and time required to manufacture the 3D object. At times, the requirement for the presence of auxiliary supports hinders (e.g., prevent) formation of cavities and/or ledges in the desired 3D object. The requirement for the presence of auxiliary supports may place constraints on the design of 3D objects, and/or on their respective materialization. In some embodiments, the inventions in the present disclosure facilitate the generation of 3D objects with reduced degree of deformation. In some embodiments, the inventions in the present disclosure facilitate generation of 3D objects that are fabricated with diminished number (e.g., absence) of auxiliary supports (e.g., without auxiliary supports). In some embodiments, the inventions in the present disclosure facilitate generation of 3D objects with diminished amount of design and/or fabrication constraints (referred to herein as “constraint-less 3D object”).

Sometimes, it is desired to control the 3D printing process. For example, it may be desirable to control the transforming energy beam, and/or the microstructure of a 3D object to form a specific type or types of microstructure. In some instances, it is desired to detect the formation of the microstructure of an object. In some instances, it is desired to control the manner in which a microstructure and/or at least a portion of a layer of hardened material is formed. The layer of hardened material may comprise a multiplicity of melt pools. In some instances, it may be desired to detect and/or control one or more characteristics of the melt pool that forms the hardened material as part of the 3D object.

At times, it may be desirable to obtain a smooth surface of the fabricated 3D object. At times, to obtain a smooth surface, it may be desirable to vary (e.g., increase) a time before the transformed material (e.g., entirely) hardens (e.g., solidifies). For example, it may be desirable to vary (e.g., increase) a time at which the transformed material is in at least a partial liquid state. Various methods for prolonging the time prior to (e.g., complete) hardening are delineated. At times, it may be desirable to irradiate an elongated energy beam (e.g., for increasing time before complete hardening of the transformed material).

In some instances, it may be desirable to detect one or more characteristics of the forming 3D object at the irradiation position and/or its vicinity (e.g., in real-time during at least a portion of the 3D printing). For example, it may be desirable to use (e.g., include) a detection system that facilitates contemporaneous focusing of a first energy beam on a target surface, and a second (related) energy beam on the detector. For example, it may be desirable to include a detection system that facilitates contemporaneous focusing of an energy beam on a target surface, and on the detector. For example, the detection system may use aberration-correcting (e.g., achromatic) optics. The detection system may be utilized in (e.g., real time) control of the 3D printing process.

At times, detection speed and/or accuracy are important. The present disclosure delineates various systems, apparatuses, and methodologies in this regard. For example, the present disclosure describes usage of at least one optical fiber that is connected to a detector. For example, an optical fiber bundle having fibers of identical and/or different cross sections. The present disclosure delineates apparatuses, systems, software, and methods that facilitates accomplishing these.

In an aspect described herein are methods, systems, and/or apparatuses for detecting one or more characteristics of the forming 3D object and/or its vicinity. Another aspect of the present disclosure describes methods, systems, and/or apparatuses for facilitating irradiation of an elongated energy beam. Another aspect of the present disclosure describes methods, systems, and/or apparatuses for facilitating contemporaneous focusing of the energy beam.

In another aspect, an apparatus for printing a three-dimensional object (e.g., using 3D printing) comprises: a target surface (e.g., configured to support the three-dimensional object during the printing); an energy source, the energy source (e.g., is configured) to irradiate a pre-transformed material with an energy beam at or adjacent to the target surface to form a transformed material as part of the three-dimensional object (e.g., that is formed by three-dimensional printing), wherein the energy source is disposed adjacent to the target surface; a detector, or a cross section of an optical fiber connected to the detector, that receives (e.g., is configured to receive) a thermal radiation (e.g., black body radiation) emerging from the transformed material, wherein the detector is disposed adjacent to the target surface; and an aberration-correcting optical arrangement (e.g., achromatic optical setup) operatively coupled to the detector, which aberration-correcting arrangement (e.g., achromatic optical setup) comprises one or more optical elements operable to maintain (i) a first focus of the energy beam on the target surface, and (ii) a second focus of at least a portion of the thermal radiation (e.g., black body radiation) on the detector or on the cross section of an optical fiber connected to the detector, wherein the detector is disposed adjacent to the target surface.

In some embodiments, the apparatus is devoid of an f-theta lens. In some embodiments, the aberration-correcting arrangement is at least one member selected from the group consisting of achromatic optics, apochromatic optics, and superachromatic optics. In some embodiments, the aberration-correcting optical arrangement comprises at least one of an achromatic lens, an apochromatic lens, or a superachromatic lens. In some embodiments, the one or more optical elements are configured to maintain (i) and (ii) contemporaneously. In some embodiments, the one or more optical elements are configured to maintain (i) and (ii) substantially simultaneously. In some embodiments, the thermal radiation received by the detector is a blackbody radiation. In some embodiments, the apparatus further comprises at least one optical fiber coupled with the detector. In some embodiments, (ii) comprises at least one controller configured to direct the thermal radiation onto a cross section of the at least one optical fiber. In some embodiments, the cross section is perpendicular to the direction in which the thermal radiation propagates in the optical fiber. In some embodiments, the apparatus further comprises a platform that comprises the target surface. In some embodiments, the platform is configured for translation. In some embodiments, the translation is at least one of horizontal, vertical, or angular translation. In some embodiments, which at least one controller is operatively coupled with the platform and is configured to translate the platform to maintain (i) and (ii). In some embodiments, the aberration-correcting optical arrangement comprises at least one high thermal conductivity optical element. In some embodiments, the at least one high thermal conductivity optical element comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, the at least one high thermal conductivity optical element comprises sapphire. In some embodiments, the one or more optical elements comprise a lens, mirror, or a beam splitter. In some embodiments, the one or more optical elements are configured to translate and/or rotate. In some embodiments, the one or more optical elements comprises a high thermal conductivity optical element. In some embodiments, the one or more optical elements comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, the one or more optical elements are disposed in an optical chamber configured to facilitate separation of the energy beam from an environment external to the optical chamber. In some embodiments, the one or more optical elements is adjustable from an environment external to the optical chamber. In some embodiments, the adjustment uses one or more adjustable levers that extend from an internal environment of the optical chamber to the environment external to the optical chamber. In some embodiments, the adjustment uses a controllable and/or wireless adjustment of the one or more optical elements. In some embodiments, the detector is configured to detect a temperature of a position of (a) a footprint of the energy beam on the pre-transformed material and/or on the target surface, (b) a vicinity of the footprint in (a), or (c) any combination of (a) and (b). In some embodiments, the vicinity of the footprint in (a) extends to at most six fundamental length scales of the footprint of the energy beam in (a). In some embodiments, configured to detect a temperature is indirectly through measurement of at least one characteristic of the returning radiation (e.g., thermal radiation). In some embodiments, the apparatus further comprises an additional detector configured to have indirect view of the target surface. In some embodiments, the at least one controller is configured to control at least one aspect of the printing considering a result of the detector. In some embodiments, the additional detector is configured to sense abrupt and/or intense radiation emitted during the printing. In some embodiments, the intense and/or abrupt radiation results from a splatter, and/or keyhole formation during the printing.

In another aspect, a system for printing a three-dimensional object (e.g., using 3D printing) comprises: a target surface (e.g., configured to support the three-dimensional object during the printing); an energy source that is configured to project an energy beam to transform a pre-transformed material at or adjacent to the target surface to a transformed material as part of the three-dimensional object (e.g., that is formed by three-dimensional printing), wherein the energy source is disposed adjacent to the target surface; a detector that receives (e.g., is configured to receive) a thermal (e.g., black body) radiation emerging from the transformed material directly or through an optical fiber that is connected to the detector, wherein the detector is disposed adjacent to the target surface; an aberration-correcting optical arrangement (e.g., achromatic optical setup) operatively coupled to the detector, which aberration-correcting optical arrangement (e.g., achromatic optical setup) comprises one or more optical elements to maintain (i) a first focus of the energy beam on the target surface, and (ii) a second focus of at least a portion of the thermal (e.g., black body) radiation on the detector or on a cross section of the optical fiber (e.g., wherein the detector is disposed adjacent to the target surface); and at least one controller that is operatively coupled to (e.g., at least one of) the target surface, the energy source, the detector and the aberration-correcting optical arrangement (e.g., achromatic optical setup), and is configured (e.g., programmed) to direct: (i) the energy source to irradiate the pre-transformed material with the energy beam, (ii) the thermal (e.g., black body) radiation to the detector through the aberration-correcting optical arrangement (e.g., achromatic optical setup), and (iii) the aberration-correcting optical arrangement (e.g., achromatic optical setup) to maintain the first focus of the energy beam on the target surface and the second focus of at least the portion of the thermal (e.g., black body) radiation on the detector or on the cross section of the optical fiber connected to the detector.

In some embodiments, the system is devoid of an f-theta lens. In some embodiments, the thermal radiation is a black body radiation. In some embodiments, the aberration-correcting optical arrangement comprises at least one of an achromatic lens, an apochromatic lens, or a superachromatic lens. In some embodiments, to direct the aberration-correcting optical arrangement comprises directing translation of the one or more optical elements. In some embodiments, the directing translation of the one or more optical elements comprises a vertical, a horizontal, or a rotational translation. In some embodiments, the one or more optical elements comprises a lens, mirror, or a beam splitter. In some embodiments, the aberration-correcting optical arrangement comprises a high thermal conductivity optical element. In some embodiments, the high thermal conductivity optical element comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, at least two of (i), (ii), and (iii) are directed by different controllers that are operatively coupled. In some embodiments, at least two of (i), (ii), and (iii) are directed by the same controller. In some embodiments, (ii) comprises the at least one controller configured to direct the at least the portion of the thermal radiation onto the cross section of the optical fiber. In some embodiments, the system further comprises a platform that comprises the target surface. In some embodiments, the at least one controller is operatively coupled with the platform and is configured to translate the platform to maintain (i) and (ii). In some embodiments, the one or more optical elements comprise a lens, mirror, or a beam splitter. In some embodiments, the one or more optical elements are configured to translate and/or rotate. In some embodiments, the one or more optical elements comprises a high thermal conductivity optical element. In some embodiments, the one or more optical elements comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, the one or more optical elements are disposed in an optical chamber configured to facilitate separation of the energy beam from an environment external to the optical chamber. In some embodiments, the one or more optical elements is adjustable from an environment external to the optical chamber. In some embodiments, the adjustment uses one or more adjustable levers that extend from an internal environment of the optical chamber to the environment external to the optical chamber. In some embodiments, the adjustment uses a controllable and/or wireless adjustment of the one or more optical elements. In some embodiments, the detector is configured to detect a temperature of a position of (a) a footprint of the energy beam on the pre-transformed material and/or on the target surface, (b) a vicinity of the footprint in (a), or (c) any combination of (a) and (b). In some embodiments, the vicinity of the footprint in (a) extends to at most six fundamental length scales of the footprint of the energy beam in (a). In some embodiments, configured to detect a temperature is indirectly through measurement of at least one characteristic of the returning radiation (e.g., thermal radiation).

In another aspect, a system for printing a three-dimensional object comprises: a target surface configured to support the three-dimensional object during the printing; an energy source configured to irradiate at least one energy beam that transforms a pre-transformed material to a transformed material to form the three-dimensional object during the printing; a detector configured to receive thermal radiation emerging during the transforming; and an optical arrangement configured to (i) adjust a first focus of the at least one energy beam on the target surface, and (ii) maintain a second focus of at least a portion of the thermal radiation on the detector.

In some embodiments, the thermal radiation is emerging during transformation of the pre-transformed material to a transformed material. In some embodiments, the thermal radiation is emerging from the pre-transformed material during the printing. In some embodiments, the at least one energy beam is a plurality of energy beams. In some embodiments, adjust the first focus of the plurality of energy beams on the target surface is done collectively for at least two energy beams of the plurality of the energy beams. In some embodiments, the at least one energy beam is a plurality of energy beams. In some embodiments, adjustment of the first focus of the plurality of energy beams on the target surface is done individually for at least two energy beams of the plurality of the energy beams. In some embodiments, maintaining the second focus of the at least a portion of the thermal radiation on the detector is by maintaining the second focus of the at least a portion of the thermal radiation on a cross section of an optical fiber operatively coupled to the detector. In some embodiments, operatively coupled to the detector is directly connected to the detector. In some embodiments, the system further comprises at least one controller that is operatively coupled to one or more of the target surface, the energy source, the detector, and the optical arrangement (e.g., at least one element thereof), which at least one controller is configured (e.g., programmed) to direct performance of the following operations: (a) causing the energy source to irradiate the pre-transformed material with the at least one energy beam, which at least the portion of the thermal radiation is directed to the detector through the optical arrangement; (b) adjusting the first focus of the energy beam on the target surface; and (c) adjusting the second focus of the at least the portion of the thermal radiation on the detector using at least one component of the optical arrangement. In some embodiments, the at least one controller causes at least one of the one or more optical elements of the optical arrangement to move to perform (b) and/or (c). In some embodiments, causing the energy source to irradiate comprises activating the energy source to irradiate the at least one energy beam. In some embodiments, the at least one energy beam is a plurality of energy beams. In some embodiments, causing the energy source to irradiate comprises irradiating at least two of the plurality of energy beams sequentially. In some embodiments, the at least one energy beam is a plurality of energy beams. In some embodiments. In some embodiments, causing the energy source to irradiate comprises irradiating at least two of the plurality of energy beams simultaneously. In some embodiments, to move comprises at least one of translation or rotation. In some embodiments, the translation comprises a vertical and/or a horizontal translation. In some embodiments, the at least one controller causes one of the one or more optical elements of the optical arrangement to move in order to perform (b) and/or (c). In some embodiments, the system further comprises a scanner configured to direct the at least one energy beam to translate across the target surface. In some embodiments, the scanner is disposed between the energy source and the target surface. In some embodiments, the scanner is disposed between one or more optical elements of the optical arrangement, and the target surface. In some embodiments, the system further comprises a scanner configured to direct the at least one energy beam to translate across the target surface. In some embodiments, the scanner is operatively coupled with the at least one controller. In some embodiments, the at least one controller is configured to direct the scanner to translate the at least one energy beam across the target surface. In some embodiments, the at least one energy beam is a plurality of energy beams. In some embodiments, the at least one controller is configured to direct the scanner to collectively translate at least two of the plurality of energy beams across the target surface. In some embodiments, the at least one energy beam is a plurality of energy beams. In some embodiments, the at least one controller is configured to direct the scanner to separately translate at least two of the plurality of energy beams across the target surface. In some embodiments, the at least one controller is configured to direct the scanner to coordinate a movement of the one or more optical elements to perform (b) and/or (c). In some embodiments, the optical arrangement is devoid of an f-theta lens. In some embodiments, the optical arrangement comprises at least one of an achromatic lens, an apochromatic lens, or a superachromatic lens. In some embodiments, the optical arrangement comprises a high thermal conductivity optical element. In some embodiments, the high thermal conductivity optical element comprises sapphire. In some embodiments, the at least one controller is configured to direct the at least the portion of the thermal radiation through a filter disposed along a thermal radiation return path to the detector, which thermal radiation return path is from the target surface to the detector. In some embodiments, the system further comprises one or more additional detectors having an associated one or more filters. In some embodiments, the at least one controller is configured to direct the thermal radiation from the thermal radiation return path through the associated one or more filters to the one or more additional detectors. In some embodiments, the one or more additional detectors have an associated thermal radiation peak wavelength sensitivity. In some embodiments, the one or more additional detectors is configured to receive a portion of the energy beam. In some embodiments, the at least one controller is configured to direct the portion of the energy beam to the one or more additional detectors. In some embodiments, the portion of the energy beam is a returning portion from the target surface. In some embodiments, the portion of the energy beam is a deflected portion from the at least one energy source. In some embodiments, the system further comprises a platform that comprises the target surface. In some embodiments, the at least one controller is configured to cause the platform to move to perform (vi). In some embodiments, the at least one controller is configured to direct (b) and/or (c) in real time. In some embodiments, in real time is during a dwell time of the energy beam along: (I) a path, (II) a hatch line forming at least one melt pool, or (III) during formation of a melt pool as part to the three-dimensional object. In some embodiments, the at least one controller uses a control scheme comprising closed loop or open loop control. In some embodiments, the at least one controller uses a control scheme comprising feedback control or feed-forward control. In some embodiments, the system further comprises an additional detector. In some embodiments, the at least one controller is configured to adjust (b) and/or (c) considering a measurement from the first detector and/or the additional detector. In some embodiments, to adjust comprises directing modulating the at least one energy beam, which directing is by the at least one controller. In some embodiments, the additional detector configured to have an indirect view of the thermal radiation emerging from the target surface. In some embodiments, the at least one controller causes the at least one energy beam to traverse across an optical path comprising (I) a first portion between the at least one energy source and one or more optical elements of the optical arrangement, and (II) a second portion between the one or more optical elements and the target surface. In some embodiments, at least one controller causes the at least one energy beam to travel across an optical path by controlling a movement of at least one optical element of the optical arrangement. In some embodiments, the additional detector is configured to receive a deflected portion of the energy beam from (I). In some embodiments, the additional detector is configured to receive a reflected portion of the energy beam from (II), which reflected portion is a returning portion of the energy beam from incidence on the target surface. In some embodiments, the optical arrangement is enclosed by an enclosure, which enclosure comprises an adjustment element that is configured to adjust at least one optical element of the optical arrangement. In some embodiments, the optical arrangement is enclosed by an enclosure, which enclosure comprises an adjustment element operatively coupled with the at least one controller, which at least one controller is configured to alter a position of one or more optical elements of the optical arrangement. In some embodiments, the at least one controller comprises a graphical processing unit (GPU), system-on-chip (SOC), application specific integrated circuit (ASIC), application specific instruction-set processor (ASIPs), programmable logic device (PLD), or field programmable gate array (FPGA). In some embodiments, the at least one controller is configured to direct one or more of (a), (b) and (c) considering a path of the at least one energy beam. In some embodiments, the at least one controller is configured to perform (c) by directing the thermal radiation to an optical fiber connected with the detector. In some embodiments, the at least one controller is configured to maintain the second focus on a cross-section of the optical fiber.

In another aspect, an apparatus for printing a three-dimensional object comprises at least one controller that is operatively coupled to one or more of a platform configured to support the three-dimensional object, an energy source configured to generate at least one energy beam that transforms a pre-transformed material to a transformed material to form the three-dimensional object, a detector, and at least one component of an aberration-correcting optical arrangement, which at least one controller is configured (e.g., programmed) to direct performance of the following operations: (a) causing the energy source to irradiate the pre-transformed material with the at least one energy beam and generate a thermal radiation, which at least a portion of the thermal radiation is directed to the detector through the optical arrangement; (b) adjusting the at least one component to form a first focus of the energy beam on a target surface disposed adjacent to the platform; and (c) adjusting the at least one component to form a second focus of at least the portion of the thermal radiation on a detector.

In some embodiments, the at least one controller causes at least one of the at least one component of an aberration-correcting optical arrangement to move to perform (b) and/or (c). In some embodiments, the at least one controller is configured to adjust the first focus and the second focus simultaneously. In some embodiments, at least one of the at least one component in (b) is different from the at least one component in (c). In some embodiments, at least one of the at least one component in (b) is the same as the at least one component in (c). In some embodiments, adjusting the at least one component to form a second focus of at least the portion of the thermal radiation on a detector is indirectly through an optical fiber. In some embodiments, adjusting the at least one component to form a second focus of at least the portion of the thermal radiation on a detector is indirectly by forming the second focus on a cross section of the optical fiber that is normal to a direction of radiation propagation in the optical fiber. In some embodiments, the aberration-correcting optical arrangement comprises at least one of an achromatic lens, an apochromatic lens, or a superachromatic lens. In some embodiments, the at least one controller is configured to maintain the first focus of the energy beam on the target surface while the second focus of at least the portion of the thermal radiation is on the detector. In some embodiments, causing the energy source to irradiate comprises activating the energy source to irradiate the at least one energy beam. In some embodiments, the at least one energy beam is a plurality of energy beams. In some embodiments, causing the energy source to irradiate comprises irradiating at least two of the plurality of energy beams sequentially. In some embodiments, the at least one energy beam is a plurality of energy beams. In some embodiments, causing the energy source to irradiate comprises irradiating at least two of the plurality of energy beams simultaneously. In some embodiments, to move comprises at least one of translation or rotation. In some embodiments, the translation comprises a vertical and/or a horizontal translation. In some embodiments, the at least one controller causes one of the one or more optical elements of the optical arrangement to move to perform (b) and/or (c). In some embodiments, the apparatus further comprises a scanner configured to direct the at least one energy beam to translate across the target surface. In some embodiments, the scanner is operatively coupled with the at least one controller. In some embodiments, at least one controller is configured to direct the scanner to translate the at least one energy beam across the target surface. In some embodiments, the at least one energy beam is a plurality of energy beams. In some embodiments, the at least one controller is configured to direct the scanner to collectively translate at least two of the plurality of energy beams across the target surface. In some embodiments, the at least one controller is configured to direct the scanner to separately translate at least two of the plurality of energy beams across the target surface. In some embodiments, the at least one controller is configured to direct the scanner to coordinate a movement of the one or more optical elements to perform (b) and/or (c) In some embodiments, the at least one controller is configured to direct the at least the portion of the thermal radiation through a filter disposed along a thermal radiation return path to the detector, which thermal radiation return path is from the target surface to the detector. In some embodiments, the apparatus further comprises one or more additional detectors having an associated one or more filters. In some embodiments, the at least one controller is configured to direct the thermal radiation from the thermal radiation return path through the associated one or more filters to the one or more additional detectors. In some embodiments, the one or more additional detectors have an associated thermal radiation peak wavelength sensitivity. In some embodiments, the one or more additional detectors is configured to receive a portion of the energy beam. In some embodiments, the at least one controller is configured to direct the portion of the energy beam to the one or more additional detectors. In some embodiments, the portion of the energy beam is a returning portion from the target surface. In some embodiments, the portion of the energy beam is a deflected portion from the at least one energy source. In some embodiments, the apparatus further comprises an additional detector. In some embodiments, the at least one controller is configured to adjust (b) and/or (c) considering a measurement from the first detector and/or the additional detector. In some embodiments, to adjust comprises directing modulating the at least one energy beam, which directing is by the at least one controller. In some embodiments, the additional detector configured to have an indirect view of the thermal radiation emerging from the target surface. In some embodiments, the at least one controller causes the at least one energy beam to traverse across an optical path comprising (I) a first portion between the at least one energy source and one or more optical elements of the optical arrangement, and (II) a second portion between the one or more optical elements and the target surface. In some embodiments, at least one controller adjusts a path of the at least one energy beam across an optical path by controlling a movement of at least one optical element of the optical arrangement. In some embodiments, the additional detector is configured to receive a deflected portion of the energy beam from (I). In some embodiments, the additional detector is configured to receive a reflected portion of the energy beam from (II), which reflected portion is a returning portion of the energy beam from incidence on the target surface. In some embodiments, the optical arrangement is enclosed by an enclosure, which enclosure comprises an adjustment element operatively coupled with the at least one controller, which at least one controller is configured to alter a position of one or more optical elements of the optical arrangement. In some embodiments, the at least one controller comprises a graphical processing unit (GPU), system-on-chip (SOC), application specific integrated circuit (ASIC), application specific instruction-set processor (ASIPs), programmable logic device (PLD), or field programmable gate array (FPGA). In some embodiments, the at least one controller is configured to direct one or more of (a), (b) and (c) considering a path of the at least one energy beam. In some embodiments, the at least one controller is configured to perform (c) by directing the thermal radiation to an optical fiber operatively coupled (e.g., connected) with the detector. In some embodiments, the at least one controller is configured to maintain the second focus on a cross-section of the optical fiber. In some embodiments, at least one component of an aberration-correcting optical arrangement (e.g., the one or more optical elements) of the optical arrangement comprise a lens, mirror, or a beam splitter. In some embodiments, at least one of the at least one component of an aberration-correcting optical arrangement are configured to translate and/or rotate. In some embodiments, at least one component of an aberration-correcting optical arrangement comprises a high thermal conductivity optical element. In some embodiments, the at least one component of an aberration-correcting optical arrangement comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, the optical arrangement is disposed in an optical chamber configured to facilitate separation of the energy beam from an environment external to the optical chamber. In some embodiments, one or more optical elements of the optical arrangement is adjustable from an environment external to the optical chamber. In some embodiments, the adjustment uses one or more adjustable levers that extend from an internal environment of the optical chamber to the environment external to the optical chamber. In some embodiments, the adjustment uses a controllable and/or wireless adjustment of the one or more optical elements. In some embodiments, the detector is configured to detect a temperature of a position of (a) a footprint of the energy beam on the pre-transformed material and/or on the target surface, and/or (b) a vicinity of the footprint in (a), or (c) any combination of (a) and (b). In some embodiments, the vicinity of the footprint in (a) extends to at most six fundamental length scales of the footprint of the energy beam in (a). In some embodiments, configured to detect a temperature is indirectly through measurement of at least one characteristic of the thermal radiation. In some embodiments, the detector outputs a result. In some embodiments, the at least one controller is configured to direct adjusting at least one characteristic of the energy source and/or energy beam considering the result. In some embodiments, the detector outputs a result. In some embodiments, the at least one controller is configured to direct adjusting at least one characteristic of the printing considering the result. In some embodiments, the adjusting and/or considering is in real time. In some embodiments, the at least one controller is configured to direct translating the platform laterally during printing in relation with a translation of the at least one energy beam along the platform.

In another aspect, a method for forming (e.g., printing) a three-dimensional object comprises: (a) irradiating a pre-transformed material with an energy beam at or adjacent to a target surface to form a transformed material as part of the three-dimensional object that is formed by (e.g., three-dimensional) printing; (b) directing a thermal (e.g., black body) radiation that emerges from the transformed material, to a detector through an aberration-correcting optical arrangement (e.g., achromatic optical setup); and (c) adjusting one or more optical elements of the aberration-correcting optical arrangement (e.g., achromatic optical setup) to maintain (i) a first focus of the energy beam on the target surface, and (ii) a second focus of at least a portion of the thermal (e.g., black body) radiation on the detector or on a cross section of an optical fiber connected to the detector.

In some embodiments, the detector comprises an image detector. In some embodiments, the detector comprises a thermal detector. In some embodiments, the detector comprises a reflectivity detector. In some embodiments, the detector comprises a sensor. In some embodiments, the detector comprises an optical detector. In some embodiments, the detector comprises a spectrometer. In some embodiments, the aberration-correcting optical arrangement comprises at least one of an achromatic lens, an apochromatic lens, or a superachromatic lens. In some embodiments, the thermal radiation is a black body radiation. In some embodiments, the method further comprises directing the black body radiation through a filter disposed along a black body radiation return path to the detector, which black body radiation return path is from the target surface to the detector. In some embodiments, the filter is an optical filter. In some embodiments, the filter comprises a reflection filter. In some embodiments, the filter comprises an absorption filter. In some embodiments, the method further comprises directing a returning portion of the energy beam from the target surface to an additional detector. In some embodiments, (ii) comprises maintaining during at least part of the printing the second focus on a cross section of an optical fiber connected with the detector. In some embodiments, the optical fiber is comprised in an optical fiber bundle. In some embodiments, at least an optical fiber of the optical fiber bundle is operatively coupled to a single pixel detector. In some embodiments, the optical fiber bundle comprises a central fiber. In some embodiments, the optical fiber bundle comprises one or more optical fibers disposed adjacent to the central fiber. In some embodiments, the one or more optical fibers engulf the central fiber. In some embodiments, a cross section of the one or more optical fibers adjacent to the central fiber, is the same as the cross section of the central fiber. In some embodiments, a cross section of the one or more optical fibers adjacent to the central fiber, is different than the cross section of the central fiber. In some embodiments, a cross section of a first optical fiber adjacent to the central fiber, is same as the cross section of the central fiber; and a cross section of a second optical fiber adjacent to the central fiber, is different than the cross section of the central fiber. In some embodiments, the (e.g., three-dimensional) printing comprises additive manufacturing. In some embodiments, the (e.g., three-dimensional) printing comprises a granular (e.g., three-dimensional) printing. In some embodiments, the granular (e.g., three-dimensional) printing comprises using a granular material selected from the group consisting of elemental metal, metal alloy, ceramics, and an allotrope of elemental carbon. In some embodiments, the granular material comprises a particulate material. In some embodiments, the granular material comprises a powder material. In some embodiments, the granular printing comprises transforming the granular material to the transformed material to form at least a portion of the three-dimensional object. In some embodiments, the transforming comprises melting or sintering. In some embodiments, the transforming comprises fusing. In some embodiments, the transforming comprises completely melting. In some embodiments, the pre-transformed material is a powder material. In some embodiments, the pre-transformed material is selected from the group consisting of metal alloy, elemental metal, ceramic, and an allotrope of elemental carbon. In some embodiments, the target surface comprises an exposed surface of a material bed. In some embodiments, the material bed is a powder bed. In some embodiments, the target surface comprises a platform. In some embodiments, the target surface comprises a previously formed layer of the three-dimensional object. In some embodiments, the one or more optical elements comprise a mirror. In some embodiments, the one or more optical elements comprise a beam splitter. In some embodiments, one or more optical elements comprises a high thermal conductivity optical element. In some embodiments, the one or more optical elements comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, the method further comprises translating the energy beam during the irradiating. In some embodiments, the method further comprises translating the target surface synchronously with translating the energy beam. In some embodiments, the one or more optical elements comprise a lens. In some embodiments, the lens is devoid of a wide field lens. In some embodiments, the lens comprises a wide field lens. In some embodiments, the wide field lens is placed at a position along an optical path from an energy source generating the energy beam to (i) the target surface or (ii) the detector. In some embodiments, the wide field lens is placed at a position between a scanner and the target surface. In some embodiments, the one or more optical elements are movable during the adjusting. In some embodiments, the one or more optical elements translate and/or rotate during the readjusting. In some embodiments, the method further comprises controlling the energy beam, target surface and/or at least one optical element using at least one controller.

In another aspect, an apparatus for printing a three-dimensional object comprises: an energy source configured to project an energy beam for transforming a pre-transformed material at or adjacent to a target surface to a transformed material, the energy source disposed adjacent to the target surface; at least one detector configured to receive a thermal radiation emerging from the transformed material, the at least one detector disposed adjacent to the target surface; and an optical arrangement operatively coupled with the energy source and the at least one detector, the optical arrangement comprising one or more optical elements configured to move and maintain a focus (i) of the energy beam at the target surface and (ii) of least a portion of the thermal radiation at the at least one detector.

In some embodiments, the one or more optical elements are configured to move and maintain a simultaneous focus (i) of the energy beam at the target surface and (ii) of least a portion of the thermal radiation at the at least one detector during the transforming. In some embodiments, energy beam translates across the target surface during the printing. In some embodiments, the one or more optical elements are configured to move and maintain a simultaneous focus (i) of the energy beam at the target surface and (ii) of least a portion of the thermal radiation at the at least one detector during translation of the energy beam across the target surface. In some embodiments, the one or more optical elements comprise a lens, a mirror, an optical window or a beam splitter. In some embodiments, one or more optical elements comprises a high thermal conductivity optical element. In some embodiments, the one or more optical elements comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, at least one of the one or more optical elements is configured to move. In some embodiments, the optical arrangement comprises at least one of an achromatic lens, an apochromatic lens, or a superachromatic lens. In some embodiments, the apparatus further comprises a scanner disposed between the energy source and the target surface. In some embodiments, the apparatus further comprises a scanner disposed between at least one optical element and the target surface. In some embodiments, the at least one optical element is configured to move during the printing. In some embodiments, the one or more optical elements are devoid of an f-theta lens. In some embodiments, the one or more optical elements comprise a lens, mirror, or a beam splitter. In some embodiments, the one or more optical elements are configured to translate and/or rotate. In some embodiments, one or more optical elements comprises a high thermal conductivity optical element. In some embodiments, the one or more optical elements comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, the one or more optical elements are disposed in an optical chamber configured to facilitate separation of the energy beam from an environment external to the optical chamber. In some embodiments, the one or more optical elements is adjustable from an environment external to the optical chamber. In some embodiments, the adjustment uses one or more adjustable levers that extend from an internal environment of the optical chamber to the environment external to the optical chamber. In some embodiments, the adjustment uses a controllable and/or wireless adjustment of the one or more optical elements. In some embodiments, the detector is configured to detect a temperature of a position of (a) a footprint of the energy beam on the pre-transformed material and/or on the target surface, (b) a vicinity of the footprint in (a), or (c) any combination of (a) and (b). In some embodiments, the vicinity of the footprint in (a) extends to at most six fundamental length scales of the footprint of the energy beam in (a). In some embodiments, configured to detect a temperature is indirectly through measurement of at least one characteristic of the returning radiation (e.g., thermal radiation). In some embodiments, the detector is configured to output a result, and at least one controller is configured to direct adjusting at least one characteristic of the energy source and/or energy beam considering the result. In some embodiments, the detector is configured to output a result. In some embodiments, at least one controller is configured to direct adjusting at least one characteristic of the printing considering the result. In some embodiments, the adjusting and/or considering is in real time during the printing. In some embodiments, the one or more optical elements are further configured to move and adjust the focus of the at least the portion of the thermal radiation at the at least one detector while maintaining the focus of the energy beam at the target surface. In some embodiments, the one or more optical elements are configured to focus (i) and (ii) non-contemporaneously. In some embodiments, the one or more optical elements are configured to focus (i) and (ii) sequentially. In some embodiments, the one or more optical elements are configured to focus (i) and (ii) (e.g., substantially) simultaneously. In some embodiments, the at least one detector comprises an image detector. In some embodiments, the at least one detector comprises a thermal detector. In some embodiments, the at least one detector comprises a reflectivity detector. In some embodiments, the at least one detector comprises a sensor. In some embodiments, the at least one detector comprises an optical detector. In some embodiments, the at least one detector comprises a spectrometer. In some embodiments, the thermal radiation is a black body radiation. In some embodiments, the optical arrangement is further configured to direct the at least the portion of the thermal radiation through one or more filters disposed along a thermal radiation return path to the at least one detector, which thermal radiation return path is from the target surface to the at least one detector. In some embodiments, the apparatus comprises at least two detectors are configured to detect the thermal radiation, which at least two detectors each have an associated thermal radiation peak wavelength sensitivity. In some embodiments, a first detector of the at least two detectors comprises a first filter of the one or more filters, and a second detector of the at least two detectors comprises a second filter of the one or more filters. In some embodiments, the associated thermal radiation peak wavelength sensitivity of the first detector and the second detector is different. In some embodiments, the associated thermal radiation peak wavelength sensitivity of the first detector and the second detector is (e.g., substantially) the same. In some embodiments, the one or more filters comprise an optical filter. In some embodiments, the one or more filters comprise a reflection filter.

In another aspect, an apparatus for printing a three-dimensional object (e.g., using 3D printing) comprises: a target surface; an energy source that (e.g., is configured to emit at least one first energy beam that) irradiates a pre-transformed material with a first energy beam at or adjacent to the target surface to form a transformed material as part of the three-dimensional object that is formed by three-dimensional printing, which transformed material generates a second energy beam, wherein the energy source is disposed adjacent to the target surface; an optical fiber that directs one or more of (i) the second energy beam and (ii) a returning first energy beam, wherein the optical fiber is disposed adjacent to the target surface; and a detector that is operatively coupled to the optical fiber, the detector to detect one or more of (i) the second energy beam and (ii) the returning first energy beam.

In some embodiments, one or more optical elements are coupled with the energy source, the optical fiber, and/or the detector, which one or more optical elements comprise a lens, a mirror, an optical window or a beam splitter. In some embodiments, one or more optical elements comprises a high thermal conductivity optical element. In some embodiments, the one or more optical elements comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, a platform comprises the target surface. In some embodiments, the platform is configured for translation. In some embodiments, the translation is at least one of horizontal, vertical, or angular translation. In some embodiments, the apparatus further comprises at least one controller that is operatively coupled with the platform and is configured to translate the platform in coordination with the energy source, the optical fiber, or the detector to direct one or more of (i) or (ii). In some embodiments, the apparatus further comprises a second detector is configured for indirect view of the target surface. In some embodiments, the at least one controller is configured to perform feedback control by adjustment to one or more of the energy source, the optical fiber, and the detector based on measurements from the second detector. In some embodiments, the one or more optical elements are configured to translate and/or rotate. In some embodiments, the one or more optical elements are disposed in an optical chamber configured to facilitate separation of the energy beam from an environment external to the optical chamber. In some embodiments, the one or more optical elements is adjustable from an environment external to the optical chamber. In some embodiments, the adjustment uses one or more adjustable levers that extend from an internal environment of the optical chamber to the environment external to the optical chamber. In some embodiments, the adjustment uses a controllable and/or wireless adjustment of the one or more optical elements. In some embodiments, the detector is configured to detect a temperature of a position of (a) a footprint of the energy beam on the pre-transformed material and/or on the target surface, (b) a vicinity of the footprint in (a), or (c) any combination of (a) and (b). In some embodiments, the vicinity of the footprint in (a) extends to at most six fundamental length scales of the footprint of the energy beam in (a). In some embodiments, configured to detect a temperature is indirectly through measurement of at least one characteristic of the returning radiation (e.g., thermal radiation). In some embodiments, the detector is configured to output a result, and at least one controller is configured to direct adjusting at least one characteristic of the energy source and/or energy beam considering the result. In some embodiments, the detector is configured to output a result. In some embodiments, at least one controller is configured to direct adjusting at least one characteristic of the printing considering the result. In some embodiments, the adjusting and/or considering is in real time during the printing. In some embodiments, the apparatus further comprises an additional detector configured to have indirect view of the target surface. In some embodiments, the at least one controller is configured to control at least one aspect of the printing considering a result of the detector. In some embodiments, the additional detector is configured to sense abrupt and/or intense radiation emitted during the printing. In some embodiments, the intense and/or abrupt radiation results from a splatter, and/or keyhole formation during the printing.

In another aspect, a system for printing a three-dimensional object (e.g., using 3D printing) comprises: a target surface configured to support the three-dimensional object; an energy source (e.g., that is configured to generate a first energy beam) that transforms a pre-transformed material with the first energy beam at or adjacent to the target surface to a transformed material as part of the three-dimensional object that is formed by three-dimensional printing, which transforms generates a second energy beam that is different from the first energy beam (e.g., wherein during transformation of the pre-transformed material, a second energy beam is generated), wherein the energy source is disposed adjacent to the target surface; an optical fiber that directs (e.g., that is configured to direct) one or more of (i) the second energy beam and (ii) a returning first energy beam, wherein the optical fiber is disposed adjacent to the target surface; a detector that is operatively coupled to the optical fiber, the detector (e.g., is configured) to detect one or more of (i) the second energy beam and (ii) the returning first energy beam; and at least one controller that is operatively coupled to (e.g., at least one of) the target surface, the energy source, the optical fiber, and the detector, which controller is configured (e.g., programmed) to: (I) direct the energy source to irradiate the pre-transformed material with the first energy beam, and (II) direct one or more of (i) the second energy beam and (ii) the returning first energy beam, to the optical fiber.

In some embodiments, different comprises of a lower energy. In some embodiments, different comprises of a lower intensity. In some embodiments, different comprises of a larger wavelength. In some embodiments, returning comprises reflecting. In some embodiments, one or more optical elements are coupled with the energy source, the optical fiber, the detector, and/or the at least one controller, which one or more optical elements comprise a lens, a mirror, an optical window, or a beam splitter. In some embodiments, at least one of the one or more optical elements comprises a high thermal conductivity optical element. In some embodiments, the high thermal conductivity optical element comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, (I) and (II) are performed by different controllers that are operatively coupled. In some embodiments, (I) and (II) are performed by the same controller. In some embodiments, the one or more optical elements comprise a lens, mirror, or a beam splitter. In some embodiments, the one or more optical elements are configured to translate and/or rotate. In some embodiments, one or more optical elements comprises a high thermal conductivity optical element. In some embodiments, the one or more optical elements comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, the one or more optical elements are disposed in an optical chamber configured to facilitate separation of the energy beam from an environment external to the optical chamber. In some embodiments, the one or more optical elements is adjustable from an environment external to the optical chamber. In some embodiments, the adjustment uses one or more adjustable levers that extend from an internal environment of the optical chamber to the environment external to the optical chamber. In some embodiments, the adjustment uses a controllable and/or wireless adjustment of the one or more optical elements. In some embodiments, the detector is configured to detect a temperature of a position of (a) a footprint of the energy beam on the pre-transformed material and/or on the target surface, (b) a vicinity of the footprint in (a), or (c) any combination of (a) and (b). In some embodiments, the vicinity of the footprint in (a) extends to at most six fundamental length scales of the footprint of the energy beam in (a). In some embodiments, configured to detect a temperature is indirectly through measurement of at least one characteristic of the returning radiation (e.g., thermal radiation). In some embodiments, the detector is configured to output a result, and the at least one controller is configured to direct adjusting at least one characteristic of the energy source and/or energy beam considering the result. In some embodiments, the detector is configured to output a result. In some embodiments, the at least one controller is configured to direct adjusting at least one characteristic of the printing considering the result. In some embodiments, the adjusting and/or considering is in real time during the printing.

In another aspect, an apparatus for printing a three-dimensional object comprises at least one controller that is operatively coupled to one or more of a target surface, an energy source, an optical fiber, and a detector, which controller is configured (e.g., programmed) to: (I) direct a first energy beam to transform a pre-transformed material to a transformed material as part of the three-dimensional object disposed, which transform is at or adjacent to a target surface, which transformed material and/or target surface generates (i) a second energy beam that is different from the first energy beam and/or (ii) a thermal radiation; and (II) direct one or more of (a) the second energy beam and (b) the thermal radiation, to an optical fiber.

In some embodiments, the optical fiber is operatively coupled to a detector. In some embodiments, the at least one controller is operatively coupled to the detector and directs the detector to produce a result. In some embodiments, the at least one controller directs an alteration of the energy beam based on the result. In some embodiments, direct one or more of (a) the second energy beam and (b) the thermal radiation, to an optical fiber is through one or more optical elements. In some embodiments, at least one of the one or more optical elements comprises a high thermal conductivity optical element. In some embodiments, the high thermal conductivity optical element comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, (I) and (II) are performed by different controllers that are operatively coupled. In some embodiments, (I) and (II) are performed by the same controller. In some embodiments, the one or more optical elements comprise a lens, mirror, or a beam splitter. In some embodiments, the one or more optical elements are configured to translate and/or rotate. In some embodiments, the one or more optical elements comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, the one or more optical elements are disposed in an optical chamber configured to facilitate separation of the energy beam from an environment external to the optical chamber. In some embodiments, the one or more optical elements is adjustable from an environment external to the optical chamber. In some embodiments, the adjustment uses one or more adjustable levers that extend from an internal environment of the optical chamber to the environment external to the optical chamber. In some embodiments, the at least one controller is configured to adjust the one or more optical elements. In some embodiments, the detector is configured to detect a temperature of a position of (a) a footprint of the energy beam on the pre-transformed material and/or on the target surface, (b) a vicinity of the footprint in (a), or (c) any combination of (a) and (b). In some embodiments, the vicinity of the footprint in (a) extends to at most six fundamental length scales of the footprint of the energy beam in (a). In some embodiments, configured to detect a temperature is indirectly through measurement of at least one characteristic of the returning radiation (e.g., thermal radiation). In some embodiments, the detector is configured to output a result, and the at least one controller is configured to direct adjusting at least one characteristic of the energy source and/or energy beam considering the result. In some embodiments, the detector is configured to output a result. In some embodiments, the at least one controller is configured to direct adjusting at least one characteristic of the printing considering the result. In some embodiments, the adjusting and/or considering is in real time during the printing. In some embodiments, the adjusting and/or considering comprises using a control scheme that includes open loop and/or closed loop control. In some embodiments, the adjusting and/or considering comprises using a control scheme that includes feedback and/or feed-forward control. In some embodiments, the detector comprises an optical detector. In some embodiments, the second energy beam has a different wavelength than the first energy beam. In some embodiments, the second energy beam has a different polarity than the first energy beam. In some embodiments, the second energy beam has a different intensity than the first energy beam. In some embodiments, the second energy beam has a different beam profile than the first energy beam. In some embodiments, the second energy beam is a returning portion of the first energy beam from an irradiation position. In some embodiments, the returning portion is from the first energy beam irradiating the pre-transformed material and/or the target surface. In some embodiments, the returning portion is from a deflection of the first energy beam using one or more optical elements, which deflection occurs in a first portion of an optical path preceding a second portion of the optical path of the first energy beam, which optical path follows irradiating the pre-transformed material. In some embodiments, the second energy beam is a returning portion a thermal radiation emerging from an irradiated portion of the pre-transformed material and/or target surface, which irradiated is by the energy beam. In some embodiments, the optical fiber is included in an optical fiber bundle. In some embodiments, the optical fiber bundle comprises a plurality of optical fibers. In some embodiments, the plurality of optical fibers is operatively coupled to one or more single pixel detectors. In some embodiments, the plurality of optical fibers comprises a central fiber and engulfing fibers that engulf the central fiber. In some embodiments, the central fiber is coupled to a first detector and the engulfing fibers are connected to a second detector. In some embodiments, the first detector and/or the second detector is a single pixel detector. In some embodiments, the first detector is configured to detect a first radiation emerging from a footprint of the energy beam, and the second detector is configured to detect a second radiation emerging from a vicinity of the footprint of the energy beam (e.g., the vicinity of the footprint may extend to at most 2, 3, 4, 5, 6, or 7 FLS of the footprint). In some embodiments, the first radiation correlates to a first temperature. In some embodiments, the second radiation correlates to a second temperature. In some embodiments, the at least one controller controls at least one characteristic of the first energy beam based on the first temperature, second temperature, or on a variation between the first temperature and the second temperature. In some embodiments, the at least one characteristic comprises power density, focus, cross section, beam profile, velocity of translation along the target surface, dwell time, intermission time, or power density profile over time. In some embodiments, the at least one characteristic of the first energy beam is controlled in real time during the printing. In some embodiments, the at least one controller is configured to direct translating a platform laterally during the printing in relation with a translation of the first energy beam along the platform, which target surface is at or adjacent to the platform. In some embodiments, the at least one controller is configured to direct translating the target surface laterally during the printing in relation with a translation of the first energy beam.

In another aspect, a method for printing a three-dimensional object comprises: (a) irradiating a pre-transformed material with a first energy beam at or adjacent to a target surface to form a transformed material as part of the three-dimensional object that is formed by three-dimensional printing; (b) directing a second energy beam to at least one optical fiber, which second energy beam returns from the target surface during and/or after (a); and (c) detecting the second energy beam by a detector that is operatively coupled to the at least one optical fiber.

In some embodiments, the detector comprises an optical detector. In some embodiments, the second energy beam has a different wavelength than the first energy beam. In some embodiments, the second energy beam has a different polarity than the first energy beam. In some embodiments, the second energy beam has a different intensity than the first energy beam. In some embodiments, the second energy beam has a different beam profile than the first energy beam. In some embodiments, the second energy beam is a returning portion of the first energy beam from an irradiation position. In some embodiments, the returning portion is from the first energy beam irradiating the pre-transformed material and/or the target surface. In some embodiments, the returning portion is from a deflection of the first energy beam using one or more optical elements, which deflection occurs in a first portion of an optical path preceding a second portion of the optical path of the first energy beam, which optical path follows irradiating the pre-transformed material. In some embodiments, the second energy beam is a returning portion of a thermal radiation emerging from an irradiated portion of the pre-transformed material and/or the target surface. In some embodiments, the irradiating transforms the pre-transformed material to the transformed material at the target surface. In some embodiments, one or more of (a), (b), and (c) comprises using a feedback control scheme or using a feed-forward control scheme. In some embodiments, the using the feedback control scheme or using the feed-forward control scheme is in real time. In some embodiments, the detector is coupled to the at least one optical fiber. In some embodiments, the at least one optical fiber is included in an optical fiber bundle. In some embodiments, the optical fiber bundle comprises two or more optical fibers. In some embodiments, the two or more optical fibers are operatively coupled to one or more single pixel detectors. In some embodiments, the method further comprises directing the first energy beam to an additional optical fiber. In some embodiments, the directing the first energy beam and/or the directing the second energy beam comprises deflecting and/or reflecting using one or more optical elements. In some embodiments, the directing the first energy beam and/or the directing the second energy beam comprises directing through an associated filter of the at least one optical fiber and/or the additional optical fiber. In some embodiments, the method further comprises detecting the first energy beam by an additional detector that is operatively coupled to the additional optical fiber. In some embodiments, one or more of (a), (b), and (c) comprises using a feedback control scheme and/or using a feed-forward control scheme. In some embodiments, using the feedback control scheme and/or using the feed-forward control scheme comprises considering measurements from the detector and/or the additional detector. In some embodiments, using the feedback control scheme and/or using the feed-forward control scheme comprises modulating the first energy beam. In some embodiments, the detecting the second energy beam comprises using an indirect view of the target surface during and/or after (a). In some embodiments, the directing the second energy beam comprises directing onto a cross section of the at least one optical fiber. In some embodiments, the cross section of the at least one optical fiber is perpendicular to a direction in which the second energy beam is propagating in the at least one optical fiber. In some embodiments, the directing the first energy beam comprises directing onto a cross section of the additional optical fiber. In some embodiments, the cross section of the additional optical fiber is perpendicular to a direction in which the first energy beam is propagating in the additional optical fiber. In some embodiments, the method comprises directing the second energy beam and/or the first energy beam through one or more high thermal conductivity optical elements. In some embodiments, the one or more high thermal conductivity optical elements comprise sapphire, crystal quartz, zinc selenide (ZnSe), magnesium fluoride (MgF₂), calcium fluoride (CaF₂), fused silica, borosilicate, silicon fluoride, or Pyrex®. In some embodiments, the deflecting and/or reflecting comprises directing through at least one lens. In some embodiments, the at least one lens is devoid of a wide field lens. In some embodiments, the at least one lens comprises a wide field lens. In some embodiments, the directing through the wide field lens comprises directing along an optical path from an energy source generating the first energy beam to (i) the target surface or (ii) the detector. In some embodiments, the detecting comprises detecting a temperature of a position of (a) a footprint of the first energy beam on the pre-transformed material and/or the target surface, and/or (b) a vicinity of (a). In some embodiments, the vicinity of (a) extends to at most six fundamental length scales of the footprint of the first energy beam in (a). In some embodiments, the detecting the temperature is indirect, through measuring one or more characteristics of the second energy beam. In some embodiments, operatively coupled to is directly connected to the detector and/or the additional detector. In some embodiments, the directing the second energy beam comprises directing to an optical fiber bundle comprising the at least one optical fiber. In some embodiments, the detecting the second energy beam comprises detecting by one or more single pixel detectors that are operatively coupled to the optical fiber bundle. In some embodiments, the directing the second energy beam comprises directing to a central fiber and to a plurality of surrounding fibers of the optical fiber bundle. In some embodiments, the directing to the plurality of surrounding fibers of the optical fiber bundle comprises directing to a first zone and to a second zone of the plurality of surrounding fibers of the optical fiber bundle, each of the first zone and the second zone comprising at least two fibers. In some embodiments, the detecting the second energy beam comprises detecting by at least one corresponding single pixel detector of the one or more single pixel detectors that is operatively coupled with the first zone and/or the second zone. In some embodiments, the at least one corresponding single pixel detector consists of one corresponding single pixel detector. In some embodiments, the at least one corresponding single pixel detector comprises at least two corresponding single pixel detectors. In some embodiments, the detecting the second energy beam comprises detecting at a first peak wavelength associated with a first single pixel detector of the at least two corresponding single pixel detectors, and at a second peak wavelength associated with a second single pixel detector of the at least two corresponding single pixel detectors. In some embodiments, the detecting the second energy beam comprises detecting at a first wavelength range associated with a first single pixel detector of the at least two corresponding single pixel detectors, and at a second wavelength range associated with a second single pixel detector of the at least two corresponding single pixel detectors. In some embodiments, the first wavelength range is at least in part differing from the second wavelength range. In some embodiments, the first wavelength range is at least in part overlapping the second wavelength range. In some embodiments, the directing comprises directing to a second zone that engulfs the first zone. In some embodiments, the directing comprises directing to a first geometry associated with the first zone, and directing to a second geometry associated with the second zone. In some embodiments, the first geometry and the second geometry are the same. In some embodiments, the first geometry and the second geometry are the different.

In another aspect, a system for printing a three-dimensional object comprises: an energy source configured to generate a first energy beam irradiating a pre-transformed material to transform to a transformed material as part of the three-dimensional object, which pre-transformed material is disposed at or adjacent to a target surface, which irradiating the pre-transformed material generates a second energy beam that is different from the first energy beam, wherein the source is disposed adjacent to the target surface; one or more detectors configured to receive one or more of (i) the first energy beam and (ii) the second energy beam, wherein the one or more detectors are disposed adjacent to the target surface; one or more optical fibers that direct one or more of (i) the first energy beam and (ii) the second energy beam to the one or more detectors; and at least one controller that is operatively coupled to one or more of the target surface, the energy source, the one or more detectors and the one or more optical fibers, which at least one controller is configured (e.g., programmed) to direct performance of the following operations: (a) using the energy source to irradiate the pre-transformed material with the first energy beam, (b) focusing the second energy beam on the one or more detectors, which second energy beam travels through the one or more optical fibers, and (c) measuring one or more second energy beam characteristics at the one or more detectors.

In some embodiments, at least two of (a), (b), and (c) are performed by different controllers of the at least one controller. In some embodiments, at least two of (a), (b), and (c) are performed by the same controller of the at least one controller. In some embodiments, the at least one controller is further configured (e.g., programmed) to direct focusing the first energy beam on the target surface. In some embodiments, focusing the first energy beam on the target surface is during the focusing of the second energy beam on the one or more detectors. In some embodiments, the second energy beam that is different from the first energy beam by at least one energy beam characteristic comprising a wavelength, power density, or amplitude. In some embodiments, (b) comprises focusing a first portion of the second energy beam on a first detector of the one or more detectors, and focusing a second portion of the second energy beam on a second detector of the one or more detectors. In some embodiments, (b) comprises focusing a first portion of the second energy beam on the first detector through a first optical fiber bundle, and focusing a second portion of the second energy beam on a second detector through a second optical fiber bundle. In some embodiments, the first optical fiber bundle and/or the second optical fiber bundle is an optical fiber. In some embodiments, the first optical fiber bundle and/or the second optical fiber bundle is a plurality of optical fibers. In some embodiments, the first optical fiber bundle is operatively coupled to a first detector, and the second optical fiber bundle is operatively coupled to a second detector. In some embodiments, the one or more detectors comprise the first detector and the second detector. In some embodiments, the first optical fiber bundle comprises an optical fiber having a first cross section and/or the second optical fiber bundle comprises an optical fiber having a second cross section. In some embodiments, the fundamental length scale of the first cross section is the same as the fundamental length scale of the second cross section. In some embodiments, the fundamental length scale of the first cross section is the same as the fundamental length scale of the second cross section. In some embodiments, the at least one controller is configured to perform one or more of (a), (b) and (c) in real time. In some embodiments, the at least one controller is configured to adjust one or more characteristics of the energy source, which at least one characteristic comprise power, power as a function of time, dwell time of the first energy beam, intermission time of the first energy beam, or pulsing rate of the first energy beam. In some embodiments, the at least one controller is configured to direct movement one or more optical elements of an optical arrangement operatively coupled with the at least one controller to perform (b). In some embodiments, the at least one controller is configured to perform (a), (b) and (c) using a control scheme comprising a closed loop or open loop control. In some embodiments, the at least one controller is configured to perform (a), (b) and (c) using a control scheme comprising a feedback control or feed-forward control. In some embodiments, feedback control comprises closed loop control. In some embodiments, feed-forward control comprises the at least one controller configured to change at least one characteristic of the first energy beam and/or energy source, considering a result of the measuring. In some embodiments, the second energy beam comprises a thermal radiation emerging. In some embodiments, the result of the measuring comprises one or more second energy beam characteristics. In some embodiments, the at least one controller is configured to change at least one characteristic of the energy source and/or first energy beam considering a result of the measuring. In some embodiments, the second energy beam is a returning portion of the first energy beam that is a deflection of the first energy beam. In some embodiments, the deflection occurs using one or more optical elements. In some embodiments, the at least one controller is configured to control at least one optical elements of the one or more optical elements. In some embodiments, the first energy beam travels from the energy source to the target surface in an optical path having a first portion and a second portion, which first position comprises an exit of the energy source, which second portion excludes the exit of the energy source, and which deflection occurs in the first portion of an optical path that precedes the second portion of the optical path. In some embodiments, the second energy beam comprises a thermal radiation from the target surface. In some embodiments, the at least one controller is configured to facilitate directing the thermal radiation through a filter disposed along a thermal radiation return path to the one or more detectors, which thermal radiation return path is from the target surface to the one or more detectors. In some embodiments, an optical fiber bundle comprises the one or more optical fibers, which optical fiber bundle comprises two or more optical fibers. In some embodiments, the two or more optical fibers are operatively coupled to one or more single pixel detectors (e.g., respectively). In some embodiments, the optical fiber bundle comprises a central fiber and a plurality of surrounding fibers, the central fiber operatively coupled with at least a first detector of the one or more detectors and the plurality of surrounding fibers are operatively coupled with at least a second detector of the one or more detectors. In some embodiments, the at least the second detector comprises a plurality of second detectors. In some embodiments, the plurality of surrounding fibers comprises a first zone and a second zone, each of the first zone and the second zone comprising at least two fibers. In some embodiments, the first zone and the second zone are operatively coupled with a corresponding one or more detectors of the plurality of second detectors. In some embodiments, the corresponding one or more detectors are the same. In some embodiments, the corresponding one or more detectors are different. In some embodiments, the corresponding one or more detectors are sensitive to different peak wavelengths. In some embodiments, the second zone engulfs the first zone. In some embodiments, the first zone and the second zone comprise fibers arranged in an associated first and second geometry, respectively. In some embodiments, the associated first and second geometry are the same. In some embodiments, the associated first and second geometry are different. In some embodiments, the corresponding one or more detectors are sensitive to different wavelength ranges. In some embodiments, the corresponding one or more detectors comprise a first detector and a second detector. In some embodiments, the first detector is sensitive a first wavelength range. In some embodiments, the second detector is sensitive to a second wavelength range. In some embodiments, the first wavelength range is at least in part different from the second wavelength range. In some embodiments, the first wavelength range at least in part overlaps with the second wavelength range.

In another aspect, a method for printing (e.g., forming) a three-dimensional object comprises: (a) irradiating a pre-transformed material with a first energy beam at or adjacent to a target surface to form a transformed material as part of the three-dimensional object that is formed by three-dimensional printing; (b) directing a second energy beam to at least one optical fiber, which second energy beam returns from the target surface during and/or after (a); and (c) detecting the second energy beam by a detector that is operatively coupled to the at least one optical fiber.

In some embodiments, the detector comprises an optical detector. In some embodiments, the second energy beam has a different wavelength than the first energy beam. In some embodiments, the second energy beam has a different polarity than the first energy beam. In some embodiments, the second energy beam has a different intensity than the first energy beam. In some embodiments, the second energy beam has a different beam profile than the first energy beam. In some embodiments, the second energy beam is a returning portion of the first energy beam from an irradiation position. In some embodiments, the returning portion is from the first energy beam irradiating the pre-transformed material and/or the target surface. In some embodiments, the returning portion is from a deflection of the first energy beam using one or more optical elements, which deflection occurs in a first portion of an optical path preceding a second portion of the optical path of the first energy beam, which optical path follows irradiating the pre-transformed material. In some embodiments, the second energy beam is a returning portion a thermal radiation emerging from an irradiated portion of the pre-transformed material and/or target surface, which irradiated is by the energy beam. In some embodiments, the irradiating transforms the pre-transformed material to the transformed material at the target surface. In some embodiments, one or more of (a), (b), and (c) comprises using a feedback control scheme or using a feed-forward control scheme. In some embodiments, the using the control scheme is in real time. In some embodiments, the detector is coupled to the at least one optical fiber. In some embodiments, the at least one optical fiber is included in an optical fiber bundle. In some embodiments, the optical fiber bundle comprises two or more optical fibers. In some embodiments, the two or more optical fibers are operatively coupled to one or more single pixel detectors (e.g., respectively).

In another aspect, an apparatus for printing a three-dimensional object (e.g., using 3D printing) comprises: an energy source, the energy source (e.g., is configured) to transmit an energy beam comprising a first cross section to travel along a path; a first set of one or more optical elements that are disposed along the path of the energy beam comprising the first cross section, the one or more optical elements to alter a diameter of the first cross section to form a second cross section, wherein the one or more optical elements are disposed adjacent to the energy source; one or more media, that allow the energy beam having the second cross section to pass through (e.g., one or more media, that is configured to pass the energy beam having the second cross section therethrough), the one or more media having a refractive index that refracts the energy beam having the second cross section, wherein the one or more media are disposed such that they convert the second cross section into a third cross section that is astigmatic in relation to the second cross section, wherein the one or more media are disposed adjacent to the one or more optical elements; and a second set of one or more optical elements that direct the energy beam having the third cross section to a pre-transformed material to form a transformed material as part of the three-dimensional object generated by three-dimensional printing.

In some embodiments, the apparatus further comprises a focusing optical element disposed adjacent to the one or more media. In some embodiments, the focusing optical element is configured to focus the energy beam having the third cross section. In some embodiments, the pre-transformed material is disposed on a target surface of a platform. In some embodiments, the platform is configured for translation. In some embodiments, the translation is at least one of horizontal, vertical, or angular translation. In some embodiments, the apparatus further comprises at least one controller that is operatively coupled with the platform, the first set, and/or the second set and is configured to translate the platform in coordination with the first set, and/or the second set to direct the energy beam having the third cross section to the pre-transformed material. In some embodiments, the apparatus further comprises at least one controller that is operatively coupled with the platform, the second set and is configured to translate the platform in coordination with the second set to direct the energy beam having the third cross section to the pre-transformed material. In some embodiments, the apparatus further comprises at least one controller that is operatively coupled with the one or more media and is configured to translate the one or more media to alter the third cross section. In some embodiments, the apparatus further comprises a detector disposed such that it is devoid of a direct view of the target surface. In some embodiments, the at least one controller is configured to use a feedback control scheme by adjustment to one or more of the energy source, the energy beam, the one or more media, the first set, and/or the second set considering one or more measurements of the detector. In some embodiments, the apparatus further comprises a detector configured to be devoid of a direct view of the target surface. In some embodiments, the at least one controller is configured to use a feedback control scheme by adjustment to one or more of the energy source, the energy beam, the one or more media, the first set, and/or the second set considering one or more measurements of the detector. In some embodiments, the apparatus further comprises a detector configured to have indirect view of the target surface. In some embodiments, the at least one controller is configured to control at least one aspect of the printing considering a result of the detector. In some embodiments, the detector is configured to sense abrupt and/or intense radiation emitted during the printing. In some embodiments, the intense and/or abrupt radiation results from a splatter, and/or keyhole formation during the printing. In some embodiments, the apparatus further comprises an optical window that comprises a high thermal conductivity material. In some embodiments, the optical window is configured to pass the energy beam therethrough. In some embodiments, the optical window comprises a high thermal conductivity optical element. In some embodiments, the high thermal conductivity optical element comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, the one or more optical elements comprise a lens, mirror, or a beam splitter. In some embodiments, the one or more optical elements comprise a high thermal conductivity optical element. In some embodiments, the one or more optical elements comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, the one or more optical elements are disposed in an optical chamber configured to facilitate separation of the energy beam from an environment external to the optical chamber. In some embodiments, the one or more optical elements is adjustable from an environment external to the optical chamber. In some embodiments, an adjustment of the one or more optical elements uses one or more adjustable levers that extend from an internal environment of the optical chamber to the environment external to the optical chamber. In some embodiments, the adjustment uses a controllable and/or wireless adjustment of the one or more optical elements. In some embodiments, the detector is configured to detect a temperature of a position of (a) a footprint of the energy beam on the pre-transformed material and/or on the target surface, (b) a vicinity of the footprint in (a), or (c) any combination of (a) and (b). In some embodiments, the vicinity of the footprint in (a) extends to at most six fundamental length scales of the footprint of the energy beam in (a). In some embodiments, configured to detect a temperature is indirectly through measurement of at least one characteristic of the energy beam, abrupt and/or intense radiation emitted during the printing. In some embodiments, the detector is configured to output a result, and the at least one controller is configured to direct adjusting at least one characteristic of the energy source and/or energy beam considering the result. In some embodiments, the detector is configured to output a result. In some embodiments, the at least one controller is configured to direct adjusting at least one characteristic of the printing considering the result. In some embodiments, the adjusting and/or considering is in real time during the printing.

In another aspect, an apparatus for printing a three-dimensional object comprises: at least one controller that is operatively coupled to at least one of an energy source that is configured to generate an energy beam comprising a first cross section, an optical element that is configured to alter the first cross section of the energy beam and that is disposed along a path of the energy beam to a target surface, and one or more media, which at least one controller is configured (e.g., programmed) to: (I) direct the energy beam to pass through the optical element and the one or more media to the target surface thereby (i) alter the first cross section to a second cross section by passing through the optical element, and (ii) alter the second cross section to a third cross section by passing an energy beam having the second cross section through the one or more media; (II) translate the one or more media to astigmatically alter the second cross section to form the third cross section; and (III) direct an energy beam having the third cross section to transform a pre-transformed material to form a transformed material as part of the three-dimensional object generated by three-dimensional printing (e.g., at or adjacent to the target surface), wherein the one or more media are (a) configured to substantially pass the energy beam therethrough, (b) have a refractive index to refract the energy beam, and (c) configured for translation.

In some embodiments, to pass is to sequentially pass. In some embodiments, the one or more media are not contacting during the printing. In some embodiments, the target surface that is configured to support the three-dimensional object. In some embodiments, the apparatus further comprises a detector configured to have indirect view of the target surface. In some embodiments, the at least one controller is configured to control at least one aspect of the printing considering a result of the detector. In some embodiments, the detector is configured to sense abrupt and/or intense radiation emitted during the printing. In some embodiments, the intense and/or abrupt radiation results from a splatter, and/or keyhole formation during the printing. In some embodiments, the at least one controller that is operatively coupled to the energy source and is configured to (IV) direct the energy source to generate the energy beam having the first cross section. In some embodiments, (IV) is before (I). In some embodiments, the apparatus further comprises a detector disposed such that it is devoid of a direct view of the target surface. In some embodiments, the at least one controller is configured to perform feedback control by adjustment to one or more of (I), (II), or (III) based on measurements from the detector. In some embodiments, a platform comprises the target surface. In some embodiments, the platform is configured for translation. In some embodiments, the at least one controller is configured to translate the platform in a horizontal, vertical, and/or angular translation. In some embodiments, the at least one controller is operatively coupled with the platform and is configured to translate the platform in coordination with directing the energy beam having the third cross section. In some embodiments, the apparatus further comprises an optical window that comprises a high thermal conductivity material. In some embodiments, the at least one controller is configured to pass the energy beam having the third cross section therethrough. In some embodiments, the optical element comprises a high thermal conductivity optical element comprises sapphire, crystal quartz, zinc selenide (ZnSe), magnesium fluoride (MgF₂), calcium fluoride (CaF₂), fused silica, borosilicate, silicon fluoride, or Pyrex®.

In another aspect, a system for printing a three-dimensional object (e.g., using 3D printing) comprises: an energy source that generates (e.g., that is configured to generate) an energy beam comprising a first cross section; a target surface that is configured to support the three-dimensional object (e.g., and that the energy beam irradiates); an optical element that is disposed along a path of the energy beam, which optical element alters the first cross section of the energy beam, wherein the optical element is disposed adjacent to the energy source, which path is from the energy source to the target surface; one or more media, that (i) are configured to substantially pass allow the energy beam to substantially pass through (e.g., are configured to substantially pass the energy beam therethrough), (ii) have a refractive index to refract the energy beam, and (iii) are configured for translation, wherein the one or more media are not contacting wherein the one or more media are disposed adjacent to the optical element; and at least one controller that is operatively coupled to (e.g., at least one of) the energy source, the optical element, and the one or more media, which at least one controller is configured (e.g., programmed) to: (I) direct the energy beam to pass through the optical element and the one or more media to the target surface thereby (i) alter the first cross section to a second cross section by passing through the optical element, and (ii) alter the second cross section to a third cross section by passing an energy beam having the second cross section through the one or more media, (II) translate the one or more media to astigmatically alter the second cross section to form the third cross section, and (III) direct an energy beam having the third cross section to transform a pre-transformed material to form a transformed material as part of the three-dimensional object generated by three-dimensional printing (e.g., at or adjacent to the target surface).

In some embodiments, to pass is to sequentially pass. In some embodiments, the at least one controller that is operatively coupled to the energy source and is configured to (IV) direct the energy source to generate the energy beam having the first cross section. In some embodiments, at least two of (I), (II), (III), and (IV) are directed by different controllers that are operatively coupled. In some embodiments, at least two of (I), (II), (III), and (IV) are directed by the same controller. In some embodiments, (IV) is before (I). In some embodiments, the system further comprises a detector disposed such that it is devoid of a direct view of the target surface. In some embodiments, the at least one controller is configured to perform feedback control by adjustment to one or more of (I), (II), or (III) based on measurements from the detector. In some embodiments, a platform comprises the target surface. In some embodiments, the platform is configured for translation. In some embodiments, the translation is at least one of horizontal, vertical, or angular translation. In some embodiments, the at least one controller is operatively coupled with the platform and is configured to translate the platform in coordination with directing the energy beam having the third cross section. In some embodiments, the system further comprises an optical window that comprises a high thermal conductivity material. In some embodiments, the at least one controller is configured to pass the energy beam having the third cross section therethrough. In some embodiments, the high thermal conductivity optical element comprises sapphire, crystal quartz, zinc selenide (ZnSe), magnesium fluoride (MgF₂), calcium fluoride (CaF₂), fused silica, borosilicate, silicon fluoride, or Pyrex®. In some embodiments, the optical element comprises a high thermal conductivity optical element comprises sapphire, crystal quartz, zinc selenide (ZnSe), magnesium fluoride (MgF₂), calcium fluoride (CaF₂), fused silica, borosilicate, silicon fluoride, or Pyrex®.

In another aspect, a system for printing a three-dimensional object comprises: an energy source that is configured to generate an energy beam for irradiating a target surface, which energy beam comprises a first cross section; an optical element that is disposed along a path of the energy beam from the at least one energy source to the target surface, which optical element is configured to alter the first cross section of the energy beam; one or more media that are configured to (i) substantially pass the energy beam therethrough, (ii) comprise a refractive index operable to refract the energy beam; and at least one controller that is operatively coupled to at least one of the at least one energy source, the optical element or the one or more media, which at least one controller is configured (e.g., programmed) to direct performance of the following operations: (I) direct the energy beam to pass through the optical element and the one or more media, thereby altering the first cross section to form a second cross section, (II) translate the one or more media to pass the energy beam having the second cross section to astigmatically alter thereby the second cross section to form an astigmatic third cross section, and (III) direct the energy beam having the astigmatic third cross section toward a material at or adjacent to the target surface to form a transformed material as part of the three-dimensional object generated by three-dimensional printing.

In some embodiments, the optical element comprises a variable focus. In some embodiments, the at least one controller is configured to controllably vary the variable focus. In some embodiments, the controllably varied is before, after, or during at least a portion of the three-dimensional printing. In some embodiments, the at least one controller is configured to direct performance of (II) over an axis of rotation. In some embodiments, the at least one controller is configured to direct translation of a first medium of the one or more media along a different axis of rotation than a second medium of the one or more media. In some embodiments, the at least one controller is configured to direct avoiding contact between the first medium and the second medium when translating. In some embodiments, the first medium and the second medium are of the one or more media. In some embodiments, the at least one controller is configured to direct varying a degree of astigmatism of the astigmatic third cross section via a change in a position of the first medium in relation to a position of the second medium of the one or more media. In some embodiments, the at least one controller is configured to direct varying the position of the first medium to vary the degree of astigmatism. In some embodiments, the at least one controller is configured to direct varying the position of the second medium to vary the degree of astigmatism. In some embodiments, wherein the at least one controller is configured to direct altering an angular position of at least one of the first medium or the second medium. In some embodiments, the at least one controller is configured to direct elongating the second cross section to form the energy beam having the astigmatic third cross section. In some embodiments, the at least one controller is configured to direct elongating the second cross section along an X-Y plane. In some embodiments, the system further comprises a focusing optical element disposed adjacent to the one or more media, wherein the at least one controller is configured to direct positioning the focusing optical element to focus the energy beam having the astigmatic third cross section. In some embodiments, the system further comprises a translatable platform that comprises the target surface. In some embodiments, the at least one controller is configured to direct moving the translatable platform to focus the energy beam having the astigmatic third cross section at the target surface. In some embodiments, the at least one controller comprises two different controllers that are configured to perform at least two of (I), (II) and (III), respectively. In some embodiments, one controller is configured to perform at least two of (I), (II) and (III). In some embodiments, the at least one controller is configured to direct performing one or more of (I), (II) and (III) via feedback control scheme and/or feed-forward control scheme. In some embodiments, the feedback control scheme comprises closed loop control scheme. In some embodiments, the at least one controller is configured to perform one or more of (I), (II) and (III) in real time. In some embodiments, the system further comprises a detector operatively configured to have indirect view of the target surface. In some embodiments, the at least one controller is configured to perform the feedback control scheme by adjustment to one or more of (I), (II) and (III) considering a measurement of the detector. In some embodiments, the system further comprises an optical window that comprises a high thermal conductivity material. In some embodiments, the at least one controller is configured to pass the energy beam therethrough. In some embodiments, the optical window is formed of a high thermal conductivity optical element comprising sapphire, crystal quartz, zinc selenide (ZnSe), magnesium fluoride (MgF₂), calcium fluoride (CaF₂), fused silica, borosilicate, silicon fluoride, or Pyrex®.

In another aspect, a method for generating a three-dimensional object comprises: (a) directing an energy beam comprising a first cross section having a first cross section, to pass through one or more optical elements that alter the first cross section to form a second cross section; (b) directing the energy beam having the second cross section to pass through one or more media having a refractive index that refracts the energy beam having the second cross section, wherein the one or more media are disposed such that they convert the second cross section into a third cross section that is astigmatic in relation to the second cross section; and (c) directing the energy beam having the third cross section to a pre-transformed material to form a transformed material as part of the three-dimensional object generated by three-dimensional printing.

In some embodiments, the first cross section comprises a first shape of a first cross section. In some embodiments, the second cross section comprises a second shape that is different than the first shape. In some embodiments, the one or more media translate over an axis of rotation. In some embodiments, the energy beam having the third cross section is an elongated energy beam. In some embodiments, the elongated energy beam is elongated along an X-Y plane. In some embodiments, the one or more optical elements comprise an optical element having a constant focus. In some embodiments, the one or more optical elements comprise an optical element having a variable focus. In some embodiments, the variable focus is controllably varied. In some embodiments, the varied is before, after, or during at least a portion of the three-dimensional printing. In some embodiments, the at least a portion of the three-dimensional printing comprises (c). In some embodiments, the one or more optical elements comprise an optical element converging the energy beam. In some embodiments, the one or more optical elements comprise an optical element diverging the energy beam. In some embodiments, a first medium of the one or more media is translating along a different axis of rotation than a second medium. In some embodiments, the first medium does not contact the second medium of the one or more media when translating. In some embodiments, a position of the first medium in relation to a position of the second medium of the one or more media is varying a degree of the astigmatic. In some embodiments, the method further comprises altering the position of the first medium to vary the degree of the astigmatic. In some embodiments, the method further comprises altering the position of the second medium to vary the degree of the astigmatic. In some embodiments, altering comprises altering an angular position of the first medium and/or the second medium.

In another aspect, an apparatus for printing a three-dimensional object (e.g., using 3D printing) comprises: a target surface configured to support the three-dimensional object; (e.g., optionally a pre-transformed material disposed at or adjacent to a target surface;) an energy source generating an energy beam that transforms a pre-transformed material into a transformed material (as part of the three-dimensional object), wherein the energy source is disposed adjacent to the target surface; and one or more controllers that are operatively coupled to the energy beam and direct the energy beam to translate (i) along a first trajectory in a first direction and irradiate the pre-transformed material to form a first portion of transformed material on the target surface, (ii) along a second trajectory to form a second portion of transformed material that at least partially overlaps the first portion of transformed material, which second trajectory is back tracking at least a portion of the first trajectory, and (iii) along a third trajectory to form a third portion of transformed material that at least partially overlaps the second portion of transformed material, wherein the transformed material forms the three-dimensional object by three-dimensional printing.

In some embodiments, at least two of (i), (ii), and (iii) are directed by different controllers that are operatively coupled. In some embodiments, at least two of (i), (ii), and (iii) are directed by the same controller.

In another aspect, a system for printing a three-dimensional object (e.g., using 3D printing) comprises: a target surface configured to support the three-dimensional object; (e.g., optionally a pre-transformed material disposed at or adjacent to a target surface); an energy source generating an energy beam that transforms a pre-transformed material to form a transformed material, which energy beam translates along a first trajectory in a first direction, wherein the energy source is disposed adjacent to the target surface; and at least one controller that is operatively coupled to the energy source and is configured (e.g., programmed) to direct the energy beam to irradiate and translate: (i) along a first trajectory to form a first portion of the transformed material on the target surface, (ii) along a second trajectory to form a second portion of transformed material that at least partially overlaps the first portion of the transformed material, which second trajectory is back tracking at least a portion of the first trajectory, and (iii) along a third trajectory to form a third portion of transformed material that at least partially overlaps the second portion of transformed material, wherein the transformed material forms the three-dimensional object by three-dimensional printing.

In some embodiments, at least two of (i), (ii), and (iii) are directed by different controllers that are operatively coupled. In some embodiments, at least two of (i), (ii), and (iii) are directed by the same controller.

In another aspect, a method for generating (e.g., printing) a three-dimensional object comprises: (a) irradiating a first portion of a pre-transformed material with a translating energy beam that translates along a first trajectory in a first direction to form a first portion of transformed material on a target surface; (b) irradiating and moving the translating energy beam along a second trajectory to form a second portion of transformed material that at least partially overlaps the first portion of transformed material, which second trajectory is back tracking at least a portion of the first trajectory; and (c) irradiating and moving the translating energy beam along a third trajectory to form a third portion of transformed material that at least partially overlaps the second portion of transformed material, which third trajectory back tracks at least a portion of the second trajectory, wherein the transformed material forms the three-dimensional object by three-dimensional printing.

In some embodiments, the second trajectory is shorter than the first trajectory. In some embodiments, the third trajectory is longer than the second trajectory and supersedes the first trajectory along the first direction.

In another aspect, a system for generating a three-dimensional object comprises: a first energy source configured to generate a first energy beam to transform a first pre-transformed material into a first transformed material; a first scanner that is configured to direct the first energy beam to a target surface at or adjacent to the first pre-transformed material within a first cone that intersects the target surface and forms a first cross section, which first scanner is movable; a second energy source configured to generate a second energy beam to transform a second pre-transformed material at or adjacent to the target surface to a second transformed material; a second scanner that is configured to direct the second energy beam to the target surface within a second cone that intersects the target surface and forms a second cross section, which second scanner is movable, which first scanner is disposed parallel to the target surface; and at least one controller that is operatively coupled to at least one of the target surface, the first energy source, the first scanner, the second energy source, or the second scanner, which at least one controller is configured (e.g., programmed) to direct performance of the following operations: (I) move the first scanner to direct the first energy beam through the first cone, (II) move the second scanner to direct the second energy beam through the second cone, (III) direct the first scanner and the second scanner to move such that the first cone and the second cone maximally overlap on the target surface, wherein the first transformed material and the second transformed material form the three-dimensional object by three-dimensional printing.

In some embodiments, the at least one controller comprises two different controllers that are configured to perform at least one of (I), (II) or (III), respectively. In some embodiments, one controller is configured to perform (I), (II) or (III). In some embodiments, the at least one controller is configured to perform one or more of (I), (II) or (III) via feedback control or feed-forward control. In some embodiments, the feedback control comprises closed loop control. In some embodiments, the at least one controller is configured to perform one or more of (I), (II) or (III) in real time. In some embodiments, the system further comprises a detector disposed such that it is devoid of a direct view of incidence of the first energy beam and the second energy beam on the target surface. In some embodiments, the at least one controller is configured to perform the feedback control by adjustment to one or more of (I), (II) or (III) based on measurements from the detector. In some embodiments, the system further comprises a platform that comprises the target surface, and an enclosure that comprises the first scanner and the second scanner. In some embodiments, the enclosure comprises a bottom surface. In some embodiments, the at least one controller is configured to pass the first energy beam and the second energy beam therethrough, which bottom surface is disposed parallel with respect to the platform. In some embodiments, the platform is configured for translation. In some embodiments, the translation is at least one of horizontal, vertical, or angular translation. In some embodiments, the at least one controller is operatively coupled with the platform and is configured to translate the platform to perform (III). In some embodiments, the system further comprises a detector disposed such that it is devoid of a direct view of the target surface. In some embodiments, the at least one controller is configured to perform feedback control by adjustment to one or more of (I), (II), or (III) based on measurements from the detector. In some embodiments, the system further comprises an optical window that comprises a high thermal conductivity material. In some embodiments, the at least one controller is configured to pass one or more of the first energy beam or the second energy beam therethrough. In some embodiments, the optical window comprises a high thermal conductivity optical element comprising sapphire, crystal quartz, zinc selenide (ZnSe), magnesium fluoride (MgF₂), calcium fluoride (CaF₂), fused silica, borosilicate, silicon fluoride, or Pyrex®. In some embodiments, the first scanner and/or the second scanner is disposed parallel to the target surface.

In another aspect, a method for generating a three-dimensional object comprises: (a) irradiating a first pre-transformed material with a first energy beam, wherein the irradiating in (a) is confined in a first processing cone, at or adjacent to a target surface to form a first transformed material; and (b) irradiating a second pre-transformed material with a second energy beam, wherein the irradiating in (b) is confined in a second processing cone, at or adjacent to the target surface to form a second transformed material, wherein the first processing cone and the second processing cone maximally overlap on the target surface, wherein the first transformed material and the second transformed material form the three-dimensional object by three-dimensional printing.

In some embodiments, the method further comprises directing the first energy beam and the second energy beam with a first scanner and a second scanner, respectively, the first scanner and the second scanner enclosed in an enclosure having a bottom surface. In some embodiments, the first energy beam and the second energy beam are passing through the bottom surface, which bottom surface is disposed parallel with respect to a platform supporting the first pre-transformed material and the second pre-transformed material. In some embodiments, the method comprises the platform translating to maintain one or more of the first processing cone or the second processing cone. In some embodiments, the method further comprises directing the first energy beam and the second energy beam through an optical window that comprises a high thermal conductivity material, the optical window housed in the bottom surface. In some embodiments, the high thermal conductivity material comprising sapphire, crystal quartz, zinc selenide (ZnSe), magnesium fluoride (MgF₂), calcium fluoride (CaF₂), fused silica, borosilicate, silicon fluoride, or Pyrex®. In some embodiments, the first scanner and/or the second scanner is disposed parallel to the target surface.

In another aspect, an apparatus for printing a three-dimensional object (e.g., using 3D printing) comprises: a first energy source that generates (e.g., is configured to generate) a first energy beam to provide to a first scanner to (a) irradiate a first pre-transformed material at or adjacent to a target surface to form a first transformed material, wherein to irradiate in (a) is confined in a first processing cone; and a second energy source that generates (e.g., is configured to generate) a second energy beam to provide to a second scanner to (b) irradiate a second pre-transformed material at or adjacent to the target surface to form a second transformed material, wherein to irradiate in (b) is confined in a second processing cone, wherein the first processing cone and the second processing cone maximally overlap on the target surface, wherein the first transformed material and the second transformed material form the three-dimensional object by three-dimensional printing.

In some embodiments, the first transformed material is different from the second transformed material. In some embodiments, the first transformed material is the second transformed material. In some embodiments, the first transformed material is different from the second transformed material by at least one energy beam characteristics or type. In some embodiments, the first transformed material is identical to the second transformed material by at least one energy beam characteristics or type. In some embodiments, the apparatus further comprises a platform that comprises the target surface, and an enclosure that comprises the first scanner and the second scanner. In some embodiments, the enclosure comprises a bottom surface configured to pass the first energy beam and the second energy beam therethrough, which bottom surface is disposed parallel with respect to the platform. In some embodiments, the first scanner and/or the second scanner is disposed parallel to the target surface.

In another aspect, a system for printing a three-dimensional object (e.g., using 3D printing) comprises: a target surface configured to support the three-dimensional object; (e.g., optionally, a pre-transformed material disposed at or adjacent to a target surface); a first energy source configured to generate a first energy beam to transform a first portion of a pre-transformed material at or adjacent to the target surface to a first portion of transformed material, wherein the first energy source is disposed adjacent to the target surface; a first optical element that directs (e.g., is configured to direct) the first energy beam to the target surface within a first cone that intersects the target surface and forms a first cross section, which first optical element is movable, wherein the first optical element is disposed adjacent to the target surface; a second energy source generating (e.g., is configured to generate) a second energy beam to transform a second portion of the pre-transformed material at or adjacent to the target surface to a second portion of transformed material, wherein the first energy source is disposed adjacent to the target surface; a second optical element that directs (e.g., is configured to direct) the second energy beam to the target surface within a second cone that intersects the target surface and forms a second cross section, which second optical element is movable, wherein the second optical element is disposed adjacent to the first optical element in a manner that facilitates maximal overlap of the first cone, the second cone, and the target surface; and at least one controller that is operatively coupled to (e.g., one or more of) the target surface, the first energy source and the second energy source and is configured (e.g., programmed) to direct: (I) moving the first optical element to direct the first energy beam to the target surface in the first cone, (II) moving the second optical element to direct the second energy beam to the target surface in the second cone, wherein the (i) first energy beam generates the first portion of transformed material, (ii) the second energy beam generates the second portion of transformed material, or (iii) both (i) and (ii), as part of the three-dimensional object.

In some embodiments, the at least one controller is a plurality of (e.g., different) controllers that are operatively coupled, and wherein (I) and (II) are directed by different controllers. In some embodiments, (I) and (II) are directed by the same controller. In some embodiments, the system further comprises a platform that comprises the target surface, and an enclosure that comprises the first optical element and the second optical element. In some embodiments, the enclosure comprises a bottom surface configured to pass the first energy beam and the second energy beam therethrough, which bottom surface is disposed parallel with respect to the platform. In some embodiments, the first scanner and/or the second scanner is disposed parallel to the target surface.

Another aspect of the present disclosure provides a system for effectuating the methods disclosed herein.

Another aspect of the present disclosure provides an apparatus for effectuating the methods disclosed herein.

Another aspect of the present disclosure provides an apparatus comprising a controller that directs effectuating one or more steps in the method disclosed herein, wherein the controller is operatively coupled to the apparatuses, systems, and/or mechanisms that it controls to effectuate the method.

Another aspect of the present disclosure provides a computer system comprising one or more computer processors and a non-transitory computer-readable medium coupled thereto. The non-transitory computer-readable medium comprises machine-executable code that, upon execution by the one or more computer processors, implements any of the methods (or any operations thereof) above or elsewhere herein.

Another aspect of the present disclosure provides an apparatus for printing one or more 3D objects comprises a controller that is programmed to direct a mechanism used in a 3D printing methodology to implement (e.g., effectuate) any of the method disclosed herein, wherein the controller is operatively coupled to the mechanism.

Another aspect of the present disclosure provides a computer software product, comprising a non-transitory computer-readable medium in which program instructions are stored, which instructions, when read by a computer, cause the computer to direct a mechanism used in the 3D printing process to implement (e.g., effectuate) any of the method (or any operations thereof) disclosed herein, wherein the non-transitory computer-readable medium is operatively coupled to the mechanism.

Another aspect of the present disclosure provides a non-transitory computer-readable medium comprising machine-executable code that, upon execution by one or more computer processors, implements any of the methods (or any operations thereof) disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGs.” herein), of which:

FIG. 1 shows a schematic side view of a 3D printing system and apparatuses.

FIG. 2 schematically illustrates a path;

FIG. 3 schematically illustrates various paths;

FIG. 4 schematically illustrates an optical system;

FIG. 5 schematically illustrates a computer control system that is programmed or otherwise configured to facilitate the formation of one or more 3D objects;

FIG. 6 schematically illustrates spatial intensity profiles of irradiating energy;

FIG. 7 shows a schematic side view of a 3D printing system and apparatuses;

FIG. 8 shows various vertical cross-sectional views of different 3D objects;

FIG. 9 shows a horizontal view of a 3D object;

FIG. 10 schematically illustrates a control system used in the formation of one or more 3D objects;

FIG. 11 schematically illustrates a detection system and its components used in the formation of one or more 3D objects;

FIG. 12 schematically illustrates a vertical cross section in a portion of an optical detection system;

FIG. 13 schematically illustrates an optical system used in the formation of one or more 3D objects;

FIGS. 14A-14D schematically illustrates an energy beam and components used in the formation of one or more 3D objects, and FIG. 14E illustrates a graph depicting a relation between a position of an energy beam as a function of time;

FIGS. 15A-15B schematically illustrate components of an optical system used in the formation of one or more 3D objects;

FIGS. 16A-16B show schematic representations of a material bed;

FIG. 17 schematically illustrates an optical system used in the formation of one or more 3D objects;

FIG. 18 schematically illustrates a vertical cross section in portion of an optical detection system;

FIG. 19 shows a schematic a side view of an optical system used in the formation of one or more 3D objects; and

FIG. 20 shows a schematic side view of an optical system chamber used in the formation of one or more 3D objects.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an” and “the” are not intended to refer to only a singular entity, but include the general class of which a specific example may be used for illustration. The terminology herein is used to describe specific embodiments of the invention, but their usage does not delimit the invention. When ranges are mentioned, the ranges are meant to be inclusive, unless otherwise specified. For example, a range between value 1 and value2 is meant to be inclusive and include value 1 and value2. The inclusive range will span any value from about value 1 to about value2.

The term “adjacent” or “adjacent to,” as used herein, includes ‘next to’, ‘adjoining’, ‘in contact with,’ and ‘in proximity to.’ In some instances, adjacent to may be ‘above’ or ‘below.’

The term “between” as used herein is meant to be inclusive unless otherwise specified. For example, between X and Y is understood herein to mean from X to Y.

The term “operatively coupled” or “operatively connected” refers to a first mechanism that is coupled (or connected) to a second mechanism to allow the intended operation of the second and/or first mechanism.

The phrase “a three-dimensional object” used herein may refer to “one or more three-dimensional objects,” as applicable.

Three-dimensional printing (also “3D printing”) generally refers to a process for generating a 3D object. The apparatuses, methods, controllers, and/or software described herein pertaining to generating (e.g., forming, or printing) a 3D object, pertain also to generating one or more 3D objects. For example, 3D printing may refer to sequential addition of material layer or joining of material layers (or parts of material layers) to form a 3D structure, in a controlled manner. The controlled manner may include automated control. In the 3D printing process, the deposited material can be transformed (e.g., fused, sintered, melted, bound, or otherwise connected) to subsequently harden and form at least a part of the 3D object. Fusing (e.g., sintering or melting) binding, or otherwise connecting the material is collectively referred to herein as transforming the material (e.g., powder material). Fusing the material may include melting or sintering the material. Binding can comprise chemical bonding. Chemical bonding can comprise covalent bonding. Examples of 3D printing include additive printing (e.g., layer by layer printing, or additive manufacturing). 3D printing may include layered manufacturing. 3D printing may include rapid prototyping. 3D printing may include solid freeform fabrication. The 3D printing may further comprise subtractive printing.

3D printing methodologies can comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition.

3D printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

The methods, apparatuses, and systems of the present disclosure can be used to form 3D objects for various uses and applications. Such uses and applications include, without limitation, electronics, components of electronics (e.g., casings), machines, parts of machines, tools, implants, prosthetics, fashion items, clothing, shoes, or jewelry. The implants may be directed (e.g., integrated) to a hard tissue, a soft tissue, or to a combination of hard and soft tissues. The implants may form adhesion with hard and/or soft tissue. The machines may include a motor or motor part. The machines may include a vehicle. The machines may comprise aerospace related machines. The machines may comprise airborne machines. The vehicle may include an airplane, drone, car, train, bicycle, boat, or shuttle (e.g., space shuttle). The machine may include a satellite or a missile. The uses and applications may include 3D objects relating to the industries and/or products listed herein.

The present disclosure provides systems, apparatuses, and/or methods for 3D printing of a desired 3D object from a pre-transformed material (e.g., powder material). The object can be pre-ordered, pre-designed, pre-modeled, or designed in real time (i.e., during the process of 3D printing). The 3D printing method can be an additive method in which a first layer is printed, and thereafter a volume of a material is added to the first layer as a separate sequential layer (or parts thereof). Each additional sequential layer (or part thereof) can be added to the previous layer by transforming (e.g., fusing (e.g., melting)) a fraction of the pre-transformed (e.g., powder) material and subsequently hardening the transformed material to form at least a portion of the 3D object. The hardening can be actively induced (e.g., by cooling) or can occur without intervention.

Pre-transformed material, as understood herein, is a material before it has been first transformed (e.g., once transformed) by an energy beam and/or flux during the 3D printing process. The pre-transformed material may be a material that was, or was not, transformed prior to its use in the 3D printing process. The pre-transformed material may be a material that was partially transformed prior to its use in the 3D printing process. The pre-transformed material may be a starting material for the 3D printing process. The pre-transformed material may be liquid, solid, or semi-solid (e.g., gel). The pre-transformed material may be a particulate material. The particulate material may be a powder material. The powder material may comprise solid particles of material. The particulate material may comprise vesicles (e.g., containing liquid or semi-solid material). The particulate material may comprise solid or semi-solid material particles.

The fundamental length scale (e.g., the diameter, spherical equivalent diameter, diameter of a bounding circle, or the largest of height, width and length; abbreviated herein as “FLS”) of the printed 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object can be at most about 1000 m, 500 m, 100 m, 80 m, 50 m, 10 m, 5 m, 4 m, 3 m, 2 m, 1 m, 90 cm, 80 cm, 60 cm, 50 cm, 40 cm, 30 cm, 20 cm, 10 cm, or 5 cm. In some cases, the FLS of the printed 3D object may be in between any of the afore-mentioned FLSs (e.g., from about 50 μm to about 1000 m, from about 120 μm to about 1000 m, from about 120 μm to about 10 m, from about 200 μm to about 1 m, or from about 150 μm to about 10 m).

In some instances, it is desired to control the manner in which at least a portion of a layer of hardened material is formed. The layer of hardened material may comprise a multiplicity of melt pools. In some instances, it may be desired to control one or more characteristics of the melt pools that form the layer of hardened material. The characteristics may comprise the depth of a melt pool, microstructure, or the repertoire of microstructures of the melt pool. The microstructure of the melt pool may comprise the crystalline structure, or crystalline structure repertoire that is included in the melt pool.

The FLS (e.g., depth, or diameter) of the melt pool may be at least about 0.5 μm, 1 μm, 5 μm, 10 μm, 20 μm, 30 μm, 40 μm, or 50 μm. The FLS of the melt pool may be at most about 0.5 μm, 1 μm, 5 μm, 10 μm, 20 μm, 30 μm, 40 μm, or 50 μm. The FLS of the melt pool may be any value between the aforementioned values (e.g., from about 0.5 μm to about 50 μm, from about 0.5 μm to about 10 μm, from about 10 μm to about 30 μm, or from about 30 μm to about 50 μm.

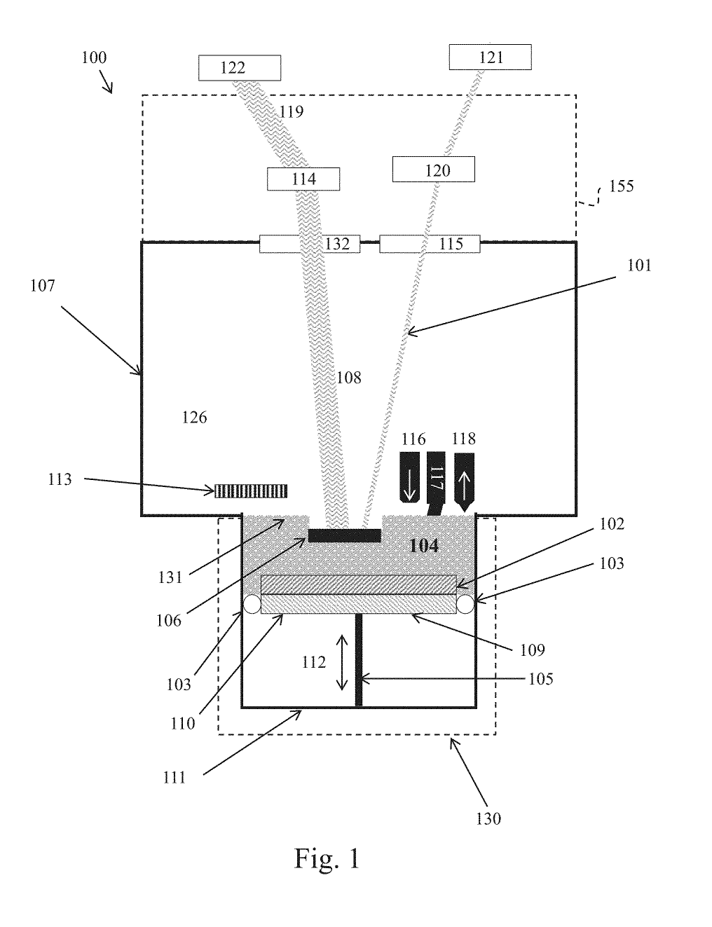

Transforming (e.g., tiling) may comprise heating at least a portion of a target surface (e.g., exposed surface of a material bed), and/or a previously formed area of hardened material using at least one energy source. The energy source may generate an energy beam. The energy source may be a radiative energy source. The energy source may be a dispersive energy source (e.g., a fiber laser). The energy source may generate a substantially uniform (e.g., homogenous) energy stream. The energy source may comprise a cross section having (e.g., footprint) a substantially homogenous fluence. The energy generated for transforming a portion of material (e.g., pre-transformed or transformed), by the energy source will be referred herein as the “energy flux.” The energy flux can be provided to the material as an energy beam (e.g., tiling energy beam). The energy flux may heat a portion of a 3D object (e.g., an exposed surface of the 3D object). The energy flux may heat a portion of the target surface (e.g., an exposed surface of the material bed, and/or a deeper portion of the material bed that is not exposed). The target surface may include surface(s) of a pre-transformed material, a partially transformed material and/or a transformed material. The target surface may include a portion of the build platform (e.g., the base (e.g., FIG. 1, 102)). The target surface may comprise a (surface) portion of a 3D object. The heating by the energy flux may be substantially uniform.

The energy flux may irradiate (e.g., flash, flare, shine, or stream) a target surface for a period of time (e.g., a predetermined period of time). The time in which the energy flux (e.g., beam) irradiates may be referred to as a dwell time of the energy flux. During this period of time (e.g., dwell time), the energy flux may be substantially stationary. During that period of time, the energy may substantially not translate (e.g., neither in a raster form nor in a vector form). During this period of time (e.g., dwell time) the energy density of the energy flux may be constant. In some embodiments, during this period of time (e.g., dwell time) the energy density of the energy flux may vary. The variation may be predetermined. The variation may be controlled (e.g., by a controller). The controller may determine the variation based on a signal received by one or more sensors. The controller may determine the variation based on an algorithm. The controlled variation may be based on closed loop or open loop control. For example, the variation may be determined based on temperature and/or imaging measurements. The variation may be determined by melt pool size evaluation. The variation may be determined based on height measurements.

The energy flux may emit energy stream towards the target surface in a step and repeat sequence. The energy flux may emit energy stream towards the target surface in a step and tiling heating or tile filling process. The energy flux may comprise a radiative heat, electromagnetic radiation, charge particle radiation (e.g., e-beam), or a plasma beam. The energy source may comprise a heater (e.g., radiator or lamp), an electromagnetic radiation generator (e.g., laser), a charge particle radiation generator (e.g., electron gun), or a plasma generator. The energy source may comprise a diode laser. The energy source may comprise a light emitting diode array (LED array).

The energy flux may irradiate a pre-transformed material, a transformed material, or a hardened material (e.g., within the material bed). The energy flux may irradiate a target surface. The target surface may comprise a pre-transformed material, a transformed material, or a hardened material. The tiling energy source may point and shoot an energy flux on the target surface. The energy flux may heat the target surface. The energy flux may transform the target surface (or a fraction thereof). The energy flux may preheat the target surface (e.g., to be followed by a scanning energy beam that optionally transforms at least a portion of the preheated surface). The energy flux may post-heat the target surface (e.g., following a transformation of the target surface). The energy flux may post-heat the target surface in order to reduce a cooling rate of the target surface. The heating may be at a specific location (e.g., a tile). The tile may comprise a wide exposure space (e.g., a wide footprint on the target surface). The energy flux may have a long dwell time (e.g., exposure time) that may be at least 1 millisecond, 1 minute, 1 hour, or 1 day. In principle, the energy flux may have a dwell time that is infinity. The energy flux may emit a low energy flux to control the cooling rate of a position within a layer of transformed material. The low cooling rate may control the solidification of the transformed (e.g., molten) material. The low cooling rate may allow formation of crystals (e.g., single crystals) at specified location within the layer that is included in the 3D object.

The energy flux may transform (e.g., melt) a portion of a 3D object (e.g., an exposed surface of the 3D object). The energy flux may transform (e.g., fuse) a portion of the powder bed (e.g., an exposed surface of the powder bed, a deeper portion of the powder bed that is not exposed), and/or a portion of a powder stream (e.g., directed toward a target surface). The transformation may be substantially uniform.

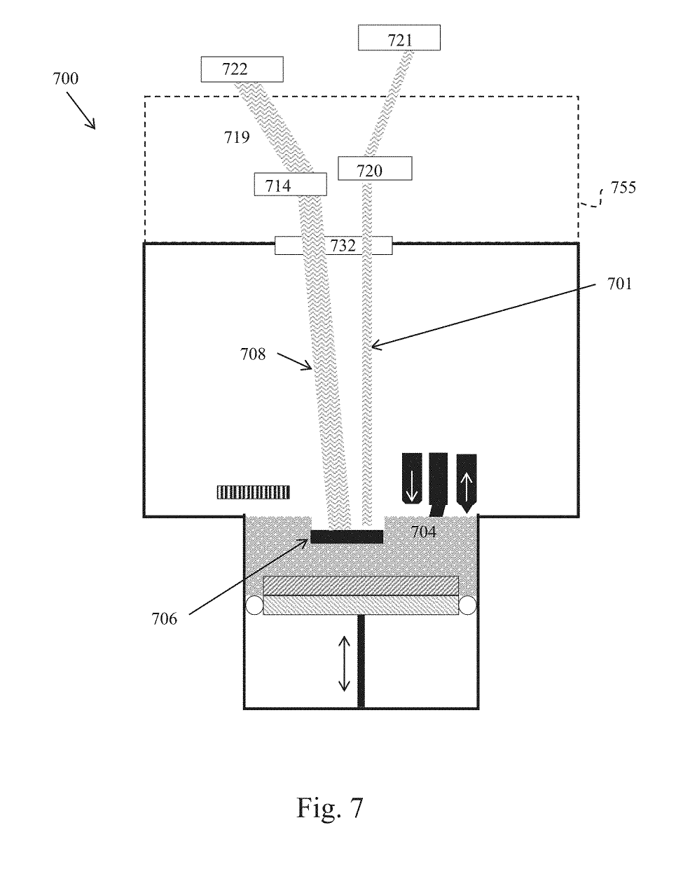

FIG. 1 shows an example of a 3D printing system 100 and apparatuses, a (e.g., first) energy source 122 (e.g., a tiling energy source) that emits a (e.g., first) energy beam 119 (which can provide an energy flux). In the example of FIG. 1 the energy flux travels through an optical system (e.g. 114, comprising an aperture, lens, mirror, beam splitter, or deflector) and an optical window (e.g., 132) to heat a target surface 131. The target surface may be a portion of a hardened material (e.g., 106) that was formed by transforming at least a portion of a target surface (e.g., 131) by a (e.g., scanning) energy beam. In the example of FIG. 1 a (e.g., second) (e.g., scanning) energy beam 101 is generated by a (e.g., second) energy source 121. The generated (e.g., second) energy beam may travel through an optical mechanism (e.g., 120) and/or an optical window (e.g., 115). The first energy beam (which can provide an energy flux) and the second, (e.g., scanning energy beam) may travel through the same optical window and/or through the same optical system. At times, the energy flux and the first (e.g., scanning) energy beam may travel through their respective optical systems and through the same optical window. FIG. 7 shows an example of a 3D printing system 700 where the energy flux 719 (e.g., second energy beam) and a (e.g., scanning) first energy beam (e.g., emitted from scanning energy source 721) 701 travel through their respective optical systems 714, 720, respectively, and through the same optical window 732. In the example of FIG. 7, the energy flux 719 (e.g., second energy beam), after passing through the optical window 732, forms emitted radiated energy 708. The emitted radiated energy (e.g., 708) and first (e.g., scanning) energy beam (e.g., 701) may be incident on a hardened material (e.g., 706) within a material bed (e.g., 704). An optical window (e.g., 732) may be a material (e.g., transparent material) that allows the irradiating energy to travel through it without (e.g., substantial) loss of radiation. The optical window can be a high thermal conductivity material (e.g., a sapphire optical window) as described herein. Substantial may be relevant to the purpose of the radiation. In some embodiments, the energy flux, and the scanning energy beam both travel through the same optical system, albeit through different components within the optical system and/or at different instances. In some embodiments, the energy flux, and the scanning energy beam both travel through the same optical system, albeit through different configurations of the optical system and/or at different instances. The emitted radiative energy (e.g., FIG. 1, 108) may travel through an aperture, deflector, and/or other parts of an optical mechanism (e.g., schematically represented as FIG. 1, 114). The aperture may restrict the amount of energy exerted by the tiling energy source. The aperture restriction may redact (e.g., cut off, block, obstruct, or discontinue) the energy beam to form a desired shape of a tile.

In the example shown in FIG. 1, a part (e.g., hardened material 106) represents a layer of transformed material in a material bed 104. The material bed may be disposed (e.g., anchorlessly) above a platform. The platform may comprise a substrate (e.g., 110) and/or a base (e.g., 102). FIG. 1 shows an example of sealants 103 that prevent the pre-transformed material from spilling from the material bed (e.g., 104) to the bottom 111 of an enclosure 107. The platform may translate (e.g., vertically, FIG. 1, 112) using a translating mechanism (e.g., an elevator 105). The translating mechanism may travel in the direction to or away from the bottom of the enclosure (e.g., 111) (e.g., vertically). For example, the platform may decrease in height before a new layer of pre-transformed material is dispensed by the material dispensing mechanism (e.g., 116). The top surface of the material bed (e.g., 131) may be leveled using a leveling mechanism (e.g., comprising parts 117 and 118). The mechanism may further include a cooling member (e.g., heat sink 113). The interior of the enclosure (e.g., 126) may comprise an inert gas or an oxygen and/or humidity reduced atmosphere. The atmosphere may be any atmosphere disclosed in patent application number PCT/US15/36802, titled “APPARATUSES, SYSTEMS AND METHODS FOR THREE-DIMENSIONAL PRINTING” that was filed on Jun. 19, 2015, which is incorporated herein by reference in its entirety.

In the example of FIG. 1, the 3D printing system comprises a processing chamber which comprises the irradiating energy and the target surface (e.g., comprising the atmosphere in the interior, e.g., 126). For example, the processing chamber may comprise a second (e.g., scanning) energy beam (e.g., FIG. 1, 101) and/or the first energy beam (e.g., energy flux) (e.g., FIG. 1, 108). The enclosure may comprise one or more build modules (e.g., enclosed in the dashed area 130). At times, at least one build module may be situated in the enclosure comprising the processing chamber. At times, at least one build module may engage with the processing chamber (e.g., FIG. 1) (e.g., 107). At times, a plurality of build modules may be coupled to the enclosure. The build module may reversibly engage with (e.g., couple to) the processing chamber. The engagement of the build module may be before or after the 3D printing. The engagement of the build module with the processing chamber may be controlled (e.g., by a controller, such as for example by a microcontroller). The controller may direct the engagement and/or dis-engagement of the build module. The control may be automatic and/or manual. The engagement of the build module with the processing chamber may be reversible. In some embodiments, the engagement of the build module with the processing chamber may be non-reversible (e.g., stable). The FLS (e.g., width, depth, and/or height) of the processing chamber can be at least about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m, or 5 m. The FLS of the processing chamber can be at most about 50 millimeters (mm), 60 mm, 70 mm, 80 mm, 90 mm, 100 mm, 200 mm, 250 mm, 400 mm, 500 mm, 800 mm, 900 mm, 1 meter (m), 2 m, or 5 m. The FLS of the processing chamber can be between any of the afore-mentioned values (e.g., 50 mm to about 5 m, from about 250 mm to about 500 mm, or from about 500 mm to about 5 m).

In one example of additive manufacturing, a layer of pre-transformed material (e.g., powder material) is disposed adjacent to the platform using the pre-transformed material dispensing mechanism (e.g., FIG. 1, 116); the layer is leveled using a leveling mechanism and a material removal mechanism (e.g., FIGS. 1, 117 and 118 respectively); an energy beam (e.g., FIG. 1, 101) and/or an energy flux (e.g., FIG. 1, 108) may be directed towards the target surface to transform at least a portion of the pre-transformed material to form a transformed material; the platform is lowered; a new layer of pre-transformed material is disposed into the material bed; that new layer is leveled and subsequently irradiated. The process may be repeated sequentially until the desired 3D object is formed from a successive generation of layers of transformed material. In some examples, as the layers of transformed material harden, they may deform upon hardening (e.g., upon cooling). The methods, systems, apparatuses, and/or software disclosed herein may control at least one characteristic of the layer of hardened material (or a portion thereof). The methods, systems, apparatuses, and/or software disclosed herein may control the degree of deformation. The control may be an in-situ control. The control may be control during formation of the at least a portion of the 3D object. The control may comprise closed loop control. The portion may be a surface, layer, multiplicity of layers, portion of a layer, and/or portion of a multiplicity of layers. The layer of hardened material within the 3D object may comprise a multiplicity of melt pools. The layers' characteristics may comprise planarity, curvature, or radius of curvature of the layer (or a portion thereof). The characteristics may comprise the thickness of the layer (or a portion thereof). The characteristics may comprise the smoothness (e.g., planarity) of the layer (or a portion thereof).

The methods, systems, apparatuses, and/or software described herein may comprise providing a first layer of pre-transformed material (e.g., powder) in an enclosure (e.g., FIG. 1, 126) to form a material bed comprising a target surface (e.g., the exposes surface of the material bed). The first layer may be provided on a substrate or a base. The first layer may be provided on a previously formed material bed. At least a portion of the first layer of pre-transformed material may be transformed by using an energy beam and/or flux (collectively referred to herein as irradiating energy). For example, an irradiating energy may heat the at least a portion of the first layer of pre-transformed material to form a first transformed material. The first transformed material may comprise a fused material. The methods, systems, apparatuses, and/or software may further comprise disposing a second layer of pre-transformed material adjacent to (e.g., above) the first layer. At least a portion of the second layer may be transformed (e.g., with the aid of the energy beam) to form a second transformed material. The second transformed material may at least in part connect to the first transformed material to form a multi-layered object (e.g., a 3D object). Connect may comprise fuse, weld, bond, and/or attach. The first and/or second layer of transformed material may comprise a first and/or second layer of hardened material respectively. The first and/or second layer of transformed material may harden into a first and/or second layer of hardened material respectively.

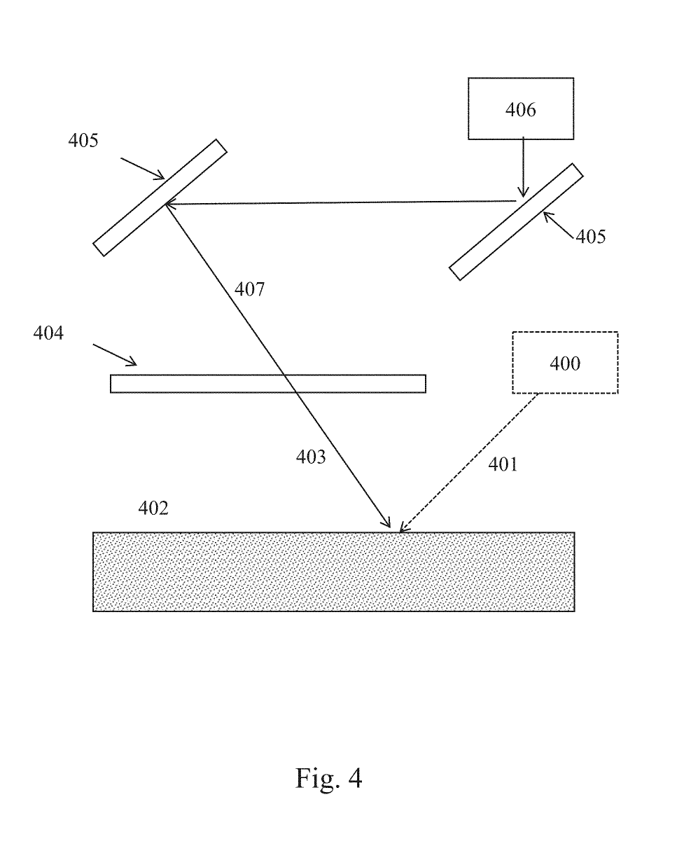

FIG. 4 shows an example of an optical mechanism in a 3D printing system: an energy source 406 irradiates energy (e.g., emits an energy beam) that travels between mirrors 405 that direct it along beam path 407 through an optical window 404 to a position on the exposed surface 402 of a material bed. An optical window can include an anti-reflective coating to pass a selected portion of an incident energy source to form a modified directed energy beam (e.g., along path 403). The energy that passes through the optical window (e.g., with an anti-reflective coating) can be measured as one or more characteristics, which may comprise wavelength, power, amplitude, flux, footprint, intensity, fluence, energy, or charge. In some cases, the anti-reflective coating can allow (e.g., substantially) all of a selected portion of an incident energy source to pass therethrough. Substantially all can correspond to at least about 80%, 85%, 90%, 95%, or 100% of the selected portion of energy. Substantially all can correspond to between any of the afore-mentioned values (e.g., from about 80% to about 100%, from about 80% to about 90%, or from about 90% to about 100% of selected portion of energy). The energy beam may also be directly projected on the exposed surface, for example, an energy beam (e.g., 401) can be generated by an energy source (e.g., 400) (e.g., that may comprise an internal optical mechanism, such as within a laser) and be directly projected onto the target surface.

The hardened material may comprise at least a portion of one or more (e.g., a few) layers of hardened material disposed above a pre-transformed material (e.g., powder) disposed in the material bed. The one or more layers of hardened material may be susceptible to deformation during formation, or not susceptible to deformation during formation. The deformation may comprise bending, warping, arching, curving, twisting, balling, cracking, or dislocating. In some examples, the at least a portion of the one or more layers of hardened material may comprise a ledge or a ceiling of a cavity. The deformation may arise, for example, when the formed 3D object (or a portion thereof) lacks auxiliary support structure(s). The deformation may arise, for example, when the formed structure (e.g., 3D object or a portion thereof) floats anchorless in the material bed.

The energy flux may comprise (i) an extended exposure area, (ii) extended exposure time, (iii) low power density (e.g., power per unit area) or (iv) an intensity profile that can fill an area with a flat (e.g., tophead) energy profile.

The extended exposure time may be at least about 1 millisecond and at most 100 milliseconds. In some embodiments, an energy profile of the tiling energy source may exclude a Gaussian beam or round top beam. In some embodiments, an energy profile of the tiling energy source may include a Gaussian beam or round top beam. In some embodiments, the 3D printer comprises a first and/or second scanning energy beams. In some embodiments, an energy profile of the first and/or second scanning energy may comprise a Gaussian energy beam. In some embodiments, an energy profile of the first and/or second scanning energy may exclude a Gaussian energy beam. The first and/or second scanning energy may have any cross-sectional shape comprising an ellipse (e.g., circle), or a polygon (e.g., as disclosed herein). The scanning energy beam may have a cross section with a diameter of at least about 50 micrometers (μm), 100 μm, 150 μm, 200 μm, or 250 μm. The scanning energy beam may have a cross section with a diameter of at most about 60 micrometers (μm), 100 μm, 150 μm, 200 μm, or 250 μm. The scanning energy beam may have a cross section with a diameter of any value between the aforementioned values (e.g., from about 50 μm to about 250 μm, from about 50 μm to about 150 μm, or from about 150 μm to about 250 μm). The power density (e.g., power per unit area) of the scanning energy beam may at least about 10000 W/mm², 20000 W/mm², 30000 W/mm², 50000 W/mm², 60000 W/mm², 70000 W/mm², 80000 W/mm², 90000 W/mm², or 100000 W/mm². The power density of the scanning energy beam may be at most about 10000 W/mm², 20000 W/mm², 30000 W/mm², 50000 W/mm², 60000 W/mm², 70000 W/mm², 80000 W/mm², 90000 W/mm², or 100000 W/mm². The power density of the scanning energy beam may be any value between the aforementioned values (e.g., from about 10000 W/mm² to about 100000 W/mm², from about 10000 W/mm² to about 50000 W/mm², or from about 50000 W/mm² to about 100000 W/mm²). The scanning speed of the scanning energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the scanning energy beam may be at most about 50 mm/sec, 100 mm/sec, 500 mm/sec, 1000 mm/sec, 2000 mm/sec, 3000 mm/sec, 4000 mm/sec, or 50000 mm/sec. The scanning speed of the scanning energy beam may any value between the aforementioned values (e.g., from about 50 mm/sec to about 50000 mm/sec, from about 50 mm/sec to about 3000 mm/sec, or from about 2000 mm/sec to about 50000 mm/sec). The second scanning energy beam may be continuous or non-continuous (e.g., pulsing). The scanning energy beam may compensate for heat loss at the edges of the target surface after the heat tiling process.

In some embodiments, the tiling energy source may be the same as the scanning energy source. The tiling energy source may be different than the scanning energy source. FIG. 1 shows an example where the tiling energy source 122 is different from the scanning energy source 121. The tiling energy source may travel through an identical, or a different optical window than the scanning energy source. FIG. 1 shows an example where the energy flux 119 (e.g., from energy source 122) travels through one optical window 132, and the (e.g., scanning) energy 101 travels through a second optical window 115 that is different. The tiling energy source and/or scanning energy source can be disposed within the enclosure, outside of the enclosure (e.g., as in FIG. 1), or within at least one wall of the enclosure. The optical mechanism through which the energy flux and/or the scanning energy beam travel can be disposed within the enclosure, outside of the enclosure, or within at least one wall of the enclosure (e.g., as in FIGS. 1, 132 and 115). In some embodiments, the optical mechanism is disposed within its own enclosure (e.g., optical enclosure FIG. 1, 155; FIG. 7, 755). The optical enclosure may optionally be coupled with the processing chamber.

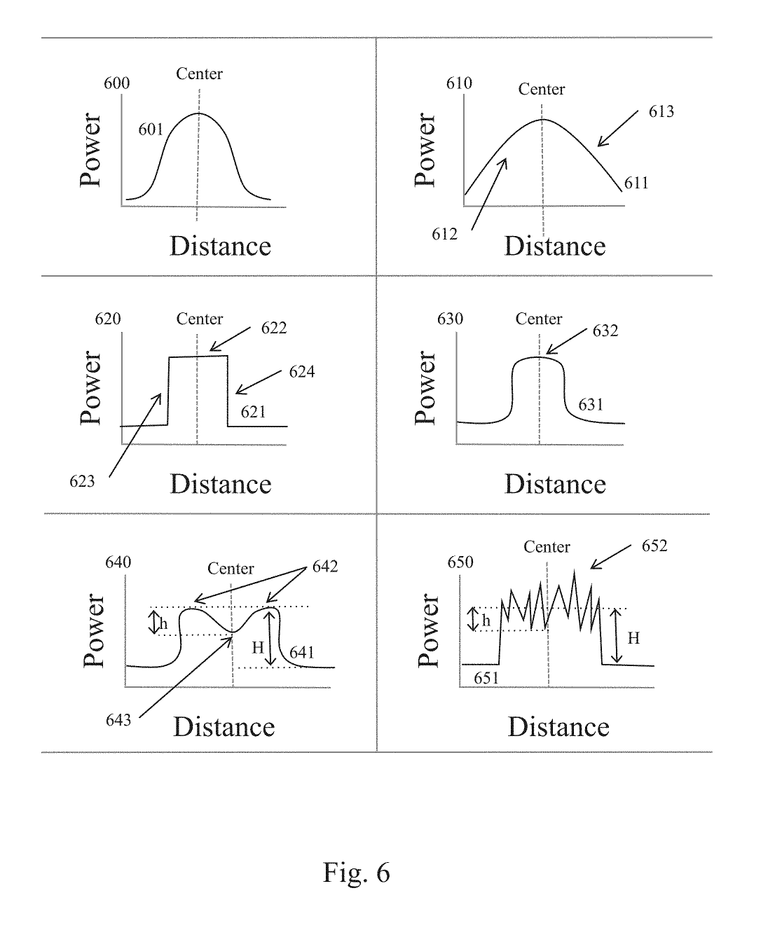

The profile of the energy flux (e.g. beam) may represent the spatial intensity profile of the energy flux (e.g., beam) at a particular plane transverse to the beam propagation path. FIG. 6 shows examples of energy flux profiles (e.g., energy as a function of distance from the center of the energy flux (e.g., beam)).

The energy flux profile (e.g., energy beam profile) may be represented as the power or energy of the energy flux plotted as a function of a distance within its cross section (e.g., that is perpendicular to its propagation path). The energy flux profile of the energy flux may be substantially uniform (e.g., homogenous). The energy flux profile may correspond to the energy flux. The energy beam profile may correspond to the first scanning energy beam and/or the second scanning energy beam.

The system and/or apparatus may comprise an energy profile alteration device that evens (e.g., is configured to smooth, or flatten) out any irregularities in the energy flux profile. The system and/or apparatus may comprise an energy profile alteration device that creates a more uniform energy flux profile. The energy profile alteration device may comprise an energy flux (e.g., beam) homogenizer. The homogenizer can comprise a mirror. The mirror may be multifaceted. The mirror may comprise square facets. The mirror may reflect the energy flux at various (e.g., different) angles to create a beam with a more uniform power across at least a portion (e.g., the entire) beam profile (e.g., resulting in a “top hat” profile), as compared to the original (e.g., incoming) energy flux. The energy profile alteration device may output a substantially evenly distributed power/energy of the energy flux (e.g., energy flux profile) instead of its original energy flux profile shape (e.g., Gaussian shape). The energy profile alteration device may comprise an energy flux profile shaper (e.g., beam shaper). The energy profile alteration device may create a certain shape to the energy flux profile. The energy profile alteration device may spread the central concentrated energy within the energy flux profile among the energy flux cross section (e.g., FLS of the energy flux, or FLS of the tile (a.k.a. “stamp”)). The energy profile alteration device may output a grainy energy flux profile. The energy profile alteration device may comprise a dispersive or partially transparent glass. The glass can be a frosted, milky, or murky glass. The energy profile alteration device may generate a blurry energy flux. The energy profile alteration device may generate a defocused energy flux, after which the energy flux that entered the energy profile alteration device will emerge as an energy flux having a more homogenized energy flux profile.

The apparatus and/or systems disclosed herein may include an optical diffuser. The optical diffuser may diffuse light substantially homogenously. The optical diffuser may remove high intensity energy (e.g., light) distribution and form a more even distribution of light across the footprint of the energy beam and/or flux. The optical diffuser may reduce the intensity of the energy beam and/or flux (e.g., act as a screen). For example, the optical diffuser may alter an energy beam with Gaussian profile, to an energy beam having a top-hat profile. The optical diffuser may comprise a diffuser wheel assembly.

The energy flux may have any of the energy flux profiles in FIG. 6, wherein the “center” designates the center of the tile cross section on the target surface. The energy flux profile may be substantially uniform. The energy flux profile may comprise a substantially uniform section. The energy flux profile may deviate from uniformity. The energy flux profile may be non-uniform. The energy flux profile may have a shape that facilitates substantially uniform heating of the tile (e.g., substantially every point within the tile (e.g., including its rim)). The energy flux profile may have a shape that facilitates substantially uniform heating of the melt pools within the tile (e.g., substantially every melt pool within the tile (e.g., including its rim)). The energy flux profile may have a shape that facilitates substantially uniform temperature of the tile (e.g., substantially every point within the tile (e.g., including its rim)). The energy flux profile may have a shape that facilitates substantially uniform temperature of the melt pools within the tile (e.g., substantially every melt pool within the tile (e.g., including its rim)). The energy flux profile may have a shape that facilitates substantially uniform phase of the tile (e.g., substantially every point within the tile (e.g., including its rim)). The energy flux profile may have a shape that facilitates substantially uniform phase of the melt pools within the tile (e.g., substantially every melt pool within the tile (e.g., including its rim)). Substantially uniform may be substantially similar, even, homogenous, invariable, consistent, or equal).

The energy flux profile of the energy flux may comprise a square shaped beam. In some instances, the energy flux may deviate from a square shaped beam. In some examples, the energy flux (e.g., FIG. 6, having energy profile 600) may exclude a Gaussian shaped beam (e.g., 601). The shape of the beam may be the energy profile of the beam with respect to a distance from the center. The center can be a center of the energy footprint, cross section, and/or tile, which it projects (e.g., through an aperture) onto the target surface. The energy flux profile may comprise one or more planar sections. FIG. 6, 622 is an example of a planar section of energy profile 621. FIG. 6, 630 shows an example of an energy profile 631 where 632 is an example of a planar section of energy profile 631. FIG. 6, 642 is an example of two planar sections of energy profile 641. The energy flux profile may comprise of a gradually increasing and/or decreasing section. FIG. 6, 610 shows an example of an energy profile 611 comprising a gradually increasing section 612, and a gradually decreasing section 613. The energy flux profile may comprise an abruptly increasing and/or decreasing sections. FIG. 6,620 shows an example of an energy profile 621 comprising an abruptly increasing section 623 and an abruptly decreasing section 624. The energy flux profile may comprise a section wherein the energy flux profile deviates from planarity. FIG. 6, 640 shows an example of an energy profile 641 comprising an energy flux profile comprising a section 643 that deviates from planarity (e.g., by a distance “h” of average flux profile 640). The energy flux profile may comprise a section of fluctuating energy flux. The fluctuation may deviate from an average planar surface of the energy flux profile. FIG. 6, 650 shows an example of an energy flux profile 651 comprising a fluctuating section 652. The fluctuating section 652 deviates from the average flat surface. The average flat surface may be measured by the average power of that surface from a baseline (e.g., FIG. 6, “H” of energy flux profile 650), by a +/−distance of “h” of energy flux profile 650. The deviation (e.g., type and/or amount) from planarity of the energy flux profile may relate to the temperature of the material bed and/or the target surface. The deviation (e.g., a percentage of deviation) may be calculated with respect to an average top surface of the energy beam profile. The percentage deviation may be calculated according to the mathematical formula 100*(H−h)/H), where the symbol “*” designates the mathematical operation “multiplied by.” In some examples, when the material bed is at a temperature of below 500° C., the deviation may be at most 1%, 5%, 10%, 15%, or 20%. In some examples, when the material bed is at a temperature of below 500° C., the deviation may be by any value between the aforementioned values (e.g., from about 1% to about 20%, from about 10% to about 20%, or from about 5% to about 15%). When the material bed is from about 500° C. to below about 1000° C., the deviation may be at most 10%, 15%, 20%, 25%, or 30%). When the material bed is from about 500° C. to below about 1000° C., the deviation may be by any value between the aforementioned values (e.g., from about 10% to about 30%, from about 20% to about 30%, or from about 15% to about 25%). When the material bed is above about 1000° C., the deviation may be at most 20%, 25%, 30%, 35%, or 40%). When the material bed is of above about 1000° C., the deviation may be by any value between the aforementioned values (e.g., from about 20% to about 40%, from about 30% to about 40%, or from about 25% to about 35%). Below 500° C. comprises ambient temperature, or room temperature (R.T.). Ambient refers to a condition to which people are generally accustomed. For example, ambient pressure may be 1 atmosphere. Ambient temperature may be a typical temperature to which humans are generally accustomed. For example, from about 15° C. to about 30° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a space ship, a ship, a boat, or any other vehicle. Room temperature may represent the small range of temperatures at which the atmosphere feels neither hot nor cold, approximately 24° C. it may denote 20° C., 25° C., or any value from about 20° C. to about 25° C.

The cross section of the tiling energy flux may comprise a vector shaped scanning beam (VSB). The energy flux may comprise a variable energy flux profile shape. The energy flux may comprise a variable cross sectional shape. The energy flux may comprise a substantially non-variable energy flux profile shape. The energy flux may comprise a substantially non-variable cross sectional shape. The energy flux (e.g., VSB) may translate across the target surface (e.g., directly) to one or more locations specified by vector coordinates. The energy flux (e.g., VSB) may irradiate once over those one or more locations. The energy flux (e.g., VSB) may substantially not irradiate (or irradiated to a considerably lower extent) once between the locations.

In some examples, the first scanning energy beam and/or the second scanning energy beam may have energy flux profile characteristics of the energy flux (e.g., as delineated herein).

The shape of the energy flux cross section may be the shape of the tile. The shape of the energy flux cross section (e.g., its circumference, also known as the edge of its cross section, or beam edge) may substantially exclude a curvature. The shape of an edge of the energy flux may substantially comprise non-curved circumference. The shape of the energy flux edge may comprise non-curved sides on its circumference. The energy flux edge can comprise a flat top beam (e.g., a top-hat beam). The energy flux may have a substantially uniform energy density within its cross section. The beam may have a substantially uniform fluence within its cross section. Substantially uniform may be nearly uniform. The beam may be formed by at least one (e.g., a multiplicity of) diffractive optical element, lens, deflector, aperture, or any combination thereof. The energy flux that reaches the target surface may originate from a Gaussian beam. The target surface may be an exposed surface of the material bed and/or an exposed surface of a 3D object (or a portion thereof). The target surface may be an exposed surface of a layer of hardened material. The energy flux may comprise a beam used in laser drilling (e.g., of holes in printed circuit boards). The energy flux may be similar to (e.g., of) the type of energy beam used in high power laser systems (e.g., which use chains of optical amplifiers to produce an intense beam). The energy flux may comprise a shaped energy beam such as a vector shaped beam (VSB). The energy flux may be similar to (e.g., of) the type used in the process of generating an electronic chip (e.g., for making the mask corresponding to the chip).

The tiling energy source may emit an energy flux that may slowly heat a tile within the exposed surface of a 3D object (e.g., FIG. 1, 106). The tile may correspond to a cross section (e.g., footprint) of the energy flux. The footprint may be on the target surface. The radiative energy source may emit radiative energy that may substantially evenly heat a tile within the target surface (e.g., of a 3D object, FIG. 1, 106). Heating may comprise transforming.

At least a portion of the material bed can be heated by the energy source (e.g., of the energy beam and/or tiling energy flux). The portion of the material bed can be heated to a temperature that is greater than or equal to a temperature wherein at least a portion of the pre-transformed material is transformed. For example, the portion of the material bed can be heated to a temperature that is greater than or equal to a temperature wherein at least a portion of the pre-transformed material is transformed to a liquid state (referred to herein as the liquefying temperature) at a given pressure (e.g., ambient pressure). The liquefying temperature can be equal to a liquidus temperature where the entire material is at a liquid state at a given pressure (e.g., ambient). The liquefying temperature of the pre-transformed material can be the temperature at or above which at least part of the pre-transformed material transitions from a solid to a liquid phase at a given pressure (e.g., ambient).

In some embodiments, the energy beam paths may be heated by a second (e.g., scanning) energy beam (e.g., an electron beam or a laser). The second scanning energy beam may the same scanning energy beam that is used to form the 3D object (e.g., first scanning energy beam). The second scanning energy beam may a different scanning energy beam from the one used to form the 3D object (e.g., first scanning energy beam). The second scanning energy beam may be generated by a second (e.g., scanning) energy source. The second scanning energy source may be the same scanning energy source that is used to generate the first scanning energy beam, or may be a different energy source. The second scanning energy source may be the same scanning energy source that is used to generate the energy flux, or be a different energy source.

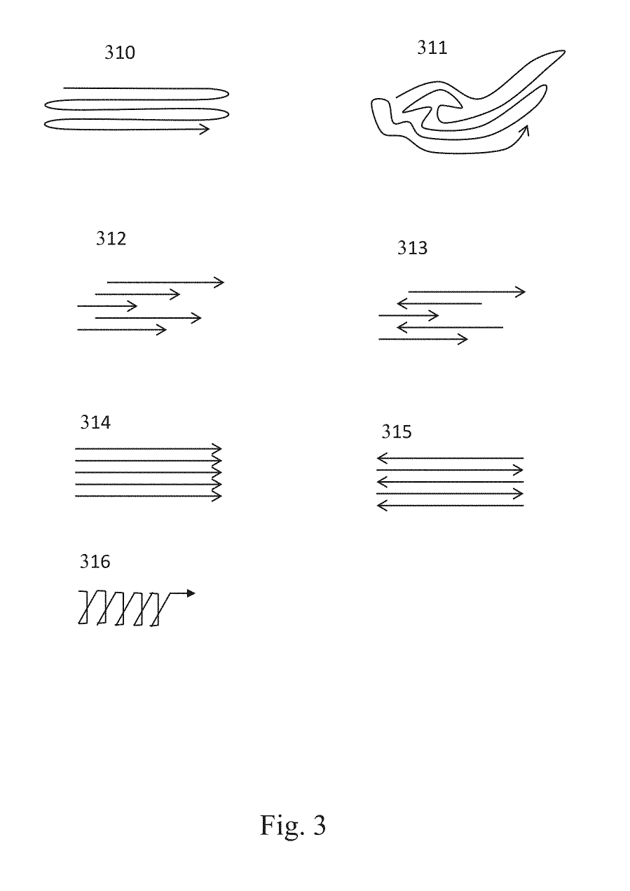

The second scanning energy beam may be a substantially collimated beam. The second scanning energy beam may not be a substantially dispersed beam. The second scanning energy beam may follow a path. The path may form an internal path (e.g., vectorial path) within the portions. The second scanning energy beam may irradiate energy on the exposed target surface after the energy flux irradiated one or more (e.g., all) of the tiles. The second scanning energy beam may heat at least a portion of the heated tile (e.g., along a path). The path of the second scanning energy beam within the tile is designated herein as the “internal path” within the tiles. The internal path within the tiles may be of substantially the same general shape as the shape of the path-of-tiles (e.g., both sine waves). The internal path within the tiles may be of a different general shape than the shape of the path-of-tiles (e.g., vector lines vs. a sine wave). The path may follow a spiraling shape, or a random shape (e.g., FIG. 3, 311). The path may be overlapping (e.g., FIG. 3, 316) or non-overlapping. The path may comprise at least one overlap. The path may be substantially devoid of overlap (e.g., FIG. 3, 310).

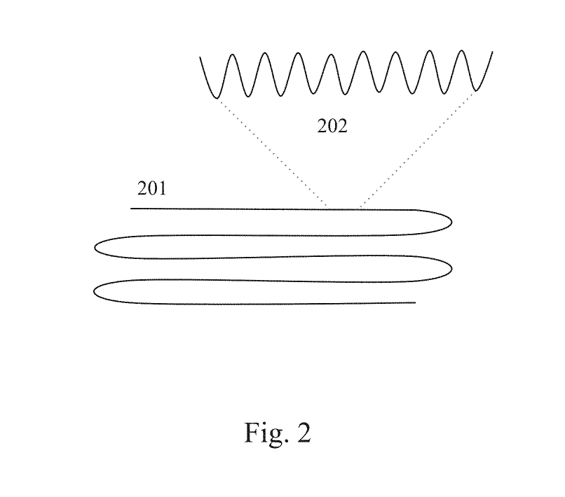

The path of the scanning energy beam may comprise a finer path. The finer path may be an oscillating path. FIG. 2 shows an example of a path of the scanning energy beam 201. The path 201 is composed of an oscillating sub-path 202. The oscillating sub path can be a zigzag or sinusoidal path. The finer path may include or substantially exclude a curvature.

The scanning energy beam may travel in a path that comprises or substantially excludes a curvature. FIG. 3 shows various examples of paths. The scanning energy beam may travel in each of these types of paths. The path may substantially exclude a curvature (e.g., 312-315). The path may include a curvature (e.g., 310-311). The path may comprise hatching (e.g., 312-315). The hatching may be directed in the same direction (e.g., 312 or 314). Every adjacent hatching may be directed in an opposite direction (e.g., 313 or 315). The hatching may have the same length (e.g., 314 or 315). The hatching may have varied length (e.g., 312 or 313). The spacing between two adjacent path sections may be substantially identical (e.g., 310) or non-identical (e.g., 311). The path may comprise a repetitive feature (e.g., 310), or be substantially non-repetitive (e.g., 311). The path may comprise non-overlapping sections (e.g., 310), or overlapping sections (e.g., 316). The tile may comprise a spiraling progression (e.g., 316). The non-tiled sections of the target surface may be irradiated by the second scanning energy beam in any of the path types described herein.

The heating can be done by the one or more energy sources. At least two of the energy sources may heat the target surface (e.g., and form tiles) simultaneously, sequentially, or a combination thereof. At least two tiles can be heated sequentially. At least two tiles can be heated substantially simultaneously. The sequence of heating at least two of the tiles may overlap.

In some instances, the methods, systems and/or apparatuses may comprise measuring the temperature and/or the shape of the transformed (e.g., molten) fraction within the heated area of the target surface (e.g., a tile). The temperature measurement may comprise real time temperature measurement. The depth of the transformed fraction may be estimated (e.g., based on the temperature measurements). The temperature measurements and/or estimation of the transformed fraction depth may be used to control (e.g., regulate and/or direct) the energy irradiated at a particular portion. Controlling the irradiating energy may comprise its power, dwell time, or cross section on the exposed surface. The control may comprise reducing (e.g., halting) the irradiating energy on reaching a target depth. The dwell time (e.g., exposure time) may be at least a few tenths of millisecond (e.g., from about 0.1), or at least a few milliseconds (e.g., from about 1 msec). The exposure time (e.g., dwell time) may be as disclosed herein. The control may comprise reducing (e.g., halting) the irradiating energy while taking into account the rate at which the heated portions cool down. The rate of heating and/or cooling the portions may afford formation of desired microstructures (e.g., at particular areas). The desired microstructures may be formed at a particular area or in the entire layer of hardened material. The temperature at the heated (e.g., heat tiled) area may be measured (e.g., visually) (e.g., with a direct or indirect view of the heated area). The measurement may comprise using a detector (e.g., CCD camera, video camera, fiber array coupled to a single pixel detector, fiber array coupled to a multiplicity of pixel detectors, and/or a spectrometer). The visual measurements may comprise using image processing. The transformation of the heated tile may be monitored (e.g., visually, and/or spectrally). The shape of the transforming fraction of the heated area may be monitored (e.g., visually, and/or in real-time). The FLS of the transformed(ing) fraction may be used to indicate the depth and/or volume of the transformed material (e.g., melt pool). The monitoring (e.g., of the heat and/or FLS of the transformed fraction within the heated area) may be used to control one or more parameters of the energy source, energy flux, second energy source, and/or second scanning energy beam. The parameters may comprise (i) the power generated by the tiling energy source and/or second scanning energy source, (ii) the dwell time of energy flux, or (iii) the speed of the second scanning energy beam.

The control of the energy (e.g., beam and/or flux) may comprise substantially ceasing (e.g., stopping) to irradiate the target area when the temperature at the bottom skin reaches a target temperature. The control of the energy (e.g., beam and/or flux) may comprise substantially reducing the energy supplied to (e.g., injected into) the target area when the temperature at the bottom skin reached a target temperature. The control of the energy (e.g., beam and/or flux) may comprise altering the energy profile of the energy beam and/or flux respectively. The control may be different (e.g., may vary) for layers that are closer to the bottom skin layer as compared to layers that are more distant from the bottom skin layer. The control may comprise turning the energy beam and/or flux on and off. The control may comprise reducing the power per unit area, cross section, focus, power, of energy beam and/or flux. The control may comprise altering a property of the energy beam and/or flux, which property may comprise the power, power per unit area, cross section, energy profile, focus, scanning speed, pulse frequency (when applicable), or dwell time of the energy beam and/or flux respectively. During the “off” times (e.g., intermission), the power and/or power per unit area of the energy beam and/or flux may be substantially reduced as compared to its value at the “on” times (e.g., dwell times). During the intermission, the energy beam and/or flux may relocate away from the area which was tiled, to a different area in the target surface that is substantially distant from area which was tiled. During the dwell times, the energy beam and/or flux may relocate back to the position adjacent to the area which was just tiled (e.g., as part of the path-of-tiles).

The very first formed layer of hardened material in a 3D object is referred to herein as the “bottom skin.” In some embodiments, the bottom skin layer is the very first layer in an unsupported portion of a 3D object. The unsupported portion may not be supported by auxiliary supports. The unsupported portion may be connected to the center (e.g., core) of the 3D object and may not be otherwise supported by, or anchored to, the platform. For example, the unsupported portion may be a hanging structure (e.g., a ledge) or a cavity ceiling.

Cooling the tiles may comprise introducing a cooling member (e.g., heat sink) to the heated area. FIG. 1 shows an example of an optional cooling member (e.g., heat sink 113) that is disposed above the exposed (e.g., top) surface 131 of the target surface (e.g., material bed) 104. The cooling member may be translatable vertically, horizontally, or at an angle (e.g., planar or compound). The translation may be controlled manually and/or by a controller. The cooling member may be operatively coupled to the controller. The energy source for energy flux (e.g., FIG. 1, 114), first scanning energy source, second scanning energy source, and/or cooling member may be translatable vertically, horizontally, or at an angle (e.g., planar or compound). The translation may be controlled manually and/or by a controller. The energy source for energy flux, first scanning energy source, and/or second scanning energy source may be operatively coupled to the controller. The cooling member may control (e.g., prevent) accumulation of heat in certain portions of the exposed 3D object (e.g., exposed layer of hardened material). Heating a tile in a particular area of the target surface may control (e.g., regulate) accumulation of heat in certain portions of the exposed 3D object (e.g., exposed layer of hardened material).

The control may be closed loop control, or an open loop control (e.g., based on energy calculations comprising an algorithm). The closed loop control may comprise feed-back or feed-forward control. The algorithm may take into account one or more temperature measurements (e.g., as disclosed herein), metrological measurements, geometry of at least part of the 3D object, heat depletion/conductance profile of at least part of the 3D object. The controller may modulate the irradiative energy and/or the energy beam. The algorithm may take into account pre-correction of an object (i.e., object pre-correction, OPC) to compensate for any distortion of the final 3D object. The algorithm may comprise instructions to form a correctively deformed object. The algorithm may comprise modification applied to the model of a desired 3D object. Examples of modifications (e.g., corrective deformations) can be found in Patent Application Serial No. PCT/US16/34857 filed on May 27, 2016, titled “THREE-DIMENSIONAL PRINTING AND THREE-DIMENSIONAL OBJECTS FORMED USING THE SAME” or in U.S. Provisional Patent Application Ser. No. 62/239,805, titled “SYSTEMS, APPARATUSES AND METHODS FOR THREE-DIMENSIONAL PRINTING, AS WELL AS THREE-DIMENSIONAL OBJECTS” that was filed on Oct. 9, 2015, both of which are entirely incorporated herein by reference. The control may be any control disclosed in U.S. Provisional Patent Application Ser. No. 62/401,534 filed on Sep. 29, 2016, titled “ACCURATE THREE-DIMENSIONAL PRINTING”, that is incorporated herein by reference in its entirety.

The methods for generating one or more 3D objects described herein may comprise: depositing a layer of pre-transformed material (e.g., powder) in an enclosure; providing energy to a portion of the layer of material (e.g., according to a path); transforming at least a section of the portion of the layer of material to form a transformed material by utilizing the energy; optionally allowing the transformed material to harden into a hardened material; and optionally repeating steps a) to d) to generate the one or more 3D objects. The enclosure may comprise a platform (e.g., a substrate and/or base). The enclosure may comprise a container. The 3D object may be printed adjacent to (e.g., above) the platform. The pre-transformed material may be deposited in the enclosure by a material dispensing system to form a layer of pre-transformed material within the enclosure. The deposited material may be leveled by a leveling mechanism. The deposition of pre-transformed material in the enclosure may form a material bed, or be deposited on a platform. The leveling mechanism may comprise a leveling step where the leveling mechanism does not contact the exposed surface of the material (e.g., powder) bed. The material dispensing system may comprise one or more dispensers. The material dispensing system may comprise at least one material (e.g., bulk) reservoir. The material may be deposited by a layer dispensing mechanism (e.g., recoater). The layer dispensing mechanism may level the dispensed material without contacting the powder bed (e.g., the top surface of the powder bed). The layer dispensing mechanism may include any layer dispensing mechanism, material removal mechanism, and/or powder dispensing mechanism that are disclosed in Patent Application Serial No. PCT/US15/36802 that is incorporated herein by reference in its entirety. The layer dispensing mechanism may comprise a material dispensing mechanism, material leveling mechanism, material removal mechanism, or any combination thereof.

The system, apparatuses and/or method may comprise a layer dispensing mechanism (e.g., recoater) that dispenses a layer of pre-transformed (e.g., powder) material comprising an exposed surface that is substantially planar. The layer dispensing mechanism can be any layer dispensing mechanism disclosed in Patent Application Serial No. PCT/US15/36802, which is incorporated herein by reference in its entirety. FIG. 1 shows an example of a layer dispensing mechanism comprising a material dispensing mechanism 116, a leveling mechanism 117, and a material removal mechanism 118 (The white arrows in 116 and 118 designate the direction in which the pre-transformed material flows into/out of the material bed (e.g., 104).

The 3D object may be subsequently cleaned and/or cooled within the enclosure, and/or exit the enclosure through an exit. The cleaning may comprise using gas pressure, vibrations, and/or surface friction (e.g., brush). The cleaning may comprise a post processing procedure as disclosed in Patent Application Serial No. PCT/US15/36802, which is incorporated herein by reference in its entirety.

The three-dimensional object can be devoid of surface features that are indicative of the use of a post printing process. The post printing process may comprise a trimming process (e.g., to trim auxiliary supports). The trimming process may be an operation conducted after the completion of the 3D printing process. The trimming process may be a separate operation from the 3D printing process. The trimming may comprise cutting (e.g., using a piercing saw). The trimming can comprise polishing or blasting. The blasting can comprise solid blasting, gas blasting, or liquid blasting. The solid blasting can comprise sand blasting. The gas blasting can comprise air blasting. The liquid blasting can comprise water blasting. The blasting can comprise mechanical blasting.

The layered structure can be a substantially repetitive layered structure. Each layer of the layered structure has an average layer thickness greater than or equal to about 5 micrometers (μm). Each layer of the layered structure has an average layer thickness less than or equal to about 1000 micrometers (μm). The layered structure can comprise individual layers of the successive solidified melt pools. A given one of the successive solidified melt pools can comprise a substantially repetitive material variation selected from the group consisting of variation in grain orientation, variation in material density, variation in the degree of compound segregation to grain boundaries, variation in the degree of element segregation to grain boundaries, variation in material phase, variation in metallurgical phase, variation in material porosity, variation in crystal phase, and variation in crystal structure. A given one of the successive solidified melt pools can comprise a crystal. The crystal can comprise a single crystal. The layered structure can comprise one or more features indicative of solidification of melt pools during the three-dimensional printing process. The layered structure can comprise a feature indicative of the use of the 3D printing process. A fundamental length scale of the three-dimensional object can be at least about 120 micrometers.

The layer of hardened material layer (or a portion thereof) can have a thickness (e.g., layer height) of at least about 50 μm, 100 μm, 150 μm, 200 μm, 300 μm, 400 μm, 500 μm, 600 μm, 700 μm, 800 μm, 900 μm, or 1000 μm. A hardened material layer (or a portion thereof) can have a thickness of at most about 1000 μm, 900 μm, 800 μm, 700 μm, 60 μm, 500 μm, 450 μm, 400 μm, 350 μm, 300 μm, 250 μm, 200 μm, 150 μm, 100 μm, 75 μm, or 50 μm. A hardened material layer (or a portion thereof) may have any value in between the aforementioned layer thickness values (e.g., from about 50 μm to about 1000 μm, from about 500 μm to about 800 μm, from about 300 μm to about 600 μm, from about 300 μm to about 900 μm, or from about 50 μm to about 200 μm).

In some instances, one, two, or more 3D objects may be generated in a material bed (e.g., a single material bed; the same material bed). The multiplicity of 3D object may be generated in the material bed simultaneously or sequentially. At least two 3D objects may be generated side by side. At least two 3D objects may be generated one on top of the other. At least two 3D objects generated in the material bed may have a gap between them (e.g., gap filled with pre-transformed material). At least two 3D objects generated in the material bed may contact (e.g., not connect to) each other. In some embodiments, the 3D objects may be independently built one above the other. The generation of a multiplicity of 3D objects in the material bed may allow continuous creation of 3D objects.

The material (e.g., pre-transformed material, transformed material, or hardened material) may comprise elemental metal, metal alloy, ceramics, or an allotrope of elemental carbon. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball or a carbon nanotube. The ceramic material may comprise cement. The ceramic material may comprise alumina. The material may comprise sand, glass, or stone. In some embodiments, the material may comprise an organic material, for example, a polymer or a resin. The organic material may comprise a hydrocarbon. The polymer may comprise styrene. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon based polymer or a resin. The material may comprise an organosilicon-based material. The material may comprise silicon and hydrogen atoms. The material may comprise silicon and carbon atoms. In some embodiments, the material may exclude a silicon-based material. The solid material may comprise powder material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) or wires.

The material may comprise a powder material. The material may comprise a solid material. The material may comprise one or more particles or clusters. The term “powder,” as used herein, generally refers to a solid having fine particles. The powder may also be referred to as “particulate material.” Powders may be granular materials. The powder particles may comprise micro particles. The powder particles may comprise nanoparticles. In some examples, a powder comprising particles having an average fundamental length scale of at least about 5 nanometers (nm), 10 nm, 20 nm, 30 nm, 40 nm, 50 nm, 100 nm, 200 nm, 300 nm, 400 nm, 500 nm, 1 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, or 100 μm. The particles comprising the powder may have an average fundamental length scale of at most about 100 μm, 80 μm, 75 μm, 70 μm, 65 μm, 60 μm, 55 μm, 50 μm, 45 μm, 40 μm, 35 μm, 30 μm, 25 μm, 20 μm, 15 μm, 10 μm, 5 μm, 1 μm, 500 nm, 400 nm, 300 nm, 200 nm, 100 nm, 50 nm, 40 nm, 30 nm, 20 nm, 10 nm, or 5 nm. In some cases, the powder may have an average fundamental length scale between any of the values of the average particle fundamental length scale listed above (e.g., from about 5 nm to about 100 μm, from about 1 μm to about 100 μm, from about 15 μm to about 45 μm, from about 5 μm to about 80 μm, from about 20 μm to about 80 μm, or from about 500 nm to about 50 μm).

The powder can be composed of individual particles. The individual particles can be spherical, oval, prismatic, cubic, or irregularly shaped. The particles can have a fundamental length scale. The powder can be composed of a homogenously shaped particle mixture such that all of the particles have substantially the same shape and fundamental length scale magnitude within at most 1%, 5%, 8%, 10%, 15%, 20%, 25%, 30%, 35%, 40%, 50%, 60%, or 70%, distribution of fundamental length scale. In some cases, the powder can be a heterogeneous mixture such that the particles have variable shape and/or fundamental length scale magnitude.

At least parts of the layer can be transformed to a transformed material that may subsequently form at least a fraction (also used herein “a portion,” or “a part”) of a hardened (e.g., solidified) 3D object. At times a layer of transformed or hardened material may comprise a cross section of a 3D object (e.g., a horizontal cross section). At times a layer of transformed or hardened material may comprise a deviation from a cross section of a 3D object. The deviation may include vertical or horizontal deviation. A pre-transformed material may be a powder material. A pre-transformed material layer (or a portion thereof) can have a thickness (e.g., layer height) of at least about 0.1 micrometer (μm), 0.5 μm, 1.0 μm, 10 μm, 50 μm, 100 μm, 150 μm, 200 μm, 300 μm, 400 μm, 500 μm, 600 μm, 700 μm, 800 μm, 900 μm, or 1000 μm. A pre-transformed material layer (or a portion thereof) can have a thickness of at most about 1000 μm, 900 μm, 800 μm, 700 μm, 60 μm, 500 μm, 450 μm, 400 μm, 350 μm, 300 μm, 250 μm, 200 μm, 150 μm, 100 μm, 75 μm, 50 μm, 40 μm, 30 μm, 20 μm, 5 μm, 1 μm, or 0.5 μm. A pre-transformed material layer (or a portion thereof) may have any value in between the aforementioned layer thickness values (e.g., from about 0.1 μm to about 1000 μm, from about 1 μm to about 800 μm, from about 20 μm to about 600 μm, from about 30 μm to about 300 μm, or from about 10 μm to about 1000 μm).

The material composition of at least one layer within the material bed may differ from the material composition within at least one other layer in the material bed. The difference (e.g., variation) may comprise difference in crystal or grain structure. The variation may comprise variation in grain orientation, variation in material density, variation in the degree of compound segregation to grain boundaries, variation in the degree of element segregation to grain boundaries, variation in material phase, variation in metallurgical phase, variation in material porosity, variation in crystal phase, or variation in crystal structure. The microstructure of the printed object may comprise planar structure, cellular structure, columnar dendritic structure, or equiaxed dendritic structure.

The pre-transformed materials of at least one layer in the material bed may differ in the FLS of its particles (e.g., powder particles) from the FLS of the pre-transformed material within at least one other layer in the material bed. A layer may comprise two or more material types at any combination. For example, two or more elemental metals, two or more metal alloys, two or more ceramics, two or more allotropes of elemental carbon. For example, an elemental metal and a metal alloy, an elemental metal and a ceramic, an elemental metal and an allotrope of elemental carbon, a metal alloy and a ceramic, a metal alloy, and an allotrope of elemental carbon, a ceramic and an allotrope of elemental carbon. All the layers of pre-transformed material deposited during the 3D printing process may be of the same material composition. In some instances, a metal alloy is formed in situ during the process of transforming at least a portion of the material bed. In some instances, a metal alloy is not formed in situ during the process of transforming at least a portion of the material bed. In some instances, a metal alloy is formed prior to the process of transforming at least a portion of the material bed. In a multiplicity (e.g., mixture) of pre-transformed (e.g., powder) materials, one pre-transformed material may be used as support (i.e., supportive powder), as an insulator, as a cooling member (e.g., heat sink), or as any combination thereof.

In some instances, adjacent components in the material bed are separated from one another by one or more intervening layers. In an example, a first layer is adjacent to a second layer when the first layer is in direct contact with the second layer. In another example, a first layer is adjacent to a second layer when the first layer is separated from the second layer by at least one layer (e.g., a third layer). The intervening layer may be of any layer size disclosed herein.

The pre-transformed material (e.g., powder material) can be chosen such that the material is the desired and/or otherwise predetermined material for the 3D object. In some cases, a layer of the 3D object comprises a single type of material. In some examples, a layer of the 3D object may comprise a single elemental metal type, or a single metal alloy type. In some examples, a layer within the 3D object may comprise several types of material (e.g., an elemental metal and an alloy, an alloy and a ceramic, an alloy, and an allotrope of elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member (e.g., an allotrope) of elemental carbon (e.g., graphite). In some cases, a layer of the 3D object comprises more than one type of material. In some cases, a layer of the 3D object comprises more than one member of a material type.

The elemental metal can be an alkali metal, an alkaline earth metal, a transition metal, a rare earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare earth metal can be a lanthanide, or an actinide. The lanthanide metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

The metal alloy can be an iron based alloy, nickel based alloy, cobalt based alloy, chrome based alloy, cobalt chrome based alloy, titanium based alloy, magnesium based alloy, copper based alloy, or any combination thereof. The alloy may comprise an oxidation or corrosion resistant alloy. The alloy may comprise a super alloy (e.g., Inconel). The super alloy may comprise Inconel 600, 617, 625, 690, 718, or X-750. The metal (e.g., alloy or elemental) may comprise an alloy used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The metal (e.g., alloy or elemental) may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, tablet), air conditioning, generators, furniture, musical equipment, art, jewelry, cooking equipment, or sport gear. The metal (e.g., alloy or elemental) may comprise an alloy used for products for human or veterinary applications comprising implants, or prosthetics. The metal alloy may comprise an alloy used for applications in the fields comprising human or veterinary surgery, implants (e.g., dental), or prosthetics.

The alloy may include a superalloy. The alloy may include a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy (e.g., Haynes 282), Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron alloy comprises Elinvar, Fernico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron alloy may include cast iron, or pig iron. The steel may include Bulat steel, Chromoly, Crucible steel, Damascus steel, Hadfield steel, High speed steel, HSLA steel, Maraging steel, Maraging steel (M300), Reynolds 531, Silicon steel, Spring steel, Stainless steel, Tool steel, Weathering steel, or Wootz steel. The high-speed steel may include Mushet steel. The stainless steel may include AL-6XN, Alloy 20, celestrium, marine grade stainless, Martensitic stainless steel, surgical stainless steel, or Zeron 100. The tool steel may include Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade such as 440F, 410, 312, 430, 440A, 440B, 440C, 304, 305, 304L, 304L, 301, 304LN, 301LN, 2304, 316, 316L, 316LN, 317L, 2205, 409, 904L, 321, 254SMO, 316Ti, 321H, 17-4, 15-5, 420 or 304H. The steel may comprise stainless steel of at least one crystalline structure selected from the group consisting of austenitic, superaustenitic, ferritic, martensitic, duplex, and precipitation-hardening martensitic. Duplex stainless steel may be lean duplex, standard duplex, super duplex, or hyper duplex. The stainless steel may comprise surgical grade stainless steel (e.g., austenitic 316, martensitic 420, or martensitic 440). The austenitic 316 stainless steel may include 316L, or 316LVM. The steel may include 17-4 Precipitation Hardening steel (also known as type 630, a chromium-copper precipitation hardening stainless steel, 17-4PH steel).

The titanium-based alloys may include alpha alloys, near alpha alloys, alpha and beta alloys, or beta alloys. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38, or higher. In some instances, the titanium base alloy includes Ti-6Al-4V or Ti-6Al-7Nb.

The Nickel alloy may include Alnico, Alumel, Chromel, Cupronickel, Ferronickel, German silver, Hastelloy, Inconel, Monel metal, Nichrome, Nickel-carbon, Nicrosil, Nisil, Nitinol, Hastelloy-X, Cobalt-Chromium or Magnetically “soft” alloys. The magnetically “soft” alloys may comprise Mu-metal, Permalloy, Supermalloy, or Brass. The brass may include Nickel hydride, Stainless or Coin silver. The cobalt alloy may include Megallium, Stellite (e. g. Talonite), Ultimet, or Vitallium. The chromium alloy may include chromium hydroxide, or Nichrome.

The aluminum alloy may include AA-8000, Al—Li (aluminum-lithium), Alnico, Duralumin, Hiduminium, Kryron Magnalium, Nambe, Scandium-aluminum, or Y alloy. The magnesium alloy may be Elektron, Magnox, or T-Mg—Al—Zn (Bergman phase) alloy.

The copper alloy may comprise Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may include Calamine brass, Chinese silver, Dutch metal, Gilding metal, Muntz metal, Pinchbeck, Prince's metal, or Tombac. The Bronze may include Aluminum bronze, Arsenical bronze, Bell metal, Florentine bronze, Guanin, Gunmetal, Glucydur, Phosphor bronze, Ormolu, or Speculum metal. The copper alloy may be a high-temperature copper alloy (e.g., GRCop-84).

The metal alloys can be Refractory Alloys. The refractory metals and alloys may be used for heat coils, heat exchangers, furnace components, or welding electrodes. The Refractory Alloys may comprise a high melting points, low coefficient of expansion, mechanically strong, low vapor pressure at elevated temperatures, high thermal conductivity, or high electrical conductivity.

In some examples the material (e.g., powder material) comprises a material wherein its constituents (e.g., atoms or molecules) readily lose their outer shell electrons, resulting in a free-flowing cloud of electrons within their otherwise solid arrangement. In some examples the material is characterized in having high electrical conductivity, low electrical resistivity, high thermal conductivity, or high density (e.g., as measured at ambient temperature (e.g., R.T., or 20° C.)). The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the aforementioned electrical conductivity values (e.g., from about 1*10⁵ S/m to about 1*10⁸ S/m). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the aforementioned electrical resistivity values (e.g., from about 1×10⁻⁵ Ω*m to about 1×10⁻⁸ Ω*m). The high thermal conductivity may be at least about 20 Watts per meters times degrees Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be any value between the aforementioned thermal conductivity values (e.g., from about 20 W/mK to about 1000 W/mK). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the aforementioned density values (e.g., from about 1 g/cm³ to about 25 g/cm³).

A metallic material (e.g., elemental metal or metal alloy) can comprise small amounts of non-metallic materials, such as, for example, oxygen, sulfur, or nitrogen. In some cases, the metallic material can comprise the non-metallic material in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (on the basis of weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, 10 ppm, 100 ppm, 500 ppm, 1000 ppm, or 10000 ppm (on the basis of weight, w/w) of non-metallic material. A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

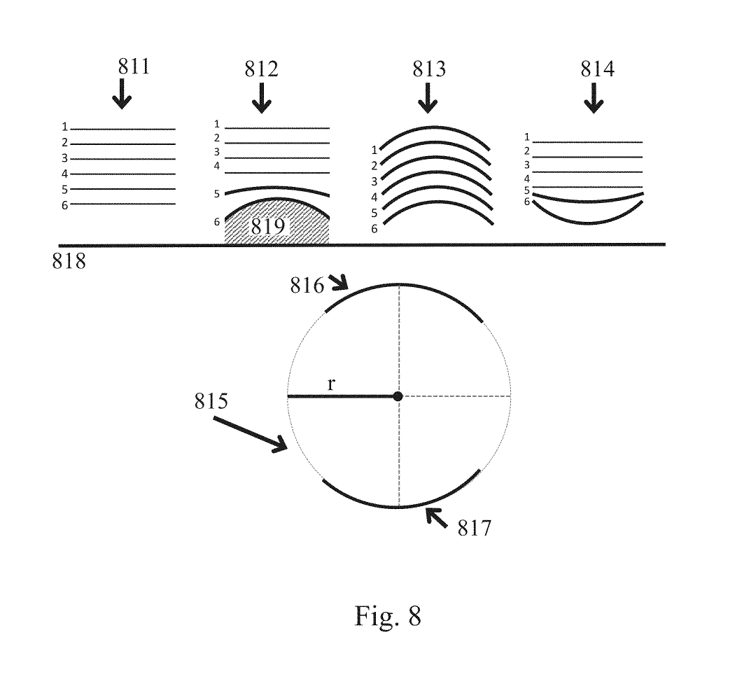

The one or more layers within the 3D object may be substantially planar (e.g., flat). The planarity of the layer may be substantially uniform. The height of the layer at a particular position may be compared to an average plane. The average plane may be defined by a least squares planar fit of the top-most part of the surface of the layer of hardened material. The average plane may be a plane calculated by averaging the material height at each point on the top surface of the layer of hardened material. The deviation from any point at the surface of the planar layer of hardened material may be at most 20% 15%, 10%, 5%, 3%, 1%, or 0.5% of the height (e.g., thickness) of the layer of hardened material. The substantially planar one or more layers may have a large radius of curvature. FIG. 8 shows an example of a vertical cross section of a 3D object 812 comprising planar layers (layers numbers 1-4) and non-planar layers (e.g., layers numbers 5-6) that have a radius of curvature. The curvature can be positive or negative with respect to the platform and/or the exposed surface of the material bed. For example, layered structure 812 comprises layer number 6 that has a curvature that is negative, as the volume (e.g., area in a vertical cross section of the volume) bound from the bottom of it to the platform 818 is a convex object 819. Layer number 5 of 812 has a curvature that is negative. Layer number 6 of 812 has a curvature that is more negative (e.g., has a curvature of greater negative value) than layer number 5 of 812. Layer number 4 of 812 has a curvature that is (e.g., substantially) zero. Layer number 6 of 814 has a curvature that is positive. Layer number 6 of 812 has a curvature that is more negative than layer number 5 of 812, layer number 4 of 812, and layer number 6 of 814. Layer numbers 1-6 of 813 are of substantially uniform (e.g., negative curvature). FIGS. 8, 816 and 817 are super-positions of curved layer on a circle 815 having a radius of curvature “r.” The one or more layers may have a radius of curvature equal to the radius of curvature of the layer surface. The radius of curvature may equal infinity (e.g., when the layer is flat). The radius of curvature of the layer surface (e.g., all the layers of the 3D object) may have a value of at least about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The radius of curvature of the layer surface (e.g., all the layers of the 3D object) may have a value of at most about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, 100 m, or infinity (i.e., flat layer). The radius of curvature of the layer surface (e.g., all the layers of the 3D object) may have any value between any of the afore-mentioned values of the radius of curvature (e.g., from about 10 cm to about 90 m, from about 50 cm to about 10 m, from about 5 cm to about 1 m, from about 50 cm to about 5 m, from about 5 cm to infinity, or from about 40 cm to about 50 m). In some embodiments, a layer with an infinite radius of curvature is a layer that is planar. In some examples, the one or more layers may be included in a planar section of the 3D object, or may be a planar 3D object (e.g., a flat plane). In some instances, part of at least one layer within the 3D object has the radius of curvature mentioned herein.

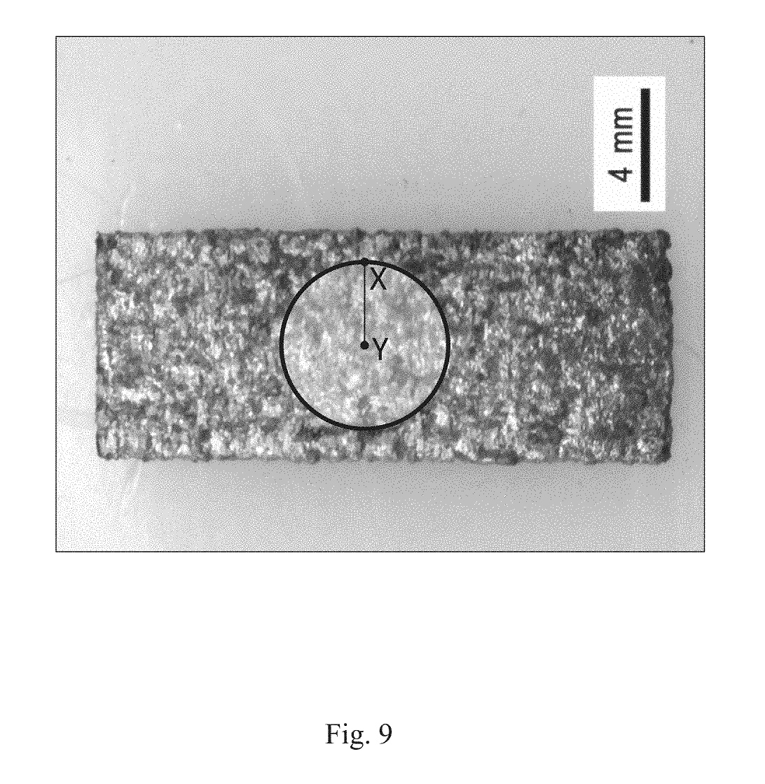

The 3D object may comprise a layering plane N of the layered structure. The 3D object may comprise points X and Y, which reside on the surface of the 3D object, wherein X is spaced apart from Y by at least about 10.5 millimeters or more. FIG. 9 shows an example of points X and Y on the surface of a 3D object. In some embodiments, X is spaced apart from Y by the auxiliary feature spacing distance. A sphere of radius XY that is centered at X lacks one or more auxiliary supports or one or more auxiliary support marks that are indicative of a presence or removal of the one or more auxiliary support features. In some embodiments, Y is spaced apart from X by at least about 10.5 millimeters or more. An acute angle between the straight line XY and the direction normal to N may be from about 45 degrees to about 90 degrees. The acute angle between the straight line XY and the direction normal to the layering plane may be of the value of the acute angle alpha. When the angle between the straight line XY and the direction of normal to N is greater than 90 degrees, one can consider the complementary acute angle. The layer structure may comprise any material(s) used for 3D printing described herein. Each layer of the 3D structure can be made of a single material or of multiple materials. Sometimes one part of the layer may comprise one material, and another part may comprise a second material different than the first material. A layer of the 3D object may be composed of a composite material. The 3D object may be composed of a composite material. The 3D object may comprise a functionally graded material.

In some embodiments, the generated 3D object may be generated with the accuracy of at least about 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm as compared to a model of the 3D object (e.g., the desired 3D object). The generated 3D object may be generated with the accuracy of at most about 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm as compared to a model of the 3D object. As compared to a model of the 3D object, the generated 3D object may be generated with the accuracy of any accuracy value between the aforementioned values (e.g., from about 5 μm to about 100 μm, from about 15 μm to about 35 μm, from about 100 μm to about 1500 μm, from about 5 μm to about 1500 μm, or from about 400 μm to about 600 μm).

The hardened layer of transformed material may deform. The deformation may cause a height deviation from a uniformly planar layer of hardened material. The height uniformity (e.g., deviation from average surface height) of the planar surface of the layer of hardened material may be at least about 100 μm, 90 μm, 80 μm, 70 μm, 60 μm, 50 μm, 40 μm, 30 μm, 20 μm, 10 μm, or 5 μm. The height uniformity of the planar surface of the layer of hardened material may be at most about 100 μm, 90 μm, 80, 70 μm, 60 μm, 50 μm, 40 μm, 30 μm, 20 μm, 10 μm, or 5 μm. The height uniformity of the planar surface of the layer of hardened material may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity. The resolution of the 3D object may have any value of the height uniformity value mentioned herein. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dip. The resolution of the 3D object may be any value between the aforementioned values (e.g., from 100 dpi to 4800 dpi, from 300 dpi to 2400 dpi, or from 600 dpi to 4800 dpi).

The height uniformity of a layer of hardened material may persist across a portion of the layer surface that has a width or a length of at least about 1 mm, 2 mm, 3 mm, 4 mm, 5 mm, or 10 mm, have a height deviation of at least about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80 μm, 70 μm, 60 μm, 50 μm, 40 μm, 30 μm, 20 μm, or 10 μm. The height uniformity of a layer of hardened material may persist across a portion of the target surface that has a width or a length of most about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80, 70 μm, 60 μm, 50 μm, 40 μm, 30 μm, 20 μm, or 10 μm. The height uniformity of a layer of hardened material may persist across a portion of the target surface that has a width or a length of or of any value between the afore-mentioned width or length values (e.g., from about 10 mm to about 10 μm, from about 10 mm to about 100 μm, or from about 5 mm to about 500 μm).

Characteristics of the hardened material and/or any of its parts (e.g., layer of hardened material) can be measured by any of the following measurement methodologies. For example, the FLS values (e.g., width), height uniformity, auxiliary support space, and/or radius of curvature of the layer of the 3D object and any of its components (e.g., layer of hardened material) may be measured by any of the following measuring methodologies. The FLS of opening ports may be measured by one or more of following measurement methodologies. The measurement methodologies may comprise a microscopy method (e.g., any microscopy method described herein). The measurement methodologies may comprise a coordinate measuring machine (CMM), measuring projector, vision measuring system, and/or a gauge. The gauge can be a gauge distometer (e.g., caliber). The gauge can be a go-no-go gauge. The measurement methodologies may comprise a caliper (e.g., vernier caliper), positive lens, interferometer, or laser (e.g., tracker). The measurement methodologies may comprise a contact or by a non-contact method. The measurement methodologies may comprise one or more sensors (e.g., optical sensors and/or metrological sensors). The measurement methodologies may comprise a metrological measurement device (e.g., using metrological sensor(s)). The measurements may comprise a motor encoder (e.g., rotary, and/or linear). The measurement methodologies may comprise using an electromagnetic beam (e.g., visible or IR). The microscopy method may comprise ultrasound or nuclear magnetic resonance. The microscopy method may comprise optical microscopy. The microscopy method may comprise electromagnetic, electron, or proximal probe microscopy. The electron microscopy may comprise scanning, tunneling, X-ray photo-, or Auger electron microscopy. The electromagnetic microscopy may comprise confocal, stereoscope, or compound microscopy. The microscopy method may comprise an inverted and/or non-inverted microscope. The proximal probe microscopy may comprise atomic force, or scanning tunneling microscopy, or any other microscopy described herein. The microscopy measurements may comprise using an image analysis system. The measurements may be conducted at ambient temperatures (e.g., R.T.)

The microstructures (e.g., of melt pools) of the 3D object may be measured by a microscopy method (e.g., any microscopy method described herein). The microstructures may be measured by a contact or by a non-contact method. The microstructures may be measured by using an electromagnetic beam (e.g., visible or IR). The microstructure measurements may comprise evaluating the dendritic arm spacing and/or the secondary dendritic arm spacing (e.g., using microscopy). The microscopy measurements may comprise using an image analysis system. The measurements may be conducted at ambient temperatures (e.g., R.T.).

Various distances relating to the chamber can be measured using any of the following measurement techniques. Various distances within the chamber can be measured using any of the following measurement techniques. For example, the gap distance (e.g., from the cooling member to the exposed surface of the material bed) may be measured using any of the following measurement techniques. The measurements techniques may comprise interferometry and/or confocal chromatic measurements. The measurements techniques may comprise at least one motor encoder (rotary, linear). The measurement techniques may comprise one or more sensors (e.g., optical sensors and/or metrological sensors). The measurement techniques may comprise at least one inductive sensor. The measurement techniques may include an electromagnetic beam (e.g., visible or IR). The measurements may be conducted at ambient temperature (e.g., R.T.).

The methods described herein can provide surface uniformity across the exposed surface of the material bed (e.g., top of a powder bed) such that portions of the exposed surface that comprises the dispensed material, which are separated from one another by a distance of from about 1 mm to about 10 mm, have a height deviation from about 100 μm to about 5 μm. The methods described herein may achieve a deviation from a planar uniformity of the layer of pre-transformed material (e.g., powder) in at least one plane (e.g., horizontal plane) of at most about 20%, 10%, 5%, 2%, 1% or 0.5%, as compared to the average plane (e.g., horizontal plane) created at the exposed surface of the material bed (e.g., top of a powder bed). The height deviation can be measured by using one or more sensors (e.g., optical sensors).

The 3D object can have various surface roughness profiles, which may be suitable for various applications. The surface roughness may be the deviations in the direction of the normal vector of a real surface, from its ideal form. The surface roughness may be measured as the arithmetic average of the roughness profile (hereinafter “Ra”). The 3D object can have a Ra value of at least about 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The formed object can have a Ra value of at most about 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The 3D object can have a Ra value between any of the aforementioned Ra values (e.g., from about 30 nm to about 50 μm, from about 5 μm to about 40 μm, from about 3 μm to about 30 μm, from about 10 nm to about 50 μm, or from about 15 nm to about 80 μm). The Ra values may be measured by a contact or by a non-contact method. The Ra values may be measured by a roughness tester and/or by a microscopy method (e.g., any microscopy method described herein). The measurements may be conducted at ambient temperatures (e.g., R.T.). The roughness may be measured by a contact or by a non-contact method. The roughness measurement may comprise one or more sensors (e.g., optical sensors). The roughness measurement may comprise a metrological measurement device (e.g., using metrological sensor(s)). The roughness may be measured using an electromagnetic beam (e.g., visible or IR).

The 3D object may be composed of successive layers (e.g., successive cross sections) of solid material that originated from a transformed material (e.g., fused, sintered, melted, bound, or otherwise connected powder material), and subsequently hardened. The transformed powder material may be connected to a hardened (e.g., solidified) material. The hardened material may reside within the same layer, or in another layer (e.g., a previous layer). In some examples, the hardened material comprises disconnected parts of the three-dimensional object, that are subsequently connected by the newly transformed material (e.g., by fusing, sintering, melting, binding or otherwise connecting a powder material).

A cross section (e.g., vertical cross section) of the generated (i.e., formed) 3D object may reveal a microstructure or a grain structure indicative of a layered deposition. Without wishing to be bound to theory, the microstructure or grain structure may arise due to the solidification of transformed powder material that is typical to and/or indicative of the 3D printing method. For example, a cross section may reveal a microstructure resembling ripples or waves that are indicative of solidified melt pools that may be formed during the 3D printing process. The repetitive layered structure of the solidified melt pools may reveal the orientation at which the part was printed. The cross section may reveal a substantially repetitive microstructure or grain structure. The microstructure or grain structure may comprise substantially repetitive variations in material composition, grain orientation, material density, degree of compound segregation or of element segregation to grain boundaries, material phase, metallurgical phase, crystal phase, crystal structure, material porosity, or any combination thereof. The microstructure or grain structure may comprise substantially repetitive solidification of layered melt pools. The substantially repetitive microstructure may have an average layer height of at least about 0.5 μm, 1 μm, 5 μm, 10 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm, 450 μm, or 500 μm. The substantially repetitive microstructure may have an average layer height of at most about 500 μm, 450 μm, 400 μm, 350 μm, 300 μm, 250 μm, 200 μm, 150 μm, 100 μm, 90 μm, 80 μm, 70 μm, 60 μm, 50 μm, 40 μm, 30 μm, 20 μm, or 10 μm. The substantially repetitive microstructure may have an average layer height of any value between the aforementioned values of layer heights (e.g., from about 0.5 μm to about 500 μm, from about 15 μm to about 50 μm, from about 5 μm to about 150 μm, from about 20 μm to about 100 μm, or from about 10 μm to about 80 μm). In some cases, the layer height can refer to a distance between layers (e.g., FIG. 8, distance between layers e.g., 1 and 2)

The pre-transformed material within the material bed (e.g., powder) can be configured to provide support to the 3D object. For example, the supportive powder may be of the same type of powder from which the 3D object is generated, of a different type, or any combination thereof. In some instances, a low flowability powder can be capable of supporting a 3D object better than a high flowability powder. A low flowability powder can be achieved inter alia with a powder composed of relatively small particles, with particles of non-uniform size or with particles that attract each other. The powder may be of low, medium, or high flowability. The powder material may have compressibility of at least about 1%, 2%, 3%, 4%, 5%, 6%, 7%, 8%, 9%, or 10% in response to an applied force of 15 kilo Pascals (kPa). The powder may have a compressibility of at most about 9%, 8%, 7%, 6%, 5%, 4.5%, 4.0%, 3.5%, 3.0%, 2.5%, 2.0%, 1.5%, 1.0%, or 0.5% in response to an applied force of 15 kilo Pascals (kPa). The powder may have basic flow energy of at least about 100 milli-Joule (mJ), 200 mJ, 300 mJ, 400 mJ, 450 mJ, 500 mJ, 550 mJ, 600 mJ, 650 mJ, 700 mJ, 750 mJ, 800 mJ, or 900 mJ. The powder may have basic flow energy of at most about 200 mJ, 300 mJ, 400 mJ, 450 mJ, 500 mJ, 550 mJ, 600 mJ, 650 mJ, 700 mJ, 750 mJ, 800 mJ, 900 mJ, or 1000 mJ. The powder may have basic flow energy in between the above listed values of basic flow energy (e.g., from about 100 mj to about 1000 mJ, from about 100 mj to about 600 mJ, or from about 500 mj to about 1000 mJ). The powder may have a specific energy of at least about 1.0 milli-Joule per gram (mJ/g), 1.5 mJ/g, 2.0 mJ/g, 2.5 mJ/g, 3.0 mJ/g, 3.5 mJ/g, 4.0 mJ/g, 4.5 mJ/g, or 5.0 mJ/g. The powder may have a specific energy of at most 5.0 mJ/g, 4.5 mJ/g, 4.0 mJ/g, 3.5 mJ/g, 3.0 mJ/g, 2.5 mJ/g, 2.0 mJ/g, 1.5 mJ/g, or 1.0 mJ/g. The powder may have a specific energy in between any of the above values of specific energy (e.g., from about 1.0 mJ/g to about 5.0 mJ/g, from about 3.0 mJ/g to about 5 mJ/g, or from about 1.0 mJ/g to about 3.5 mJ/g).

The 3D object can have one or more auxiliary features. The auxiliary feature(s) can be supported by the material (e.g., powder) bed. The term “auxiliary features,” as used herein, generally refers to features that are part of a printed 3D object, but are not part of the desired, intended, designed, ordered, modeled, or final 3D object. Auxiliary features (e.g., auxiliary supports) may provide structural support during and/or subsequent to the formation of the 3D object. Auxiliary features may enable the removal or energy from the 3D object that is being formed. Examples of auxiliary features comprise heat fins, wires, anchors, handles, supports, pillars, columns, frame, footing, scaffold, flange, projection, protrusion, mold (a.k.a. mould), or other stabilization features. In some instances, the auxiliary support is a scaffold that encloses the 3D object or part thereof. The scaffold may comprise lightly sintered or lightly fused powder material. The 3D object can have auxiliary features that can be supported by the material bed (e.g., powder bed) and not touch the base, substrate, container accommodating the material bed, or the bottom of the enclosure. The 3D part (3D object) in a complete or partially formed state can be completely supported by the material bed (e.g., without touching the substrate, base, container accommodating the powder bed, or enclosure). The 3D object in a complete or partially formed state can be completely supported by the powder bed (e.g., without touching anything except the powder bed). The 3D object in a complete or partially formed state can be suspended in the powder bed without resting on any additional support structures. In some cases, the 3D object in a complete or partially formed (i.e., nascent) state can freely float (e.g., anchorless) in the material bed.

In some examples, the 3D object may not be anchored (e.g., connected) to the platform and/or walls that define the material bed (e.g., during formation). The 3D object may not touch (e.g., contact) to the platform and/or walls that define the material bed (e.g., during formation). The 3D object be suspended (e.g., float) in the material bed. The scaffold may comprise a continuously sintered (e.g., lightly sintered) structure that is at most 1 millimeter (mm), 2 mm, 5 mm or 10 mm. The scaffold may comprise a continuously sintered structure that is at least 1 millimeter (mm), 2 mm, 5 mm or 10 mm. The scaffold may comprise a continuously sintered structure having dimensions between any of the aforementioned dimensions (e.g., from about 1 mm to about 10 mm, or from about 1 mm to about 5 mm). In some examples, the 3D object may be printed without a supporting scaffold. The supporting scaffold may engulf the 3D object. The supporting scaffold may float in the material bed.

The printed 3D object may be printed without the use of auxiliary features, may be printed using a reduced amount of auxiliary features, or printed using spaced apart auxiliary features. In some embodiments, the printed 3D object may be devoid of one or more auxiliary support features or auxiliary support feature marks that are indicative of a presence or removal of the auxiliary support features. The 3D object may be devoid of one or more auxiliary support features and of one or more marks of an auxiliary feature (including a base structure) that was removed (e.g., subsequent to, or contemporaneous with, the generation of the 3D object). The printed 3D object may comprise a single auxiliary support mark. The single auxiliary feature (e.g., auxiliary support or auxiliary structure) may be a platform (e.g., a building platform such as a base or substrate), or a mold. The auxiliary support may be adhered to the platform or mold. The 3D object may comprise marks belonging to one or more auxiliary structures. The 3D object may comprise two or more marks belonging to auxiliary features. The 3D object may be devoid of marks pertaining to an auxiliary support. The 3D object may be devoid of an auxiliary support. The mark may comprise variation in grain orientation, variation in layering orientation, layering thickness, material density, the degree of compound segregation to grain boundaries, material porosity, the degree of element segregation to grain boundaries, material phase, metallurgical phase, crystal phase, or crystal structure; wherein the variation may not have been created by the geometry of the 3D object alone, and may thus be indicative of a prior existing auxiliary support that was removed. The variation may be forced upon the generated 3D object by the geometry of the support. In some instances, the 3D structure of the printed object may be forced by the auxiliary support (e.g., by a mold). For example, a mark may be a point of discontinuity that is not explained by the geometry of the 3D object, which does not include any auxiliary supports. A mark may be a surface feature that cannot be explained by the geometry of a 3D object, which does not include any auxiliary supports (e.g., a mold). The two or more auxiliary features or auxiliary support feature marks may be spaced apart by a spacing distance of at least 1.5 millimeters (mm), 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The two or more auxiliary support features or auxiliary support feature marks may be spaced apart by a spacing distance of at most 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The two or more auxiliary support features or auxiliary support feature marks may be spaced apart by a spacing distance of any value between the aforementioned auxiliary support space values (e.g., from 1.5 mm to 500 mm, from 2 mm to 100 mm, from 15 mm to 50 mm, or from 45 mm to 200 mm). Collectively referred to herein as the “auxiliary feature spacing distance.”

The 3D object may comprise a layered structure indicative of 3D printing process that is devoid of one or more auxiliary support features or one or more auxiliary support feature marks that are indicative of a presence or removal of the one or more auxiliary support features. The 3D object may comprise a layered structure indicative of 3D printing process, which includes one, two, or more auxiliary support marks. The supports or support marks can be on the surface of the 3D object. The auxiliary supports or support marks can be on an external, on an internal surface (e.g., a cavity within the 3D object), or both. The layered structure can have a layering plane. In one example, two auxiliary support features or auxiliary support feature marks present in the 3D object may be spaced apart by the auxiliary feature spacing distance. The acute (i.e., sharp) angle alpha between the straight line connecting the two auxiliary supports or auxiliary support marks and the direction of normal to the layering plane may be at least about 45 degrees (°), 50°, 55°, 60°, 65°, 70°, 75°, 80°, or 85°. The acute angle alpha between the straight line connecting the two auxiliary supports or auxiliary support marks and the direction of normal to the layering plane may be at most about 90°, 85°, 80°, 75°, 70°, 65°, 60°, 55°, 50°, or 45°. The acute angle alpha between the straight line connecting the two auxiliary supports or auxiliary support marks and the direction of normal to the layering plane may be any angle range between the aforementioned angles (e.g., from about 45 degrees (°), to about 90°, from about 60° to about 90°, from about 75° to about 90°, from about 80° to about 90°, from about 85° to about 90°). The acute angle alpha between the straight line connecting the two auxiliary supports or auxiliary support marks and the direction normal to the layering plane may from about 87° to about 90°. An example of a layering plane can be seen in FIG. 8 showing a vertical cross section of a 3D object 811 that comprises layers 1 to 6, each of which are substantially planar. In the schematic example in FIG. 8, the layering plane of the layers can be the layer. For example, layer 1 could correspond to both the layer and the layering plane of layer 1. When the layer is not planar (e.g., FIG. 8, layer 5 of 3D object 812), the layering plane would be the average plane of the layer. The two auxiliary supports or auxiliary support feature marks can be on the same surface. The same surface can be an external surface or an internal surface (e.g., a surface of a cavity within the 3D object). When the angle between the shortest straight line connecting the two auxiliary supports or auxiliary support marks and the direction of normal to the layering plane is greater than 90 degrees, one can consider the complementary acute angle. In some embodiments, any two auxiliary supports or auxiliary support marks are spaced apart by at least about 10.5 millimeters or more. In some embodiments, any two auxiliary supports or auxiliary support marks are spaced apart by at least about 40.5 millimeters or more. In some embodiments, any two auxiliary supports or auxiliary support marks are spaced apart by the auxiliary feature spacing distance.

In some embodiments, the 3D object can be formed without one or more auxiliary features and/or without contacting a platform (e.g., a base, a substrate, or a bottom of an enclosure). The one or more auxiliary features (which may include a base support) can be used to hold or restrain the 3D object during formation. In some cases, auxiliary features can be used to anchor or hold a 3D object or a portion of a 3D object in a material bed. The one or more auxiliary features can be specific to a part and can increase the time needed to form the 3D object. The one or more auxiliary features can be removed prior to use or distribution of the 3D object. The longest dimension of a cross-section of an auxiliary feature can be at most about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension of a cross-section of an auxiliary feature can be at least about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension of a cross-section of an auxiliary feature can be any value between the above-mentioned values (e.g., from about 50 nm to about 300 mm, from about 5 μm to about 10 mm, from about 50 nm to about 10 mm, or from about 5 mm to about 300 mm). Eliminating the need for auxiliary features can decrease the time and cost associated with generating the three-dimensional part. In some examples, the 3D object may be formed with auxiliary features. In some examples, the 3D object may be formed with contact to the container accommodating the material bed (e.g., side(s) and/or bottom of the container).

In some examples, the diminished number of auxiliary supports or lack of one or more auxiliary support, will provide a 3D printing process that requires a smaller amount of material, produces a smaller amount of material waste, and/or requires smaller energy as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the aforesaid values (e.g., from about 1.1 to about 10, or from about 1.5 to about 5).

FIG. 1 depicts an example of a system that can be used to generate a 3D object using a 3D printing process disclosed herein. The system can include an enclosure (e.g., a chamber 107). At least a fraction of the components in the system can be enclosed in the chamber. At least a fraction of the chamber can be filled with a gas to create a gaseous environment (i.e., an atmosphere). The gas can be an inert gas (e.g., Argon, Neon, Helium, Nitrogen). The chamber can be filled with another gas or mixture of gases. The gas can be a non-reactive gas (e.g., an inert gas). The gaseous environment can comprise argon, nitrogen, helium, neon, krypton, xenon, hydrogen, carbon monoxide, or carbon dioxide. The pressure in the chamber can be at least 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, 1000 bar, or more. The pressure in the chamber can be at least 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at most 10⁻⁷ Torr, 10⁻⁶ Torr, 10⁻⁵ Torr, or 10⁻⁴ Torr, 10⁻³ Torr, 10⁻² Torr, 10⁻¹ Torr, 1 Torr, 10 Torr, 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at a range between any of the aforementioned pressure values (e.g., from about 10⁻⁷ Torr to about 1200 Torr, from about 10⁻⁷ Torr to about 1 Torr, from about 1 Torr to about 1200 Torr, or from about 10⁻² Torr to about 10 Torr). The pressure can be measured by a pressure gauge. The pressure can be measured at ambient temperature (e.g., R.T.). In some cases, the pressure in the chamber can be standard atmospheric pressure. In some cases, the pressure in the chamber can be ambient pressure (i.e., neutral pressure). In some examples, the chamber can be under vacuum pressure. In some examples, the chamber can be under a positive pressure (i.e., above ambient pressure).

The concentration of oxygen and/or humidity in the enclosure (e.g., chamber) can be minimized (e.g., below a predetermined threshold value). For example, the gas composition of the chamber can contain a level of oxygen and/or humidity that is at most about 100 parts per billion (ppb), 10 ppb, 1 ppb, 0.1 ppb, 0.01 ppb, 0.001 ppb, 100 parts per million (ppm), 10 ppm, 1 ppm, 0.1 ppm, 0.01 ppm, or 0.001 ppm. The gas composition of the chamber can contain an oxygen and/or humidity level between any of the aforementioned values (e.g., from about 100 ppb to about 0.001 ppm, from about 1 ppb to about 0.01 ppm, or from about 1 ppm to about 0.1 ppm). The gas composition may be measures by one or more sensors (e.g., an oxygen and/or humidity sensor.). In some cases, the chamber can be opened at the completion of a formation of a 3D object. When the chamber is opened, ambient air containing oxygen and/or humidity can enter the chamber. Exposure of one or more components inside of the chamber to air can be reduced by, for example, flowing an inert gas while the chamber is open (e.g., to prevent entry of ambient air), or by flowing a heavy gas (e.g., argon) that rests on the surface of the powder bed. In some cases, components that absorb oxygen and/or humidity on to their surface(s) can be sealed while the chamber is open.

The chamber can be configured such that gas inside of the chamber has a relatively low leak rate from the chamber to an environment outside of the chamber. In some cases, the leak rate can be at most about 100 milliTorr/minute (mTorr/min), 50 mTorr/min, 25 mTorr/min, 15 mTorr/min, 10 mTorr/min, 5 mTorr/min, 1 mTorr/min, 0.5 mTorr/min, 0.1 mTorr/min, 0.05 mTorr/min, 0.01 mTorr/min, 0.005 mTorr/min, 0.001 mTorr/min, 0.0005 mTorr/min, or 0.0001 mTorr/min. The leak rate may be between any of the aforementioned leak rates (e.g., from about 0.0001 mTorr/min to about, 100 mTorr/min, from about 1 mTorr/min to about, 100 mTorr/min, or from about 1 mTorr/min to about, 100 mTorr/min). The leak rate may be measured by one or more pressure gauges and/or sensors (e.g., at ambient temperature). The enclosure can be sealed such that the leak rate of gas from inside the chamber to an environment outside of the chamber is low (e.g., below a certain level). The seals can comprise O-rings, rubber seals, metal seals, load-locks, or bellows on a piston. In some cases, the chamber can have a controller configured to detect leaks above a specified leak rate (e.g., by using at least one sensor). The sensor may be coupled to a controller. In some instances, the controller is able to identify and/or control (e.g., direct and/or regulate). For example, the controller may be able to identify a leak by detecting a decrease in pressure in side of the chamber over a given time interval.

One or more of the system components can be contained in the enclosure (e.g., chamber). The enclosure can include a reaction space that is suitable for introducing precursor to form a 3D object, such as powder material. The enclosure can contain the platform. In some cases, the enclosure can be a vacuum chamber, a positive pressure chamber, or an ambient pressure chamber. The enclosure can comprise a gaseous environment with a controlled pressure, temperature, and/or gas composition. The gas composition in the environment contained by the enclosure can comprise a substantially oxygen free environment. For example, the gas composition can contain at most at most about 100,000 parts per million (ppm), 10,000 ppm, 1000 ppm, 500 ppm, 400 ppm, 200 ppm, 100 ppm, 50 ppm, 10 ppm, 5 ppm, 1 ppm, 100,000 parts per billion (ppb), 10,000 ppb, 1000 ppb, 500 ppb, 400 ppb, 200 ppb, 100 ppb, 50 ppb, 10 ppb, 5 ppb, 1 ppb, 100,000 parts per trillion (ppt), 10,000 ppt, 1000 ppt, 500 ppt, 400 ppt, 200 ppt, 100 ppt, 50 ppt, 10 ppt, 5 ppt, or 1 ppt oxygen. The gas composition in the environment contained within the enclosure can comprise a substantially moisture (e.g., water) free environment. The gaseous environment can comprise at most about 100,000 ppm, 10,000 ppm, 1000 ppm, 500 ppm, 400 ppm, 200 ppm, 100 ppm, 50 ppm, 10 ppm, 5 ppm, 1 ppm, 100,000 ppb, 10,000 ppb, 1000 ppb, 500 ppb, 400 ppb, 200 ppb, 100 ppb, 50 ppb, 10 ppb, 5 ppb, 1 ppb, 100,000 ppt, 10,000 ppt, 1000 ppt, 500 ppt, 400 ppt, 200 ppt, 100 ppt, 50 ppt, 10 ppt, 5 ppt, or 1 ppt water. The gaseous environment can comprise a gas selected from the group consisting of argon, nitrogen, helium, neon, krypton, xenon, hydrogen, carbon monoxide, carbon dioxide, and oxygen. The gaseous environment can comprise air. The chamber pressure can be at least about 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 760 Torr, 1000 Torr, 1100 Torr, 2 bar, 3 bar, 4 bar, 5 bar, or 10 bar. The chamber pressure can be of any value between the afore-mentioned chamber pressure values (e.g., from about 10⁻⁷ Torr to about 10 bar, from about 10⁻⁷ Torr to about 1 bar, or from about 1 bar to about 10 bar). In some cases, the enclosure pressure can be standard atmospheric pressure. The gas can be an ultrahigh purity gas. For example, the ultrahigh purity gas can be at least about 99%, 99.9%, 99.99%, or 99.999% pure. The gas may comprise less than about 2 ppm oxygen, less than about 3 ppm moisture, less than about 1 ppm hydrocarbons, or less than about 6 ppm nitrogen.

The enclosure can be maintained under vacuum or under an inert, dry, non-reactive and/or oxygen reduced (or otherwise controlled) atmosphere (e.g., a nitrogen (N₂), helium (He), or argon (Ar) atmosphere). In some examples, the enclosure is under vacuum. In some examples, the enclosure is under pressure of at most about 1 Torr, 10⁻³ Torr, 10⁻⁶ Torr, or 10⁻⁸ Torr. The atmosphere can be provided by providing an inert, dry, non-reactive, and/or oxygen reduced gas (e.g., Ar) and/or flowing the gas through the chamber.

In some examples, a pressure system is in fluid communication with the enclosure. The pressure system can be configured to regulate the pressure in the enclosure. In some examples, the pressure system includes one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector. The pressure system can include valves; such as throttle valves. The pressure system can include a pressure sensor for measuring the pressure of the chamber and relaying the pressure to the controller, which can regulate the pressure with the aid of one or more vacuum pumps of the pressure system. The pressure sensor can be coupled to a control system. The pressure can be electronically or manually controlled.

The system and/or apparatus components described herein can be adapted and configured to generate a 3D object. The 3D object can be generated through a 3D printing process. A first layer of material can be provided adjacent to a platform. A base can be a previously formed layer of the 3D object or any other surface upon which a layer or bed of material is spread, held, placed, or supported. In the case of formation of the first layer of the 3D object the first material layer can be formed in the material bed without a base, without one or more auxiliary support features (e.g., rods), or without other supporting structure other than the material (e.g., within the material bed). Subsequent layers can be formed such that at least one portion of the subsequent layer melts, sinters, fuses, binds and/or otherwise connects to the at least a portion of a previously formed layer. In some instances, the at least a portion of the previously formed layer that is transformed and subsequently hardens into a hardened material, acts as a base for formation of the 3D object. In some cases, the first layer comprises at least a portion of the base. The material of the material layer can be any material described herein. The material layer can comprise particles of homogeneous or heterogeneous size and/or shape.

The system and/or apparatus described herein may comprise at least one energy source (e.g., the scanning energy source generating the first scanning energy, second scanning energy, and/or tiling energy flux). The first scanning energy source may project a first energy (e.g., first energy beam). The first energy beam may travel (e.g., scan) along a path. The path may be predetermined (e.g., by the controller). The apparatuses may comprise at least a second energy source. The second energy source may comprise the tiling energy source and/or the second scanning energy source. The second energy source may generate a second energy (e.g., second energy beam). The first and/or second energy may transform at least a portion of the pre-transformed material in the material bed to a transformed material. In some embodiments, the first and/or second energy source may heat but not transform at least a portion of the pre-transformed material in the material bed. In some cases, the system can comprise 1, 2, 3, 4, 5, 6, 7, 8, 9, 10, 30, 100, 300, 1000 or more energy fluxes (e.g., beams) and/or sources. The system can comprise an array of energy sources (e.g., laser diode array). Alternatively, or additionally the target surface, material bed, 3D object (or part thereof), or any combination thereof may be heated by a heating mechanism. The heating mechanism may comprise dispersed energy beams. In some cases, the at least one energy source is a single (e.g., first) energy source.

An energy source can be a source configured to deliver energy to an area (e.g., a confined area). An energy source can deliver energy to the confined area through radiative heat transfer. The energy source can project energy (e.g., heat energy, and/or energy beam). The energy (e.g., beam) can interact with at least a portion of the pre-transformed material (e.g., in the material bed). The energy can heat the material in the material bed before, during and/or after the material is being transformed. The energy can heat at least a fraction of a 3D object at any point during formation of the 3D object. Alternatively, or additionally, the material bed may be heated by a heating mechanism projecting energy (e.g., radiative heat and/or energy beam). The energy may include an energy beam and/or dispersed energy (e.g., radiator or lamp). The energy may include radiative heat. The radiative heat may be projected by a dispersive energy source (e.g., a heating mechanism) comprising a lamp, a strip heater (e.g., mica strip heater, or any combination thereof), a heating rod (e.g., quartz rod), or a radiator (e.g., a panel radiator). The heating mechanism may comprise an inductance heater. The heating mechanism may comprise a resistor (e.g., variable resistor). The resistor may comprise a varistor or rheostat. A multiplicity of resistors may be configured in series, parallel, or any combination thereof. In some cases, the system can have a single (e.g., first) energy source. An energy source can be a source configured to deliver energy to an area (e.g., a confined area). An energy source can deliver energy to the confined area through radiative heat transfer (e.g., as described herein).

The energy beam may include a radiation comprising an electromagnetic, or charged particle beam. The energy beam may include radiation comprising electromagnetic, electron, positron, proton, plasma, or ionic radiation. The electromagnetic beam may comprise microwave, infrared, ultraviolet, or visible radiation. The energy beam may include an electromagnetic energy beam, electron beam, particle beam, or ion beam. An ion beam may include a cation or an anion. A particle beam may include radicals. The electromagnetic beam may comprise a laser beam. The energy beam may comprise plasma. The energy source may include a laser source. The energy source may include an electron gun. The energy source may include an energy source capable of delivering energy to a point or to an area. In some embodiments, the energy source can be a laser source. The laser source may comprise a CO₂, Nd:YAG, Neodymium (e.g., neodymium-glass), an Ytterbium, or an excimer laser. The laser may be a fiber laser. The energy source may include an energy source capable of delivering energy to a point or to an area. The energy source (e.g., first scanning energy source) can provide an energy beam having an energy density of at least about 50 joules/cm² (J/cm²), 100 J/cm², 200 J/cm², 300 J/cm², 400 J/cm², 500 J/cm², 600 J/cm², 700 J/cm², 800 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source (e.g., first scanning energy source) can provide an energy beam having an energy density of at most about 50 J/cm², 100 J/cm², 200 J/cm², 300 J/cm², 400 J/cm², 500 J/cm², 600 J/cm², 700 J/cm², 800 J/cm², 1000 J/cm², 500 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source (e.g., scanning energy source) can provide an energy beam having an energy density of a value between the afore-mentioned values (e.g., from about 50 J/cm² to about 5000 J/cm², from about 200 J/cm² to about 1500 J/cm², from about 1500 J/cm² to about 2500 J/cm², from about 100 J/cm² to about 3000 J/cm², or from about 2500 J/cm² to about 5000 J/cm²). In an example a laser (e.g., scanning energy source) can provide electromagnetic energy (e.g., light energy) at a peak wavelength of at least about 100 nanometer (nm), 400 nm, 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 2000 nm, 1900 nm, 1800 nm, 1700 nm, 1600 nm, 1500 nm, 1200 nm, 1100 nm, 1090 nm, 1080 nm, 1070 nm, 1060 nm, 1050 nm, 1040 nm, 1030 nm, 1020 nm, 1010 nm, 1000 nm, 750 nm, 500 nm, 400 nm, or 100 nm. The laser can provide light energy at a peak wavelength between any of the afore-mentioned peak wavelength values (e.g., from about 100 nm to about 2000 nm, from about 500 nm to about 1500 nm, or from about 1000 nm to about 1100 nm). The energy beam (e.g., laser) may have a power of at least about 0.5 Watt (W), 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy beam may have a power of at most about 0.5 W, 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500, 2000 W, 3000 W, or 4000 W. The energy beam may have a power between any of the afore-mentioned laser power values (e.g., from about 0.5 W to about 100 W, from about 1 W to about 10 W, from about 100 W to about 1000 W, or from about 1000 W to about 4000 W). The first energy source (e.g., producing the first scanning energy beam) may have at least one of the characteristics of the second energy source (e.g., producing the second scanning energy beam). The energy flux may have the same characteristics disclosed herein for the energy beam. The energy flux may be generated from the same energy source or from different energy sources. The energy flux may be of a lesser power as compared to the scanning energy beam. Lesser power may be by about 0.25, 0.5, 0.75, or 1 (one) order of magnitude. The scanning energy beam may operate independently with the energy flux. The scanning energy beam and the energy flux may be generated by the same energy source that operates in two modules (e.g., different modules) respectively. The characteristics of the irradiating energy may comprise wavelength, power, amplitude, trajectory, footprint, intensity, energy, fluence, Andrew Number, hatch spacing, scan speed, or charge. The charge can be electrical and/or magnetic charge. Andrew number is proportional to the power of the irradiating energy over the multiplication product of its velocity (e.g., scan speed) by the its hatch spacing. The Andrew number is at times referred to as the area filling power of the irradiating energy.

An energy beam from the energy source(s) can be incident on, or be directed perpendicular to, the target surface. An energy beam from the energy source(s) can be directed at an acute angle within a value of from parallel to perpendicular relative to the target surface. The energy beam can be directed onto a specified area of at least a portion of the source surface and/or target surface for a specified time period. The material in target surface (e.g., powder material such as in a top surface of a powder bed) can absorb the energy from the energy beam and, and as a result, a localized region of the solid material can increase in temperature. The energy beam can be moveable such that it can translate relative to the source surface and/or target surface. The energy source may be movable such that it can translate relative to the target surface. The energy beam(s) can be moved via a scanner (e.g., as disclosed herein). At least two (e.g., all) of the energy sources can be movable with the same scanner. A least two (e.g., all) of the energy beams can be movable with the same scanner. At least two of the energy source(s) and/or beam(s) can be movable (e.g., translated) independently of each other. In some cases, at least two of the energy source(s) and/or beam(s) can be translated at different rates (e.g., velocities). In some cases, at least two of the energy source(s) and/or beam(s) can be comprise at least one different characteristic. The characteristics may comprise wavelength, power, amplitude, trajectory, footprint, intensity, energy, or charge. The charge can be electrical and/or magnetic charge.

The energy source can be an array, or a matrix, of energy sources (e.g., laser diodes). Each of the energy sources in the array, or matrix, can be independently controlled (e.g., by a control mechanism) such that the energy beams can be turned off and on independently. At least a part of the energy sources in the array or matrix can be collectively controlled such that the at least two (e.g., all) of the energy sources can be turned off and on simultaneously. The energy per unit area or intensity of at least two energy sources in the matrix or array can be modulated independently (e.g., by a control mechanism or system). At times, the energy per unit area or intensity of at least two (e.g., all) of the energy sources in the matrix or array can be modulated collectively (e.g., by a control mechanism). The energy source can scan along the source surface and/or target surface by mechanical movement of the energy source(s), one or more adjustable reflective mirrors, or one or more polygon light scanners. The energy source(s) can project energy using a DLP modulator, a one-dimensional scanner, a two-dimensional scanner, or any combination thereof. The energy source(s) can be stationary. The target and/or source surface can translate vertically, horizontally, or in an angle (e.g., planar or compound). Translation of the target and/or surface can be manual, automatic, or a combination thereof. Translation can be controlled by at least one controller which at least one controller can operate to maintain a selected focus (or de-focus) of an energy source at or near the target and/or surface. Translation control can be local or remote (e.g., controlled over a network connection). The selected focus can be a variable focus.

The energy source can be modulated. The energy flux (e.g., beam) emitted by the energy source can be modulated. The modulator can include amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an aucusto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

An energy beam from the first and/or second energy source can be incident on, or be directed to, a target surface (e.g., the exposed surface of the material bed). The energy beam can be directed to the pre-transformed or transformed material for a specified time period. That pre-transformed or transformed material can absorb the energy from the energy source (e.g., energy beam and/or dispersed energy), and as a result, a localized region of that pre-transformed or transformed material can increase in temperature. The energy source and/or beam can be moveable such that it can translate relative to the surface (e.g., the target surface). In some instances, the energy source may be movable such that it can translate across (e.g., laterally) the top surface of the material bed. The energy beam(s) and/or source(s) can be moved via a scanner. The scanner may comprise a galvanometer scanner, a polygon, a mechanical stage (e.g., X-Y stage), a piezoelectric device, gimble, or any combination of thereof. The galvanometer may comprise a mirror. The scanner may comprise a modulator. The scanner may comprise a polygonal mirror. The scanner can be the same scanner for two or more energy sources and/or beams. At least two (e.g., each) energy source and/or beam may have a separate scanner. The energy sources can be translated independently of each other. In some cases, at least two energy sources and/or beams can be translated at different rates, and/or along different paths. For example, the movement of the first energy source may be faster (e.g., at a greater rate) as compared to the movement of the second energy source. The systems and/or apparatuses disclosed herein may comprise one or more shutters (e.g., safety shutters). The energy beam(s), energy source(s), and/or the platform can be moved by the scanner. The galvanometer scanner may comprise a two-axis galvanometer scanner. The scanner may comprise a modulator (e.g., as described herein). The energy source(s) can project energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle). The energy source(s) can be modulated. The scanner can be included in an optical system that is configured to direct energy from the energy source to a predetermined position on the target surface (e.g., exposed surface of the material bed). The controller can be programmed to control a trajectory of the energy source(s) with the aid of the optical system. The controller can regulate a supply of energy from the energy source to the material (e.g., at the target surface) to form a transformed material.

An optical system can be enclosed in a chamber (e.g., to separate a radiation environment from a radiation-free environment. The chamber may be, or be comprised in, the enclosure of the 3D printing system. The chamber may be the processing chamber. The chamber may be an optical chamber. The optical chamber (e.g., FIG. 1, 155) may be separate from the processing chamber (e.g., FIG. 1, 107). The optical chamber may be an integral part of the processing chamber. The radiation free environment may be the external environment (e.g., the ambient environment). The radiation can be generated by one or more energy sources coupled with the chamber. The radiation can be directed toward one or more optical systems (such as described herein) in the chamber (i) directly (e.g., by the one or more energy sources coupled to an opening of a wall of the chamber and radiating into the chamber), or (ii) indirectly (e.g., by a fiber coupled to the one or more energy sources, which fiber enters into the chamber (e.g., via a through-hole) and directs energy source radiation). One or more components of the optical system(s) can be adjusted inside the chamber. The adjustment can be made before, during, and/or after a build process (e.g., 3D printing), or any combination thereof. Adjustment can be made from the radiation-free environment. The adjustment can be made remotely, for example, using signal transmission (e.g., communication signals). Adjustment can be made by suitable elements, such as mechanical or electro-mechanical tool(s), The mechanical or electro-mechanical tool may comprise a screw or a lever. The mechanical or electro-mechanical tool may extend from the external environment into the chamber. The mechanical or electro-mechanical tool may penetrate into the radiation chamber (e.g., via through-holes). The mechanical or electro-mechanical tool may operatively couple to the optical element (e.g., to be adjusted). The coupling may be permanent or reversible. The adjustment tool(s) can be removable (e.g., reversibly engaged), or fixed in place (e.g., fixed to the chamber and/or the optical element). The optical element may be referred to herein as “optical component.” The access to the optical components (e.g., the through-holes) can be sealed, e.g., by a removable cover or by a diaphragm. In some embodiments adjustments to the optical component(s) can be made manually, automatically, or a combination thereof. Automatic adjustments can be controlled (e.g., by at least one controller), which control can be local (e.g., by a local controller coupled with the adjustment tool(s)) or remote (e.g., by a controller coupled with the adjustment tool(s) over a network).

In some embodiments, at least the processing chamber (and the enclosure comprising the processing chamber) is maintained at a positive pressure, e.g., compared with the ambient environment, the radiation environment, or a combination thereof. In some embodiments the pressure in the processing chamber (and the enclosure comprising the processing chamber) may be raised (e.g., by a pump) such that there may be (e.g., substantially) no negative pressure within the chamber, with respect to the ambient pressure. For example, the pressure in the area surrounding the platform and/or material bed may be at a positive pressure with respect to the ambient pressure. In some embodiments, the optical chamber is maintained at ambient pressure or at a positive pressure. For example, the pressure in the area surrounding the optical system(s) may be at a positive pressure with respect to the ambient pressure. At times, a gas flow may be directed toward one or more elements of the optical systems(s), e.g., to clean debris from at least a portion of the element. The gas flow can comprise an inert gas (e.g., nitrogen, helium, and/or argon), or air (e.g., filtered air). The gas may be a cooling gas. A raised pressure may be at least about 1 psi, 2 psi, 3 psi, 4 psi, 5 psi, 6 psi, 7 psi, 8 psi, 9 psi, or 10 psi above the ambient pressure. The raised pressure may be any value between the aforementioned values (e.g., from about 1 psi to about 10 psi, from about 1 psi to about 5 psi, or from about 5 psi to about 10 psi). The raised pressure may be the pressure directly adjacent to the pump (e.g., behind the pump). The raised pressure may be the average pressure in the chamber. The chamber can be maintained under an inert, dry, non-reactive and/or oxygen reduced (or otherwise controlled) atmosphere. The atmosphere can be provided by providing an inert, dry, non-reactive, and/or oxygen reduced gas (e.g., Ar and/or N₂) and/or flowing the gas through the chamber.

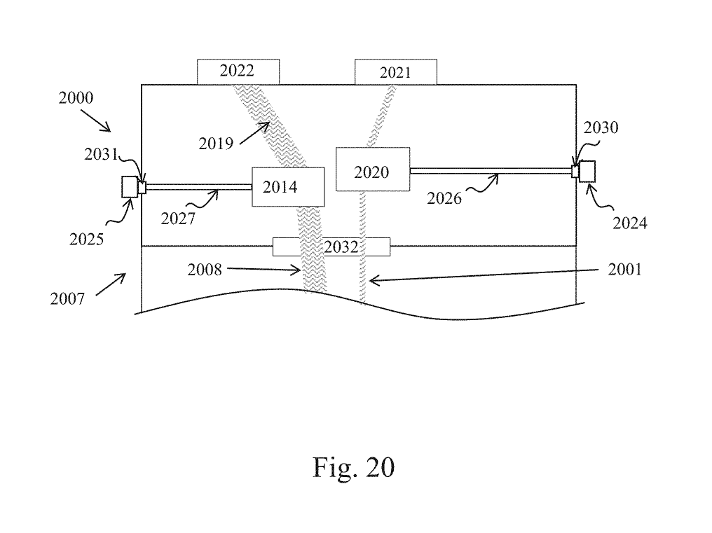

FIG. 20 shows an example of a chamber 2000 that encloses optical elements 2014 and 2020. In the example of FIG. 20 the (e.g., first) optical element 2014 is coupled with an (e.g., first) adjustment element 2027, and the (e.g., second) optical element 2020 is coupled with an (e.g., second) adjustment element 2026. The adjustment element is referred to herein as an “adjuster.” The adjustment element(s) can be accessible from an external portion of the chamber (e.g., via through-holes 2030 and 2031 respectively). At least one controller can be operatively coupled with the adjustment element(s) (e.g., controller(s) 2024 and 2025 coupled with 2026 and 2027, respectively). Operative coupling can be via (respective) through-holes (e.g., 2030 and 2031). Control can be (i) separate control, (ii) coordinated control, or (iii) a combination thereof. Separate control can include the controller(s) controlling respective adjustment element(s) one at a time. Coordinated control can include the controller(s) controlling their respective adjustment element(s) simultaneously, sequentially, or contemporaneously. Control can be manual, automatic, or a combination thereof. The control can be made remotely, for example, using signal transmission (e.g., communication signals). In some embodiments the controller can be controlled over a network. The energy source(s) (e.g., 2021 and/or 2022) can be coupled with the chamber (e.g., on an external wall), and emit respective energy beams, for example a scanning energy beam and an energy flux (e.g., 2019) toward the optical element(s) (e.g., 2014 and/or 2020). The optical element(s) can direct energy beam(s) through one or more optical windows (e.g., 2032), e.g., forming emitted radiative energy (e.g., 2008) and/or scanning energy beam (e.g., 2001). The radiative energy and/or scanning energy may travel within a processing chamber (e.g., 2007) of a 3D printing system. The adjuster may comprise a rod, shaft, string, or a plank. The adjuster may be linear (e.g., straight), or non-linear. The adjuster may comprise a curvature. The adjuster may comprise an angle. The adjuster may comprise a linear portion. The adjuster may be aligned or misaligned with the optical element. The adjuster may comprise a handle. The handle may be external to the chamber (e.g., 2000). The handle may comprise a knob, shaft, handgrip, haft, holder, lever, or crank. The adjuster (e.g., handle thereof) may be operatively coupled to the at least one controller.

The energy beam(s) emitted by the energy source(s) can be modulated. The modulator can include an amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an aucusto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

Energy (e.g., heat) can be transferred from the material bed to a cooling member (e.g., heat sink FIG. 1, 113). The cooling member can facilitate transfer of energy away from a least a portion of a pre-transformed material layer. In some cases, the cooling member can be a thermally conductive plate. The cooling member can be passive. The cooling member can comprise a cleaning mechanism (e.g., cleaning device), which removes powder and/or process debris from a surface of the cooling member to sustain efficient cooling. Debris can comprise dirt, dust, powder (e.g., that result from heating, melting, evaporation and/or other process transitions), or hardened material that did not form a part of the 3D object. In some cases, the cleaning mechanism can comprise a stationary rotating rod, roll, brush, rake, spatula, or blade that rotates when the cooling member (e.g., heat sink) moves in a direction adjacent to the platform (e.g., laterally). The cleaning mechanism may comprise a vertical cross section (e.g., side cross section) of a circle, triangle, square, pentagon, hexagon, octagon, or any other polygon. The vertical cross section may be of an amorphous shape. In some cases, the cleaning mechanism rotates when the cooling member moves in a direction that is not lateral. In some cases, the cleaning mechanism rotates without movement of the cooling member. In some cases, the cooling member comprises at least one surface that is coated with a layer that prevents powder and/or debris from coupling (e.g., attaching) to the at least one surface (e.g., an anti-stick layer).

In another aspect, the 3D printer comprises a detection system. In some embodiments, the detection system detects one or more characteristics and/or features of the irradiating energy. In some embodiments, the detection system detects one or more characteristics and/or features caused by the irradiating energy (e.g., on the target surface). In some embodiments, the detection system detects one or more characteristics and/or features of an electromagnetic radiation. In some embodiments, the detection system detects one or more characteristics and/or features of a black body radiation.

In some embodiments aberration-correcting optics (e.g., achromatic optics) provide focusing of energy source radiation and returning radiation (e.g., contemporaneously) each on a different target. For example, the energy source radiation (e.g., transforming energy beam) can be focused onto a target surface (e.g., of the 3D printing), and the returning radiation from the target surface can be focused onto one or more detectors (e.g., the surface(s) of the one or more detectors). The focus may be direct or indirect. The returning radiation can comprise a blackbody (or other thermal radiation) from the target surface. A path of the returning radiation through the optical system(s) described herein can be termed a “thermal path.” The detectors can be operatively coupled to one or more fibers. For example, a detector can be operatively coupled to a fiber. For example, a detector can be operatively coupled to a plurality of fibers. For example, a first detector can be operatively coupled to one fiber and a second detector can be operatively coupled to a plurality of fibers (that exclude the one fiber). For example, a first detector can be operatively coupled to a first group of plurality of fibers and a second detector can be operatively coupled to a second group of plurality of fibers. Operatively coupled may comprise connected, e.g., directly connected. The fiber may be an optical fiber (e.g., a glass fiber or a plastic fiber). Detectors that are operatively coupled to (e.g., comprise) one or more fibers can be can be present in embodiments that do not include aberration-correcting optics. The one or more fibers can be placed preceding the detector (e.g., to receive radiation and transmit the radiation to the detector). Returning radiation can be focused onto the one or more fibers and transmitted to one or more detectors. The indirect focus of the radiation onto the detector may be by focusing the radiation on a surface of a radiation entry end of the fiber. The radiation may be (optically) communicated to the detector through the fiber. The detector may comprise a sensor. The detectors can be configured to operate as point detectors, area detectors, or any combination thereof. One or more (optical) filters can be operatively coupled with the one or more detectors (e.g., respectively). The one or more filters can, for example, filter (e.g., at least partially reject) wavelengths corresponding to energy source wavelengths and pass selected wavelengths. The rejection of the wavelength may be by absorption, deflection, and/or dispersion. For example, the filter may pass radiation in the IR and/or near-IR spectrum (e.g., to pass returning radiation). The one or more filters can, for example, attenuate wavelengths corresponding to energy source wavelengths and reject other wavelengths (e.g., to pass only a portion of energy source radiation and/or returning energy source radiation).

At least a portion of an optical system (e.g., comprising a lens mirror, beam splitter, or filter) that can be used to controllably focus the irradiating energy onto the target surface can be used to focus the returning radiation onto the one or more detectors. Controllably focus can include translation and/or rotation of one or more mirrors, lenses, beam splitters, or filters. The optical system can be configured such that, as a focal point of an irradiating energy beam is moved in a path along a target surface (e.g., adjusted) (e.g., along a plane), a focus of returning radiation generated within the processing environment is maintained on the one or more detectors and/or radiation entry end of the one or more fibers. The returning radiation can have a different wavelength than the irradiating energy beam. A different radiation wavelength (e.g., a returning radiation) can engender chromatic aberration when passing through the same optical component(s) as the irradiating energy beam. Aberration-correcting optics (e.g., achromatic optics, apochromatic optics, and/or superachromatic optics) within the optical system can be configured to correct for chromatic aberration, and/or spherical aberration. The optical system can be operable to direct the irradiating energy and the returning radiation through a shared portion of an optical path (e.g., in a boresight or a through beam configuration). The optical system can be operable to direct the returning radiation through a portion of an optical path that is not shared by the irradiating energy.

For example, one or more beam splitters of the optical system can be configured to (i) transmit at least a portion of energy source radiation, (ii) deflect (e.g., reflect) at least a portion of energy source radiation, (iii) reflect at least a portion of energy source radiation returning from a surface, (iv) transmit at least a portion of energy source radiation returning from a surface, (v) reflect at least a portion of returning radiation, and/or (vi) transmit at least a portion of returning radiation. In some embodiments a detection system can be arranged corresponding to each of the above-mentioned optical paths (e.g., optical paths formed by beam splitter transmission/reflection examples (i)-(vi), above), for example, one detector for each optical path. In some embodiments only one detector is present (e.g., a detector arranged to receive returning radiation reflected from a beam splitter). In some embodiments, an aberration-correcting optical system can include more than one beam splitter. In some embodiments, a beam splitter of the optical system transmits at least 95%, at least 96%, at least 97%, at least 98%, or at least 99% of an incident energy source radiation. In some embodiments, a beam splitter of the optical system transmits at most 99%, at most 98%, at most 97%, at most 96%, or at most 95% of an incident energy source radiation. In some embodiments transmission can correspond to between any of the afore-mentioned values (e.g., from about 95% to about 99%, from about 95% to about 97%, or from about 97% to about 99%). In some embodiments, a beam splitter reflects at most 5%, at most 4%, at most 3%, at most 2%, or at most 1% of an incident energy source radiation. In some embodiments, a beam splitter reflects at least 1%, at least 2%, at least 3%, at least 4%, or at least 5% of an incident energy source radiation. In some embodiments reflection can correspond to between any of the afore-mentioned values (e.g., from about 5% to about 1%, from about 5% to about 3%, or from about 3% to about 1%). The energy source radiation can be such as described herein, for example, electromagnetic radiation. The returning radiation can be such as described herein, for example, blackbody radiation. The returning radiation can have a wavelength that is different from a wavelength of the irradiating energy.

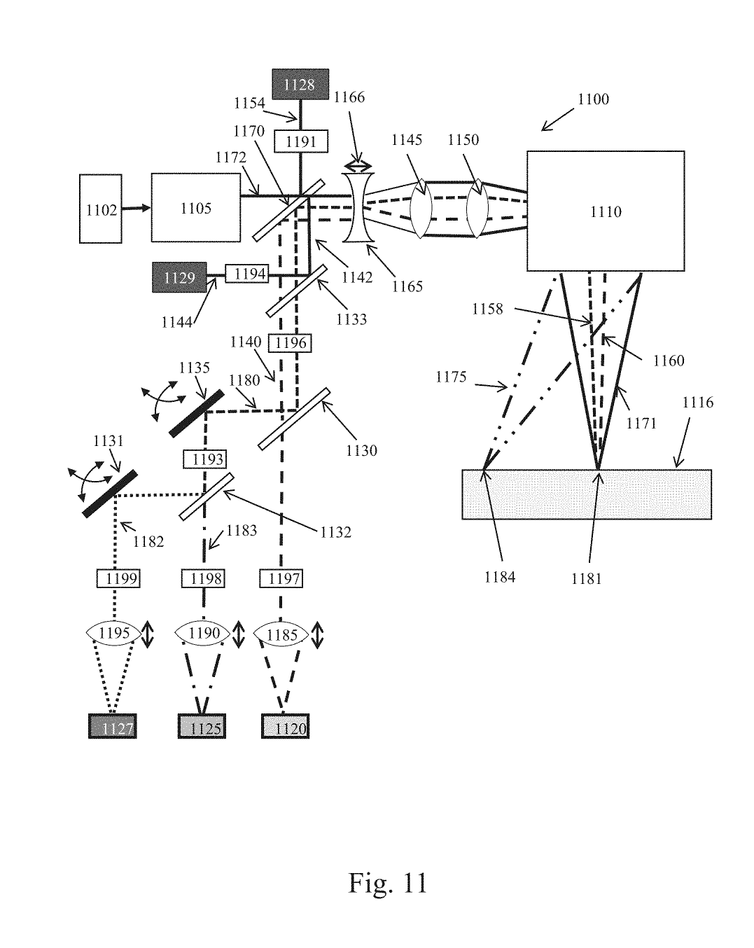

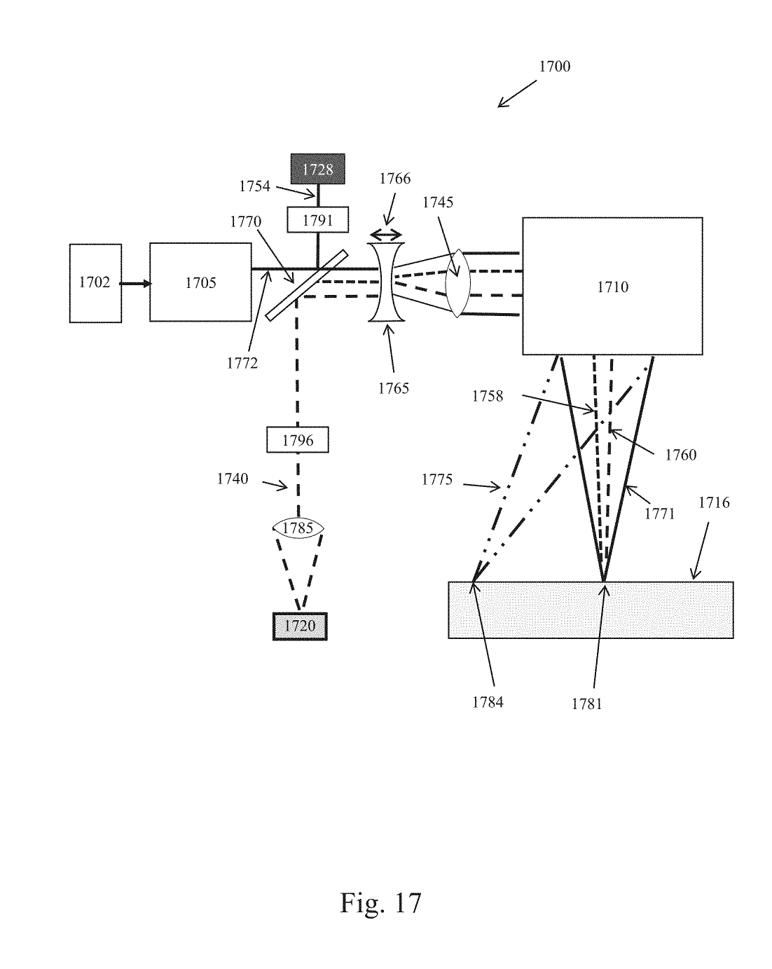

FIG. 17 shows an example of a (e.g., optical) detection system 1700 as part of a 3D printing system. In the example of FIG. 17 an energy source 1702 provides an energy beam 1772 to a collimator 1705, and the collimated energy beam is incident on a beam splitter 1770. In the example of FIG. 17 the energy beam passes through optical elements 1765 (e.g., a diverging lens, capable of translating 1766) and 1745 (e.g., a converging lens) to a scanner 1710 (e.g., any scanner described herein). An arrangement of the one or more lenses may comprise a vario z focusing arrangement. While not depicted in the example of FIG. 17, it should be appreciated that more than one or more optical elements can be present between the optical element (e.g., 1765) and the scanner (e.g., 1710) (e.g., a second converging lens, such as in FIG. 11, 1150). The scanner (e.g., 1710) can be operable to direct an energy beam onto a material, for example, via optical paths (e.g., 1771 and 1775) toward target positions (e.g., 1781 and 1784, respectively) of a target surface (e.g., 1716). Irradiation of the target surface can generate characteristic radiation (e.g., electromagnetic radiation) at or near the targeted position of the target material. Near the targeted position may be at most 2, 3, 4, 5, 6, 7, or 10 FLS of the energy beam (e.g., cross sectional diameter of the energy beam, or diameters of the footprint of the energy beam on the target surface).

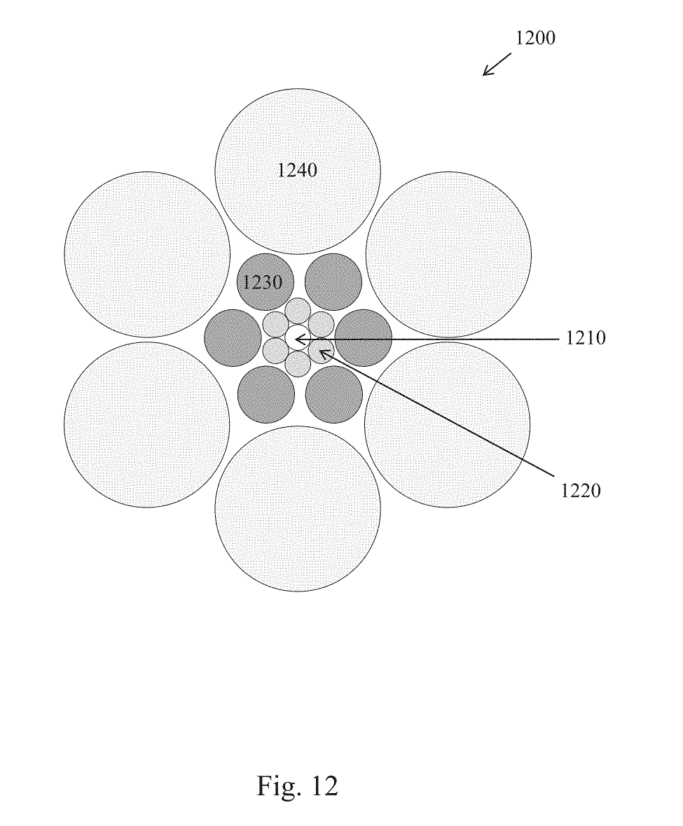

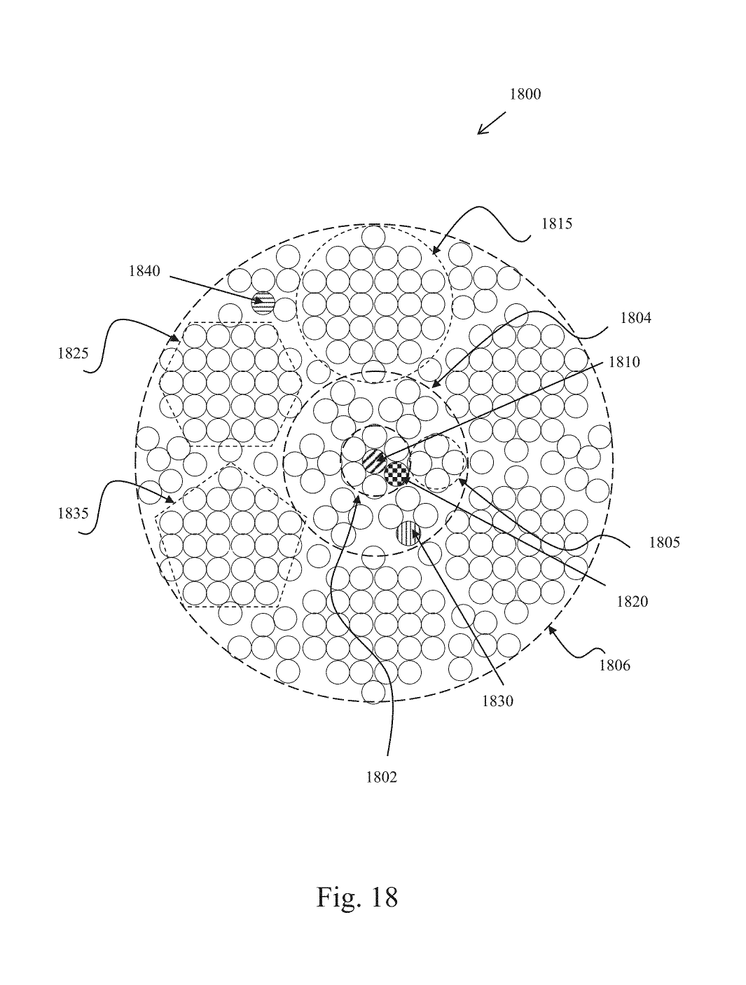

In some embodiments, a directed energy beam is transforming the target material from a first state (e.g., a pre-transformed state) to a second state (e.g., a transformed state), and optionally generates heat within the target material. The target material may be a portion of a material bed. The target material may comprise at least a portion of the target surface. In some embodiments, a detector is arranged to follow the processing location of the directed energy beam to the target material. For example, the detector may move along with a point at which the energy beam is incident upon the target material. The processing location may comprise (i) a footprint of the energy beam on a target surface, (ii) a transformed portion that comprises the target surface, or (iii) a heated portion that comprises the target surface. In an embodiment, an optical system includes a detector (e.g., FIG. 12, 1200) operable to detect one or more characteristics of the target material. For example, the detector may be operable to detect one or more characteristics of the target surface (or a portion thereof). The detector can be operated continuously, or controlled to operate at selected intervals. The detector may operate before, during, and/or after processing of the target material. The detector can be formed, for example, by a bundle of optical fibers operatively coupled with a radiation-sensitive one or more detectors. According to some embodiments, each fiber is connected to its own radiation detector, e.g., in a one-to-one ratio. In some embodiments, a plurality of fibers is collectively operatively coupled to a detector, e.g., depending on their spatial arrangement. For example, the central fiber may be operatively coupled to a first detector. For example, fibers that are disposed in a circular arrangement may be collectively operatively coupled to a second detector. The first detector may be different from the second detector. The radiation detector can be adapted to detect a selected wavelength of radiation. For example, the first detector may be configured to detect shorter wavelengths as compared to the second detector. The radiation may be an electromagnetic radiation. The wavelength of the electromagnetic radiation may comprise a wavelength in the ultraviolet band, visible band, or infrared (IR) band. According to some embodiments different radiation detectors detect different wavelengths, respectively. For example, a near-IR wavelength for a first radiation detector (e.g., a detector coupled with fiber 1820, FIG. 18), and an IR wavelength for a second radiation detector (e.g., a detector coupled with fiber 1840, FIG. 18). The bundle of fibers can be operable to receive radiation (e.g., wavelength) emitted from the target material.

In some embodiments, different groups of pluralities of fibers are coupled to different detectors, e.g., depending on their spatial arrangement. For example, the central fiber may be operatively coupled to a first detector. A first group of fibers that are disposed in a first circular arrangement around the central fiber may be collectively operatively coupled to a second detector. A second group of fibers that are disposed in a second circular arrangement around the central fiber and around the first group of fibers may be collectively operatively coupled to a third detector. The second group of fibers may be more distant from the central fiber than the second group of fibers. The first detector may be different from the second detector. The first detector may be different from the third detector. The third detector may be different from the second detector. The radiation detector can be adapted to detect a selected wavelength of radiation. For example, the first detector may be configured to detect shorter wavelengths as compared to the second detector. For example, the second detector may be configured to detect shorter wavelengths as compared to the third detector.

In the example of FIG. 17 returned energy beams 1758 and 1760 travel from the target surface 1716 back through optical elements of the scanner 1710 and the lenses 1745 and 1765. In the example shown in FIG. 17, the returned energy beams are reflected by beam splitter 1770 toward one or more detectors (e.g., as described herein), for example, detector 1720. A beam splitter can comprise a dichroic mirror. The beam splitter may be operable (e.g., configured) to transmit incident radiation of a first selected spectrum of wavelengths and to reflect a second (e.g., non-overlapping) selected spectrum of wavelengths (e.g., wavelengths corresponding to a returning energy beam(s)). Additional optical components and detectors (e.g., corresponding to different wavelengths of the returning energy beams) can be provided, e.g., beam splitters (e.g., 1130, 1132 and 1133) and detectors (e.g., 1125 and 1127) in the example of FIG. 11. The returned energy beams can be transmitted through a beam splitter, while other wavelengths (e.g., wavelengths corresponding to returning energy source radiation) are reflected by the beam splitter. The detector can comprise one or more fibers, which fiber(s) can be coupled to one or more radiation-sensitive detection elements (e.g., such as described herein). The returned energy beams can be incident upon the one or more fibers, which fibers transmit received radiation to the one or more detectors coupled therewith. The returned energy beams can be filtered (e.g., by wavelength) prior to incidence onto a detector (e.g., by filter 1796), providing a filtered returned energy beam (e.g., 1740). In some embodiments a focusing element (e.g., FIG. 17, 1785), which can be fixed or movable (e.g., translatable or rotatory), is provided for focusing returned energy beams onto the detector. In some embodiments a portion of the energy beam output from the collimator is deflected onto a detector for monitoring characteristics of the energy beam output by the energy source. In the example shown in FIG. 17 the beam splitter 1770 deflects a portion of the energy beam through a filter 1791, forming filtered energy beam 1754, onto a detector 1728. The deflected beam detector can detect one or more characteristics of the energy source radiation provided to the optical system, for example, to measure a power stability of the energy source radiation. The deflected beam detector can detect one or more characteristics of the radiation emitted by the energy source, comprising energy profile shape and homogeneity of signal across the energy profile. The deflected beam detector can detect one or more characteristics of the radiation emitted by the energy source before it interacted with the target surface and/or other components of the optical system. In some embodiments the amount of the energy beam deflected can be at most 5%, at most 4%, at most 3%, at most 2%, or at most 1% of the total energy emitted (e.g., generated) by the energy source. In some embodiments the amount deflected can be at least 1%, at least 2%, at least 3%, at least 4%, or at least 5%. In some embodiments the amount deflected can correspond to between any of the afore-mentioned values (e.g., from about 5% to about 1%, from about 5% to about 3%, or from about 3% to about 1%).

FIG. 11 shows an example of a (e.g., optical) detection system (e.g., FIG. 11, 1100) as part of a 3D printer. The detection system may be operatively coupled to at least one component of the processing chamber. The at least one component of the processing chamber may comprise the irradiating energy, the controller, the target surface, or the platform. The detection system may be operatively coupled to the build module. The detection system may be a part of the optical system. The detection system may be separate from (e.g., different than) the optical system. The detection system may be operatively coupled to an energy source (e.g., FIG. 11, 1102). The energy source may be any energy source disclosed herein (e.g., tiling energy source and/or scanning energy source). The energy source may irradiate with a transforming energy (e.g., beam or flux). The irradiating transforming energy may heat (e.g., at transform) a material at the target surface, and subsequently emit an electromagnetic radiation of a different wavelength (e.g., a thermal radiation, e.g., a black body radiation) and/or be reflected back (e.g., away from the material). The different wavelength may be a larger wavelength as compared to the wavelength of the irradiating energy by the energy source. For example, a laser may emit laser energy towards the target surface at a position, which irradiation will cause the irradiated position to heat (e.g., at transform). The laser irradiation may be reflected back from the target surface (e.g., exposed surface of a material bed). The heating of the position at the target surface may cause emittance of heat radiation. The heat radiation may have a larger wavelength as compared to the laser irradiation wavelength. At times, the irradiating energy may illuminate the enclosure environment. At times, the target surface may be illuminated by the irradiating energy (e.g., direct or reflected) or the produced black body radiation. At times, the enclosure environment may include a separate illumination source (e.g., a light-emitting diode (LED)). The back reflected irradiating energy and/or the electromagnetic radiation of a different wavelength are referred to herein as “the returned energy beams.” The returned energy beams may be detected via one or more detectors. The detection may be performed in real-time (e.g., during at least a portion of the 3D printing). For example, the real-time detection may be during the transformation of the pre-transformed material. The irradiating energy may be focused on a position at the target surface. The returned energy beams may be focused on their respective detectors. In some embodiments, the irradiating energy is focused on a position at the target surface as at least a portion of the returned energy beams are focused on at least one of their respective detectors. The returned energy beam can provide energy at a peak wavelength of at least about 100 nanometer (nm), 400 nm, 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, 2000 nm, 2100 nm, 2200 nm, 2300 nm, 2400 nm, 2500 nm, 2600 nm, 2700 nm, 2800 nm, 2900 nm 3000 nm, or 3500 nm. The returned energy beam can provide energy at a peak wavelength of at most about 3500 nm, 3000 nm, 2900 nm, 2800 nm, 2700 nm, 2600 nm, 2500 nm, 2400 nm, 2300 nm, 2200 nm, 2100 nm, 2000 nm, 1900 nm, 1800 nm, 1700 nm, 1600 nm, 1500 nm, 1200 nm, 1100 nm, 1090 nm, 1080 nm, 1070 nm, 1060 nm, 1050 nm, 1040 nm, 1030 nm, 1020 nm, 1010 nm, 1000 nm, 750 nm, 500 nm, 400 nm, or 100 nm. The returned energy beam can provide energy at a peak wavelength between any of the afore-mentioned peak wavelength values (e.g., from about 100 nm to about 3500 nm, from about 1000 nm to about 1500 nm, from about 1700 nm to about 2600 nm, or from about 1000 nm to about 1100 nm). In some embodiments, the detection system may comprise aberration-correcting optics (e.g., spherical aberration correcting optics, chromatic aberration correcting optics, achromatic optics, apochromatic optics, superachromatic optics, f-theta achromatic optics, or any combinations thereof). In some embodiments, the aberration-correcting optics is devoid of an f-theta lens. In some embodiments, the aberration corrective optics is devoid off-theta achromatic optics. The detector of the returned energy beam may detect the energy at the above-mentioned peak wavelengths. The peak wavelength may be a wavelength at full width at half maximal of the energy profile of the returned energy beam.

In some cases, one or more optical elements of a detection system (e.g., comprising a lens, mirror, or beam splitter) is comprised of an optical material having high thermal conductivity (e.g., having any value of high thermal conductivity disclosed herein). The optical element may be any optical element disclosed in patent application number PCT/US17/60035, titled “GAS FLOW IN THREE-DIMENSIONAL PRINTING” that was filed on Nov. 3, 2017, which is incorporated herein by reference in its entirety. The optical material having a high thermal conductivity may have a thermal conductivity of at least about 1.5 W/m° C. (Watts per meter per degree Celsius), 2 W/m° C., 2.5 W/m° C., 3 W/m° C., 3.5 W/m° C., 4 W/m° C., 4.5 W/m° C., 5 W/m° C., 5.5 W/m° C., 6 W/m° C., 7 W/m° C., 8 W/m° C. 9 W/m° C., 10 W/m° C., or 15 W/m° C., at 300 K (Kelvin). In some embodiments, the optical material having a high thermal conductivity may have a thermal conductivity can be at most about 20 W/m° C., 10 W/m° C., 9 W/m° C., 8 W/m° C., 7 W/m° C., 6 W/m° C., 5.5 W/m° C., 5 W/m° C., 4.5 W/m° C., 4 W/m° C., 3.5 W/m° C., 3 W/m° C., 2.5 W/m° C., or 2 W/m° C., at 300K. The optical material having a high thermal conductivity may have a thermal conductivity ranging between any of the afore-mentioned values (e.g., from about 1.5 W/m° C. to about 20 W/m° C., from about 1.5 W/m° C. to about 5 W/m° C., or from about 5 W/m° C. to about 20 W/m° C.), at 300K. In some embodiments, the window and/or optical element (e.g., that includes the high thermally conductivity material) comprises sapphire, crystal quartz, zinc selenide (ZnSe), magnesium fluoride (MgF₂), zinc sulfide (ZnS), potassium fluoride (KF), infrared opmi-germanium, or calcium fluoride (CaF₂). In some embodiments, the window and/or optical element comprises SCHOTT N-BK 7®, SCHOTT N-SF2, fused silica (e.g., UV fused silica), or fused Quartz. The window and/or optical element may comprise sodium carbonate (Na₂CO₃), lime (CaO), magnesium oxide (MgO), aluminum oxide (Al₂O₃), boron trioxide (B₂O₃), soda (Na₂O₃), barium oxide (BaO), lead oxide (PbO), potassium oxide (K₂O), zinc oxide (ZnO), germanium oxide (GeO₂), barium fluoride (BaF₂), calcium fluoride (CaF₂), gallium arsenide (GaAs), germanium, lithium fluoride (LiF), magnesium fluoride (MgF₂), potassium bromide (KBr), potassium chloride (KCl), cesium iodide (CsI), calcite (CaCO₃), or thallium bromo-iodide. In some embodiments, the window and/or component(s) of the optical element comprises a material having a low thermal conductivity. The material may have a thermal conductivity at most about 2 W/m° C., 5 W/m° C., 10 W/m° C., or 11 W/m° C., at 300K. The material may have a thermal conductivity at least about 1 W/m° C., 2 W/m° C., 5 W/m° C. or 10 W/m° C., at 300K. The material may have a thermal conductivity of any value between the afore-mentioned values (e.g., from about 1 W/m° C. to about 11 W/m° C., from about 1 W/m° C. to about 5, or from about 5 W/m° C. to about 11 W/m° C.) at 300K.

In some embodiments, the optical element comprises a material having a higher thermal conductivity than that of fused silica (e.g., higher than about 1.38 W/m° C.), for example, Zerodur®. In some embodiments, the optical material comprises sapphire. In some embodiments, the optical element comprises a material having a lower thermal conductivity than that of fused silica and/or fused quartz (e.g., lower than about 1.38 W/m° C.), for example, borosilicate (e.g., BK7), silicon fluoride (e.g., SF2), or Pyrex®. An optical element having a high reflectivity may have a reflectivity of at least about 88% (e.g., percentage of incident radiative energy), 90%, 92%, 94%, 96%, 98%, 99%, 99.5%, or 99.9%, at a specified wavelength or wavelength range for incident radiative energy. The optical material having a high reflectivity may have a reflectivity ranging between any of the afore-mentioned values (e.g., from about 90% to about 99.9%, from about 90% to about 95%, or from about 95% to about 99.9%). An optical element having a high reflectivity can be comprised of any optical element material disclosed herein. In some embodiments, the optical element having a high reflectivity comprises a metallic coating such as aluminum, UV enhanced aluminum, protected aluminum, silver, protected silver, gold, or protected gold. In some embodiments, the optical element (e.g., having a high reflectivity) comprises a dielectric coating or an (e.g., ion-beam) sputtered coating. In some embodiments, the optical element comprises a material with a linear coefficient of thermal expansion of at most about 10 ppm, 8 ppm, 6 ppm, 5 ppm, 3 ppm, 2 ppm, 1 ppm, or 0.5 ppm per degree Celsius. The optical element may comprise a material with a linear coefficient of thermal expansion between any of the afore-mentioned values (e.g., from about 10 ppm to about 0.5 ppm, from about 5 ppm to about 0.5 ppm, or from about 2 ppm to about 0.5 ppm per degree Celsius). In some embodiments, the optical element comprises a material with an optical absorption coefficient of at most about 10 ppm, 50 ppm, 100 ppm, 250 ppm, 500 ppm, 750 ppm, or 900 ppm per centimeter at the wavelength of the laser. The optical element may comprise a material with an optical absorption coefficient of any value between the afore-mentioned values (e.g., from about 10 ppm to about 900 ppm, from about 10 ppm to about 500 ppm, from about 250 ppm to about 750 ppm, or from about 750 ppm to about 900 ppm per centimeter at the wavelength of the laser). The material can be an optically transparent material.

In some embodiments, the irradiating energy is collimated (e.g., by a collimator). The energy source may be operatively coupled to a collimator (e.g., FIG. 11, 1105). The collimator may collimate (e.g., narrow, parallelize, and/or align along a specific direction) the irradiating energy (e.g., the energy beam or the energy flux). The collimator may be an optical collimator (e.g., may comprise a curved lens or mirror and a light source). The collimator may include a fiducial marker (e.g., an image) to focus on. The fiducial marker may assist in collimating the energy beam to a specific focus. The collimator may include one or more filters (e.g., wavelength filters, gamma ray filters, neutron filters, X-ray filters, and/or electromagnetic radiation filters). The collimator may comprise parallel hole collimator, pinhole collimator, diverging collimator, converging collimator, fanbeam collimator, or slanthole collimator.

The collimated irradiating energy may be directed in an optical path (e.g., FIG. 11, 1171, or 1175) to a position (e.g., 1181, or 1184) on the target surface (e.g., 1116). The optical path may diverge or converge the irradiating energy. The divergence or convergence of the irradiating energy may comprise a lens. The lens may be a converging lens or a diverging lens. At least one lens may be movable (e.g., laterally) relative to the target surface.

In some embodiments, the optical path from the energy source, passing the target surface, to the detector(s) comprises a variable focus mechanism (e.g., aberration-correcting optics, e.g., achromatic optics). The optical path (or the variable focus mechanism) may comprise one or more optical elements (e.g., FIG. 11, 1170, 1165, 1145, 1150). The optical path may be controlled manually and/or by a controller. The control may be real-time control during at least a portion of the 3D printing. The controller may control the positions of the optical elements to adjust the optical path. The controller may control the positions of the optical elements to adjust the focus of the beam on the target surface and/or on the detector(s). The one or more optical elements may be translatable. The one or more optical elements may be stationary. The optical element may be a negative optical element (e.g., a concave lens or a diverging lens). The optical element may be a positive optical element (e.g., a convex lens or a converging lens). The optical element may be a beam splitter (e.g., 1170). The optical elements in the optical path may be arranged achromatically (e.g., to allow simultaneous focus on at least one detector and on a position on the target surface). The achromatic optics may keep the optical detectors and an imaging device (e.g., a fiber optics coupled to a single detector) in focus. Optionally, a portion of the collimated energy beam may be deflected (e.g., 1154, through filter 1191) or reflected (e.g., 1142, reflected returning energy source radiation from a target surface). The deflected and/or reflected energy beam may be optionally filtered by a filter (e.g., FIG. 11, beam 1144 filtered by filter 1194). The deflected and/or reflected energy beam may be directed to a detector (e.g., FIG. 11, 1128 and/or FIG. 11, 1129 for deflected and reflected, respectively). The detector may be an optical detector. The detector may comprise a spectrometer. The detector can be an imaging detector. The detector may be an intensity reflection detector. The detector may allow analyzing (e.g., visual, and/or reflective analysis) of an irradiated position at the target surface (e.g., a melt pool).

In some examples, at least one optical element translates before, after, and/or during at least a portion of the 3D printing (e.g., in real time). In some examples, at least one optical element is stationary. In some examples, at least one optical element is controlled before, after, and/or during at least a portion of the 3D printing (e.g., in real time). The first optical element (e.g., FIG. 11, 1165) may be translatable (e.g., laterally, according to arrow 1166). The first optical element may be coupled to a movable element (e.g., a swivel mount, a gimbal, a motor, an electronic controller, a moving belt, or a scanner) that translates the first optical element. The first optical element may be coupled to an actuator (e.g., lateral actuator). The translation of the movable element may be before, after during and/or during at least a portion of the 3D printing. For example, the movable element may translate in real-time. The speed of translation of the first optical element may be correlated (e.g., coupled, and/or synchronized) with the translated transforming energy beam. The correlation may be in real-time. The second optical element (e.g., FIG. 11, 1145) and/or third optical element (e.g., FIG. 11, 1150) may be stationary. The second and/or third optical elements may be positioned to adjust the focus of at least one of (i) the irradiating energy, (ii) the back reflected irradiating energy, and (iii) the electromagnetic radiation of a different wavelength. For example, the second and/or third optical elements may be positioned to adjust the focus of the irradiating energy, and at least one of (i) the back reflected irradiating energy, and (ii) the electromagnetic radiation of a different wavelength. The focus may be adjusted before, during and/or after at least a portion of the 3D printing (e.g., in real-time). The focus may be adjusted before transforming, during transforming and/or after transforming a portion of the target surface (e.g., a layer of material bed).

One or more electromagnetic radiation beams (e.g., FIG. 11, 1158, 1160) having a different wavelength from the transforming energy beam (e.g., 1170) may be directed from the target surface to one or more optical elements (e.g., lens, mirror, beam splitter, beam filter) of the detection system. The optical element may be a wide field lens. The wide field lens may be placed in the path of the transforming energy beam (e.g., between the scanner and the target surface). The wide field lens may be placed in the optical path (e.g., between the optical elements and the detector). The wide field lens may have a focal length shorter than a normal lens. The shorter focal length allows the energy beam to cover a wider area of the target surface. The electromagnetic radiation beams having a different wavelength from the transforming energy beam may be a large wavelength energy beam (e.g., as they are of a larger wavelength than the transforming energy beam). The transforming energy beam may be the irradiating energy (e.g., energy flux and/or scanning energy beam). One or more of the optical element (e.g., mirror, FIG. 11, 1135, 1131) may be translatable (e.g., rotating). Translatable may be vertically, horizontal, and/or at an angle. The mirror may facilitate aligning the returned energy beams on the detector(s) (e.g., each respectively). In some examples, the image directed on the detector correlates to the transforming energy beam spot on the target surface. At times, the returned energy beams (e.g., large wavelength energy beams) originating from the target surface (e.g., 1180) are split into two wavelength ranges. The wavelength range split may utilize a filter (e.g., 1193) and/or beam splitter (e.g., 1132). Each of one or more returned energy beams may have different energy beam characteristics (e.g., wavelength). Each of one or more detectors may be susceptible to (e.g., sensitive to detecting) different beam characteristics (e.g., wavelength range). The filter element may allow an energy beam with a characteristic (e.g., a polarity, wavelength range, intensity, profile). The filter may filter the returned energy beam based on at least one of its characteristic. For example, a first detector energy beam (e.g., FIG. 11, 1140) may be susceptible to a shorter wavelength as compared to a second detector energy beam (e.g., FIG. 11, 1180). At least two returned energy beams (or range groups thereof) may be separated by the same filter. At least two returned energy beams (or range groups thereof) may be separated by their respective and different filter (e.g., a first filter that filters shorter wavelength energy beam and a second filter that filters a longer wavelength energy beam). Each filter can isolate one or more wavelengths. Each filter may isolate a narrower range of wavelengths as compared to the returned energy beams. The filters can be optical, electronic, and/or magnetic filter. The filter may comprise a high pass filter, bandpass filter, a notch filter, a multi-bandpass filter or a low pass filter. The filter may comprise an absorption filter or a reflection filter. The filter elements may be fixed. At times, the filter elements may be translatable (e.g., before, after, and/or during at least a portion of the 3D printing). One or more filter elements may be coupled to a translatable element (e.g., a robotic arm, motor, gimbal, controller, a swivel mount, a moving belt, or a scanner). Optionally, a converging optical element (e.g., 1130, 1133) may be placed along the returned energy beam path. The converging optical element may focus one or more (e.g., all) detector energy beams on the detectors. In some embodiments, an optical fiber is connected to a detector. In some embodiments, at least one optical fiber is connected to a detector. For example, a plurality of optical fibers may be connected to a (e.g., one) detector. The (e.g., converging) optical element may focus one or more (e.g., all) detector energy beams on (e.g., onto) an optical fiber. A filter element may be selected such that the filter element may balance the spot size on the detector and/or optical fiber (e.g., that is coupled thereto). A narrow filter element may provide a narrow wavelength range (e.g., having a lower signal intensity relative to a wide filter). A wide filter element may provide a wide wavelength range (e.g., having a higher signal intensity relative to a narrow filter).

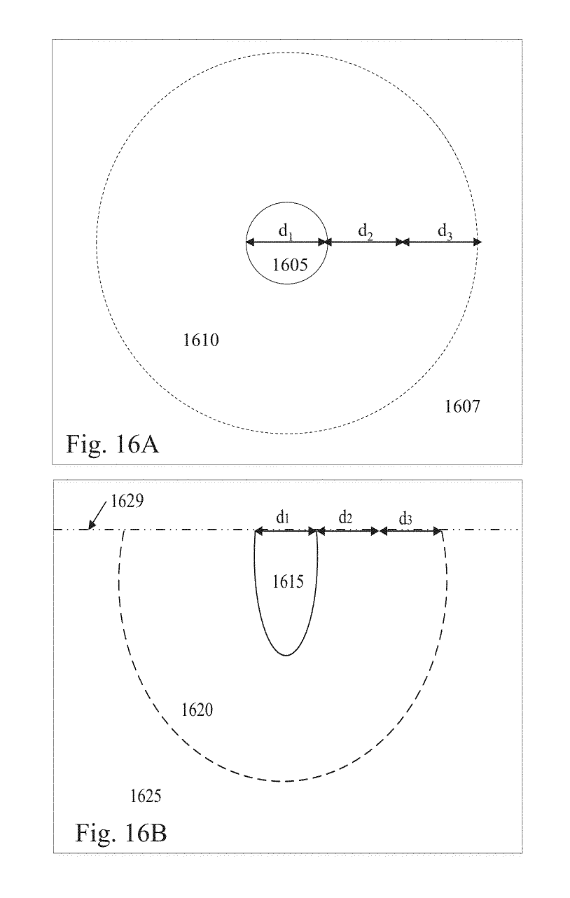

During processing, the transforming area can correspond to intense radiation and/or high temperatures (e.g., FIG. 16A, 1605; FIG. 16B, 1615). The particular aspect ratio of a vertical cross section of the transformation area (e.g., radial extent along a material surface vs. depth into the material), and of the heated region in the vicinity of the transformation area, can depend on the intensity and/or duration of the irradiating energy on the target material. In some cases, the temperature of the target material can be greatest at the transformation area and penetrate into the target material, and can fall off (e.g., along a surface, e.g., FIG. 16B, 1629, or along the interior of the material or material bed, e.g., 1620) for the target material as distance increases from the transformation area. The reduction in temperature may be diffusion dependent. The reduction in temperature may be homogenous in space (e.g., throughout a material bed, or throughout a material). The reduction in temperature may be in a (e.g., substantially) radial geometry. For example, referring to the examples shown in FIGS. 16A and 16B, temperature can be greatest at the transforming position having a surface diameter d1, is relatively lower at an area distant from the transforming position (d2), and relatively lower still an area distant from the transforming position (at d3).

In some embodiments, a detector can be configured to follow (e.g., to have a view that follows) the processing (e.g., transformation) location of the directed energy beam (e.g., the detector and/or the detector view may be configured to move along with the point at which the energy beam is incident upon the target material). The detector may be synchronized with (e.g., track or follow) the transformation location, and/or a vicinity (e.g., immediate vicinity) of the transformation location. The detector may be synchronized with the center of the energy beam. The detector may be synchronized with a (e.g., predetermined) distance from the center of the energy beam. The synchronization of the detector with the energy beam may be during the operation of the energy beam or part of that operation. For example, the synchronization of the detector with the energy beam may be during a transformation of a material by the energy beam. For example, the synchronization of the detector with the energy beam may be during a translation of the energy beam along the target surface. The processing location may comprise a footprint of the energy beam on a target surface, a transformed portion that comprises the target surface, or a heated portion that comprises the target surface.

In some embodiments, an optical system includes a detector (e.g., FIG. 18, 1800) operable to (e.g., configured to) detect one or more characteristics of the target material and/or target surface. The detector can be operated continuously, or controlled to operate at selected intervals before, during, and/or after processing of the target material. The detector can be formed, for example, by a bundle of optical fibers operatively coupled with a radiation-sensitive detector or detectors. The detector can be adapted to detect a selected wavelength of radiation. The radiation may be an electromagnetic radiation. The wavelength of the electromagnetic radiation may comprise a wavelength in the ultraviolet band, visible band, or infrared (IR) band. According to some embodiments different detectors detect different wavelengths, respectively (e.g., a near-IR wavelength for a first radiation detector, and an IR wavelength for a second radiation detector). The bundle of fibers can be operable to receive radiation (e.g., wavelength) emitted from the target material. According to some embodiments, each fiber is connected to its own radiation detector, e.g., in a one-to-one ratio. In some embodiments, a plurality of fibers is collectively operatively coupled to a detector, e.g., depending on their spatial arrangement. For example, fibers that are disposed in a geometrical (e.g., circular, regular and/or irregular polygonal) arrangement may be collectively operatively coupled to a detector. Non-limiting examples of geometical arrangement include circular, ellipsoidal, annular, triangular, quadrilateral, pentagonal, hexagonal, heptagonal, octagonal, nonagonal, and decagonal. In some embodiments groups of arrangements (e.g., more than one circular geometry) can be coupled to one detector. In some embodiments mixtures of groups of geometrical arrangements (e.g., one or more triangular arrangements coupled with one or more hexagonal arrangements) can be coupled to one detector. Groups of arrangements coupled to one detector may be used for the detector to more readily detect a wavelength for which it is less sensitive (e.g., for electromagnetic wavelengths greater than 3000 nm). Longer electromagnetic wavelengths can be present for melting materials that have low melting points (e.g., such as aluminum, e.g., a material having a melting point at or below around 660° C.).

FIG. 18 shows an example of a multi-zone fiber bundle (e.g., 1800) in cross section. In the example of FIG. 18 a central fiber 1810 is surrounded by a first series of fibers (comprising fiber 1820) (e.g., arranged in an annular geometry), which first series of fibers is surrounded by a second series of fibers (comprising fiber 1830), which second series of fibers is surrounded by a third series of fibers (comprising fiber 1840). In some embodiments, the bundle of fibers can be arranged in a geometry, e.g., a circular arrangement (e.g., FIG. 18, 1805), or any geometrical arrangement (e.g., as disclosed herein). In some embodiments, the bundle of fibers can be arranged in an array. In some embodiments, the bundle of fibers can be arranged in a series of geometries (e.g., (i) circular, FIG. 18, 1815, (ii) hexagonal, FIG. 18, 1825, and/or (iii) pentagonal, FIG. 18, 1835). The series of geometries may be symmetric or asymmetric. The series of geometries may be concentric or non-concentric. The series of geometries may be inclusive (e.g., engulf one another). The series of geometries may form a series, which first series member geometry is included in a subsequent second series member geometry. The series of geometries may include disparate geometries (e.g., at least one geometry in the series is different from another geometry of the series). The series of geometries may be a series of concentric rings (e.g., FIG. 12). In the example of FIG. 18, a first ring (e.g., annular ring) is defined by the region between 1802 and 1804, and a second ring is defined by the region between 1804 and 1806. The size (e.g., cross sectional area) of the geometries can vary across the bundle of fibers. An inner portion of the bundle (e.g., FIG. 18, fiber 1810) can be adapted to facilitate detection of (i) a transforming area of, (ii) an actively irradiated area of, and/or (iii) a footprint of the energy beam on, the exposed surface of the target material. For example, the inner portion of the bundle can be positioned over the transforming area, the irradiated area, and/or the footprint of the energy beam on the exposed surface of the target material.

In some embodiments, the energy beam is operatively coupled to an optical system comprising one or more detectors. The returning energy beams may be directed by an optical system to the one or more detectors (e.g., FIG. 11, 1120, 1125, 1127). Each detector may detect a different wavelength range of the returning energy beams. Each detector may have a different gain pattern. The gain pattern of the detector may be susceptible to (e.g., respond to) a wavelength (e.g., range) of the energy beam that is directed to it. The gain pattern of the detector may be susceptible to an intensity of the energy beam that is directed to it. In some cases, at least one of the detectors can be a charge-coupled device (CCD) camera. At least one of the detectors can be a pyrometer and/or a bolometer. At least one of the detectors comprise an In GaAs and/or Gallium sensor. At times, the detector may be coupled to at least one optical fiber (e.g., a fiber coupled to a detector). At times, the detector may comprise a multiplicity of detectors. Each of the multiplicity of detectors may be coupled to a different optical fiber respectively. At times, an optical fiber may be coupled to a single detector. At times, at least two detectors may be coupled to an optical fiber. At times, at least two optical fibers may be coupled to a detector. The different optical fibers may form an optical fiber bundle. The optical fiber detector may comprise a magnifier and/or a de-magnifier coupled to a fiber. The optical fiber bundle may be a coherent bundle of fiber. The optical fiber may split to two or more detectors. The optical fiber detector may be positioned prior to the detector and after the optical element (e.g., filter, mirror, or beam splitter, whichever disposed before the optical fiber). At times, the detector may be a single (e.g., pixel) detector. The detector may be devoid of (e.g., not include, or exclude) spatial information.

FIGS. 16A and 16B (in plane view and an cross-sectional view, respectively) depict an example of a target material (e.g., a material bed) that comprises a transformation region (FIG. 16A, 1605; FIG. 16B 1615), a surrounding region (FIG. 16A, 1610; FIG. 16B, 1620) that experiences heat (e.g., via diffusion) from the transformation region (also referred to herein as a “heat affected zone”), and pre-transformed material (FIG. 16A, 1607; FIG. 16B, 1625) that is outside the heated surrounding region. FIG. 16A shows an example of a melt pool 1605 shown as a top view, having a diameter d1. The melt pool 1605 in the example shown in FIG. 16A, is surrounded by an area that is centered at the melt pool, and extends (for example) two melt pool diameters after the edge of the melt pool 1605, designated as d2 and d3, wherein d1, d2 and d3 are (e.g., substantially) equal. FIG. 16B shows an example of a vertical cross section in a material bed 1625 in which a melt pool 1615 is disposed, which melt pool 1615 has a diameter d1. The target material (e.g., material bed) 1625 shown in the example of FIG. 16B has an exposed surface (e.g., 1629). The area (e.g., 1620) surrounding the melt pool can extend beyond the melt pool. In the example of FIG. 16 the area 1620 extends away from the melt pool by (for example) two melt pool diameters d2 and d3, as measured from the edge of the melt pool 1615, wherein d1, d2 and d3 are (e.g., substantially) equal.

In some embodiments, different fiber groups within the fiber bundle sense different positions in the target surface. FIG. 12 shows an example of an optical fiber bundle (e.g., 1200). In some examples, the central fiber (e.g., 1210) may detect the (e.g., forming) melt pool, while closely surrounding fibers (e.g., 1220) detect positions in a ring around the melt pool (e.g., that is distanced d1 away from the center); more distant surrounding fibers (e.g., 1230) detect positions at a ring that is distanced d2 from the center etc. At least two (e.g., each of the) fibers within the fiber bundle may have different cross sections (e.g., diameters thereof). At least two fibers within the fiber bundle may have (e.g., substantially) the same cross section. For example, at least two fibers within a ring of fibers (e.g., surrounding the central fiber) may have different cross sections (e.g., diameters thereof). At least two fibers within a ring of fibers (e.g., surrounding the central fiber) may have (e.g., substantially) the same cross section.

In some embodiments, different fiber groups within the fiber bundle are directed to different detectors. For example, the central optical fiber (e.g., 1210) may be directed to a first detector. The first fiber ring (e.g., 1220) surrounding the central fiber may be directed to a second detector. The second fiber ring (e.g., 1230) surrounding the central fiber may be directed to a third detector. The third fiber ring (e.g., 1240) surrounding the central fiber may be directed to a fourth detector. The different detectors may form a group of detectors. At least two (e.g., each of the) detectors within the group of detectors may detect signals pertaining to different areas of the target surface respectively. For example, at least two (e.g., each of the) detectors within the group of detectors may detect signals pertaining to different distanced rings relative to the melt pool (e.g., center thereof) respectively. The different distanced rings relative to the melt pool can have different temperatures. Detectors within the fiber bundle can be sensitive to different wavelengths. The wavelength sensitivity of detectors in the fiber bundle can be implemented according to a predetermined pattern. For example, detectors near the central portion of the fiber bundle (e.g., FIG. 12, 1210) can be sensitive to relatively higher energy/shorter wavelength radiation, when compared with detectors coupled at more distal portions of the fiber bundle (e.g., at FIG. 12, 1220, 1230 or 1240) which can be sensitive to relatively lower energy/longer wavelength radiation. In some embodiments the detectors at progressively greater distances from a central region of the fiber bundle are sensitive to progressively longer wavelengths of radiation. The detectors may be connected to a control system that may control one or more 3D printing parameters. For example, the one or more detectors may be used to control the temperature at one or more positions in the material bed. The one or more detectors may be used to control the metrology (e.g., height) of at least one portion in the material bed (e.g., surface thereof). The control system may be any control system described herein. The control system may be any control system described in Provisional Patent Application Ser. No. 62/444,069, filed on Jan. 9, 2017, titled “ACCURATE THREE-DIMENSIONAL PRINTING,” that is incorporated herein by reference in its entirety.

One or more optical elements (e.g., lenses, FIG. 11, 1190, 1185, 1195) may be placed preceding the one or more detectors, and along the path of the returning energy beam. Optionally, there may be one or more filter elements (e.g., 1197, 1198, 1199, 1196) placed before each of the optical element. The optical element may maintain the focus of the detector energy beam (e.g., 1182, 1183) on each detector (e.g., simultaneously with maintaining the focus of the transforming energy beam on the target surface). The optical element may remain in a fixed position while maintaining the focus of the detector energy beam. The optical element may be movable (e.g., translatable) for maintaining the focus of the detector energy beam. The optical element can move (e.g., according to arrows next to 1185, 1190, 1195) before, during, and/or after processing of the target material. The optical element may alter a focus of the returning energy beam on each detector. At times, the optical element may maintain and/or alter an image size of one or more detected images (e.g., perform chromatic aberration and/or correction). At times, the optical element may synchronize one or more images from the imaging sensor.

At least one optical element may direct the irradiating energy to a scanner (e.g., X-Y scanner, galvanometer scanner). FIG. 11 shows an example in which three lenses (1165, 1145, and 1150) direct the irradiating energy 1172 to the scanner 1110. The scanner may be any scanner disclosed herein. The irradiating energy may be directed to one or more scanners. The scanner may direct the irradiating energy on to a position at the target surface. The energy beam may travel through one or more filters, apertures, or optical windows on its way to the target surface (e.g., as depicted in FIGS. 1 and 7).

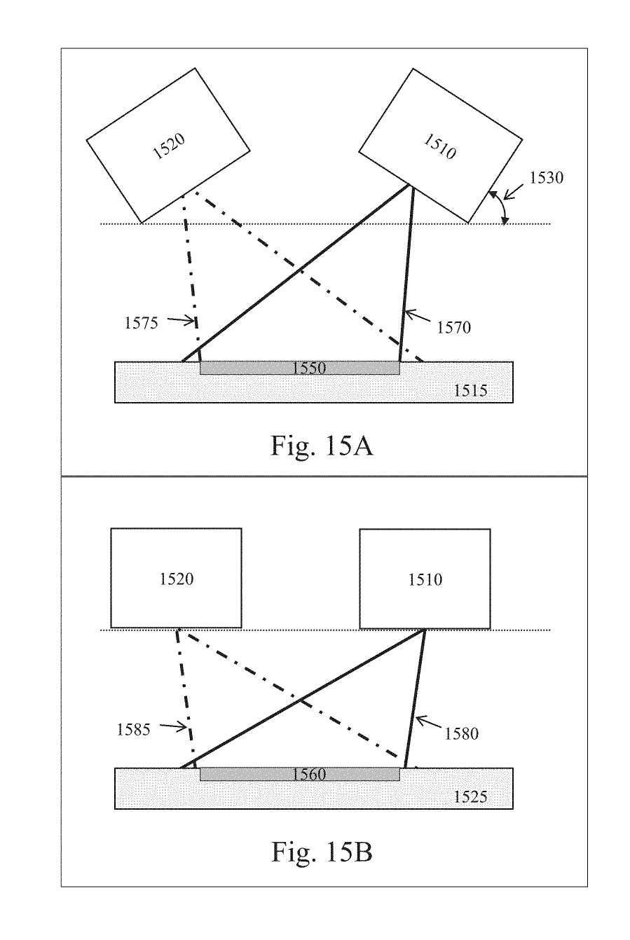

In some embodiments, a multiplicity of scanners directs a multiplicity of energy beams respectively to the target surface (e.g., to different positions of the target surface). The multiplicity of energy beams may be of different characteristics (e.g., large vs. small cross section) and/or functions (e.g., hatching vs. tiling) in the 3D printing process. The scanners may be controlled manually and/or by at least one controller. For example, at least two scanners may be directed by the same controller. For example, at least two scanners may be directed each by their own different controller. The multiplicity of controllers may be operatively coupled to each other. The multiplicity of energy beams may irradiate the surface simultaneously or sequentially. The multiplicity of energy beams may be directed towards the same position at the target surface, or to different positions at the target surface. The multiplicity of energy beams may comprise the energy flux, or scanning energy beam. The one or more scanners may be positioned at an angle (e.g., tilted) with respect to the material bed. The one or more sensors may be positioned perpendicular (e.g., at a normal) to the material bed. A portion of the enclosure, that is occupied by the energy beam (e.g., the energy flux or the scanning energy beam) can define a processing cone. FIG. 15A shows an example of two scanners (e.g., 1520, 1510) that are tilted at an angle 1530 with respect to the target surface 1515. The scanner may be positioned such that the processing cones of the scanners (e.g., FIG. 15A, 1575, 1570) may have a large overlap region (e.g., 1550) of potential irradiation of the target surface. Positioned may include angular position (e.g., 1530). In some embodiments one or more scanners may be positioned at a normal to the target surface (e.g., FIG. 15B, target surface 1525). In the example of FIG. 15B, the processing cones 1580 (e.g., of scanner 1510) and 1585 (e.g., of scanner 1520) are configured to overlap (e.g., 1560) via (e.g., control of) optical components of the scanners. The target surface may be the exposed surface of a material bed. Large may include covering a maximum number of positions on the target surface. Large may include covering all the positions on the target surface. Each position on the target surface may receive exposure from each of the scanners. At times, the target surface may be translated to achieve a desired exposure from each of the scanners. The scanners may comprise high conductivity and/or high reflectivity mirrors (e.g., sapphire mirrors, beryllium mirrors, e.g., as disclosed herein).

A controller may be operatively coupled to at least one component of the detection system. The controller may control the amount of translation of the variable focus system. The controller may adjust the position of the optical elements to vary the cross-section of the transforming beam. The controller may adjust the position of the optical elements to vary a footprint of the transforming beam and/or its focus on the target surface. The controller may direct the one or more filters of the optical system to activate or de-activate. Activating or de-activating a filter may allow a specific type of energy beam (e.g., beam of a certain wavelength region) to radiate. The controller may adjust at least one characteristic of the irradiating energy (e.g., as disclosed herein). For example, the controller may adjust the power density and/or fluence of the energy beam. Adjustments by the controller may be static (e.g., not in real-time). Adjustments by the controller may be dynamic (e.g., in real-time). Static adjustments may be done before or after 3D printing. Dynamic adjustments may be done during at least a portion of the 3D printing (e.g., during transformation of the pre-transformed material). At times, static adjustments may be done before and/or after an optical detection. At times, dynamic adjustments may be done during optical detection.

FIG. 12 shows an example of an optical fiber bundle (e.g., 1200). The optical fiber bundle may include one or more single (e.g., pixel) detectors. Each pixel detector may be optionally coupled to an optical fiber. The optical fiber bundle may comprise a central fiber (e.g., 1210). One or more independent single detectors (e.g., at least 1, 2, 3, 4, 5, 6, 7, 8, 9 or 10 detectors) coupled to one or more independent optical fibers (e.g., at least 1, 2, 3, 4, 5, 6, 7, 8, 9 or 10 optical fibers) respectively may be disposed adjacent to the central fiber. For example, the one or more independent optical fibers may engulf (e.g., surround) the central fiber. The number of independent optical fibers that engulf the central fiber may vary (e.g., the central fiber may be engulfed by at least 1, 2, 3, 4, 5, 6, 7, 8, 9 or 10 optical fibers). The engulfed optical fibers may be engulfed by one or more independent optical fibers (e.g., the first one or more independent fibers adjacent to the central fiber may be engulfed by at least 1, 2, 3, 4, 5, 6, 7, 8, 9 or 10 optical fibers). Engulf may be in at least one cross-sectional circular arrangement (e.g., FIG. 12). In some embodiments, the optical fiber bundle comprises (i) another optical fiber that has a cross section that is (e.g., substantially) the same as the cross section of the central optical fiber, or (ii) another optical fiber that has a cross section that is different (e.g., smaller, or larger) from the cross section of the central optical fiber. In some embodiments, the one or more independent optical fibers have a cross section that is (e.g., substantially) the same (e.g., 1220) as the cross section of the central optical fiber (e.g., 1210). In some embodiments, the one or more independent optical fibers have a cross section that is different than the cross section of the central optical fiber. For example, the one or more independent optical fibers may have a cross section that is larger (e.g., 1230, 1240) than the cross section of the central optical fiber (e.g., 1210). The larger cross section of the optical fiber may facilitate detection of a returning energy beam striking a larger cross section of the optical fiber, and thus allowing for detection of a lower intensity energy beam. The adjacent one or more single detectors may allow detection of energy beam that strikes an area larger than the area detected by the central fiber. For example, the outermost single detector (e.g., 1240) may detect (e.g., collect irradiation from) an area that is larger than the area detected by the central fiber. Larger may comprise at least about 2, 3, 5, 10, 20, 25, 30, 35, 40, 45, 50, 55, 60, 65, 70, 75, 80, 85, 90, 95 or 100 times larger area than the area detected by the central fiber. Larger may comprise at most about 2, 3, 5, 10, 20, 25, 30, 35, 40, 45, 50, 55, 60, 65, 70, 75, 80, 85, 90, 95 or 100 times larger area than the area detected by the central fiber. The outermost single detector may detect an area larger than the area detected by the central fiber, wherein larger can be between any of the afore-mentioned values (e.g., 2 times to 100 times, from about 2 times to about 30 times, from about 35 times to about 70 times, or from about 75 times to about 100 times). The central fiber may detect a pixel at its highest resolution. As the detection area increases amongst the surrounding single detectors, the surrounding fiber may detect one or more lower resolution pixels. The at least one optical fiber in the bundle may be aligned with the portion of the energy beam that has the strongest signal intensity (e.g., radiation energy). The one optical fiber can be aligned (e.g., in real time) to be the central optical fiber. As the detection area of the fiber detectors increase, the signal intensity may drop. The increasing area of the detector may allow improvement of the signal (e.g., as the signal to noise ratio decreases). The fiber bundle may allow maximizing the collection rate of (e.g., optical) information (e.g., by selecting a sample of optical fiber detectors, by varying the sampling frequency of the detectors). The optical fiber bundle may be a lower cost alternative to thermal imaging detectors (e.g., In GaAs or Ge). The optical fiber bundle (e.g., having varied cross sectional optical fibers), may allow quicker focusing and/or signal detection.

The detector may be any detector disclosed in patent application number PCT/US15/65297, titled “FEEDBACK CONTROL SYSTEMS FOR THREE-DIMENSIONAL PRINTING” that was filed on Dec. 11, 2015, which is incorporated herein by reference in its entirety. The detectors can comprise the sensors. The detectors (e.g., sensors) can be configured to measure one or more properties of the 3D object and/or the pre-transformed material (e.g., powder). The detectors can collect one or more signals from the 3D object and/or the target surface (e.g., by using the returning energy beams). In some cases, the detectors can collect signals from one or more optical sensors (e.g., as disclosed herein). The detectors can collect signals from one or more vision sensors (e.g. camera), thermal sensors, acoustic sensors, vibration sensors, spectroscopic sensor, radar sensors, and/or motion sensors. The optical sensor may include an analogue device (e.g., CCD). The optical sensor may include a p-doped metal-oxide-semiconductor (MOS) capacitor, charge-coupled device (CCD), active-pixel sensor (APS), micro/nano-electro-mechanical-system (MEMS/NEMS) based sensor, or any combination thereof. The APS may be a complementary MOS (CMOS) sensor. The MEMS/NEMS sensor may include a MEMS/NEMS inertial sensor. The MEMS/NEMS sensor may be based on silicon, polymer, metal, ceramics, or any combination thereof. The detector (e.g., optical detector) may be coupled to an optical fiber.

The detector may include a temperature sensor. The temperature sensor (e.g., thermal sensor) may sense a IR radiation (e.g., photons). The thermal sensor may sense a temperature of at least one melt pool. The metrology sensor may comprise a sensor that measures the FLS (e.g., depth) of at least one melt pool. The transforming energy beam and the detector energy beam (e.g., thermal sensor beam and/or metrology sensor energy beam) may be focused on substantially the same position. The transforming energy beam and the detector energy beam (e.g., thermal sensor beam and/or metrology sensor energy beam) may be confocal.

The detector may include an imaging sensor. The imaging sensor can image a surface of the target surface comprising untransformed material (e.g., pre-transformed material) and at least a portion of the 3D object. The imaging sensor may be coupled to an optical fiber. The imaging sensor can image (e.g. using the returning energy beam) a portion of the target surface comprising transforming material (e.g., one or more melt pools and/or its vicinity). The optical filter or CCD can allow transmission of background lighting at a predetermined wavelength or within a range of wavelengths.

The detector may include a reflectivity sensor. The reflectivity sensor may include an imaging component. The reflectivity sensor can image the material surface at variable heights and/or angles relative to the surface (e.g., the material surface). In some cases, reflectivity measurements can be processed to distinguish between the exposed surface of the material bed and a surface of the 3D object. For example, the untransformed material (e.g., pre-transformed material) in the target surface can be a diffuse reflector and the 3D object (or a melt pool, a melt pool keyhole) can be a specular reflector. Images from the detectors can be processed to determine topography, roughness, and/or reflectivity of the surface comprising the untransformed material (e.g., pre-transformed material) and the 3D object. The detector may be used to perform thermal analysis of a meltpool and/or its vicinity (e.g., detecting keyhole, balling and/or spatter formation). The surface can be sensed (e.g., measured) with dark-field and/or bright field illumination and a map and/or image of the illumination can be generated from signals detected during the dark-field and/or bright field illumination. The maps from the dark-field and/or bright field illumination can be compared to characterize the target surface (e.g., of the material bed and/or of the 3D object). For example, surface roughness can be determined from a comparison of dark-field and/or bright field detection measurements. In some cases, analyzing the signals can include polarization analysis of reflected or scattered light signals.

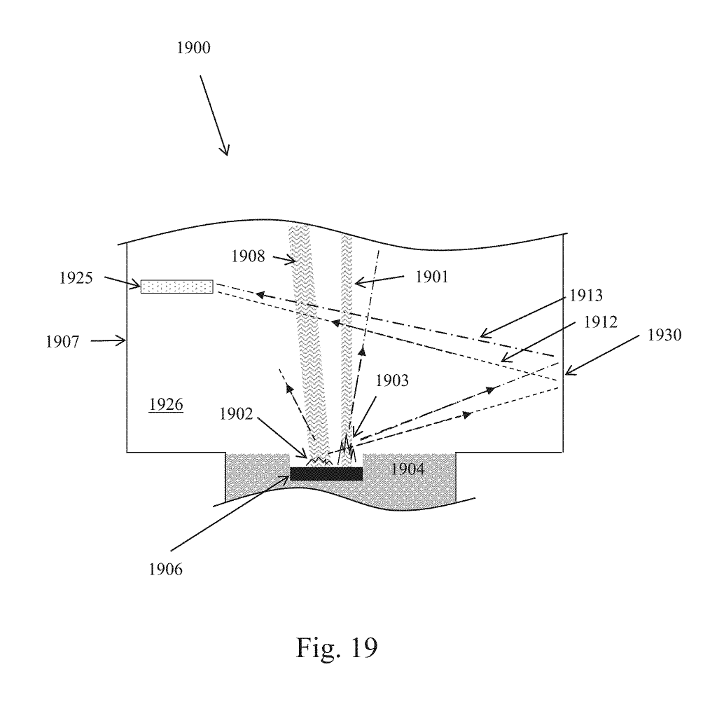

In some embodiments, measurements are made by a detector system (e.g., optical system) having an indirect view (e.g., devoid of a direct view) of one or more of (i) a target surface, (ii) a processing beam (e.g., a transforming energy beam or a scanning energy beam), (iii) a processing area (e.g., a position where an irradiating energy beam is incident on a surface), and/or (iv) a portion of a forming 3D object. In some embodiments, the indirect measurements can measure reflection of energy (e.g., light) from a surface of the enclosure and/or a species (e.g., particles, gas, and/or plasma) within the enclosure. The detector system can comprise one or more detectors. Measurements can be taken before, during and/or after processing (e.g., transforming) one or more materials. In some embodiments one or more measurements can be taken before processing of a material (e.g., of a background level of radiation in an enclosure), which one or more measurements can be used as a baseline measurement against which subsequent measurements are compared (e.g., measurements of radiation levels in an enclosure during processing). A detector can comprise one or more sensors (e.g., one or more photodiode((s)) and/or cameras (e.g., CCD, IR) as described herein. The detector(s) can detect an intensity of illumination (e.g., electromagnetic radiation)) that is reflected (e.g., off the target surface). A detector that that detects indirect energy (e.g., light) of a process or processing surface is referred to herein a “gray field detector.” An indirect measurement as described herein can be measurement of illumination that that are not (e.g., directly) emanating from a transformation region (e.g., a melt pool)) during a transformation process. The detector systems can comprise one or more filters (e.g., a high pass filter, a low pass filter, a notch filter, a bandpass filter, and/or a multibandpass filter). As non-limiting examples, the detector(s) can comprise (i) a UV bandpass filter, (ii) an IR bandpass filter, and/or (iii) a near-IR bandpass filter. The filter can be operable to reject electromagnetic wavelengths that correspond to illumination wavelengths that emanate from a transformation region of a target material (such as a melt pool) or from a vicinity thereof (e.g., an immediate vicinity thereof). Processing of measurements (e.g., generated by a gray field detector) can distinguish any (e.g., at least one) of characteristics as described herein, for example, a topography, roughness, and/or reflectivity of one or more materials (e.g., of pre-transformed material, transformed material, target surface, and/or target material). Such measurements can be processed to provide feedback (e.g., to a control system) regarding a processing state. For example, that a target surface is undergoing an intense and/or abrupt transformation, an intense temperature change, or any combination thereof. For example, that a chamber environment is undergoing an intense and/or abrupt temperature change For example, that a target surface is undergoing a welding transformation, (e.g., intense and/or abrupt) splatter, (e.g., substantial and/or abrupt) temperature change, and/or that a target surface is undergoing keyhole formation. At least one element of the detector system may be controlled manually and/or automatically (e.g., using a controller). The control may be before, after, and/or during the operation of the energy beam. Controlling can be before, during, or after processing of the one or more materials. At times, measurements from a first detector system (e.g., the system of FIG. 19, 1900) can be correlated with measurements of a second detector system (e.g., the system of FIG. 11, 1000) to determine at least one characteristic of, for example, the (i) a target material surface, (ii) a processing beam (e.g., a transforming energy beam or a scanning energy beam), (iii) a processing area (e.g., a position where an irradiating energy beam is incident on a surface), and/or (iv) a portion of a forming 3D object.

In some cases, one or more of the detectors can be movable. For example, the one or more detectors can be movable along a plane that is parallel to the target surface (e.g., to the exposed surface of the material bed. The one or more detectors can be movable horizontally, vertically, and/or in an angle (e.g., planar or compound). The one or more detectors can be movable along a plane that is parallel to a surface of the target surface. The one or more detectors can be movable along an axis this is orthogonal to the target surface and/or a surface of the material bed. The one or more detectors can be translated, rotated, and/or tilted at an angle (e.g., planar or compound) before, after, and/or during at least a portion of the 3D printing.

The one or more detectors can be disposed within the enclosure, outside the enclosure, within the structure of the enclosure (e.g., within a wall of the enclosure), or any combination thereof. The one or more detectors can be oriented in a location such that the detector can receive one or more signals in the field of view of the detector. A viewing angle and/or field of view of at least one of the one or more detectors can be maneuverable via a scanner. In some cases, the viewing angle and/or field of view can be maneuverable relative to an energy beam that is employed to additively generate the 3D object. In some cases, the variable focus mechanism may synchronize the movement of the transforming energy beam to be within the range of the detectors that may be detecting the detecting energy beam. In some cases, movement (e.g., scanning) of the energy beam and maneuvering of the viewing angle and/or field of view of one or more detectors can be synchronized.

A controller may receive signals from the detector. The controller may be a part of a high-speed computing environment. The computing environment may be any computing environment described herein. The computing environment may be any computer and/or processor described herein. The controller may control (e.g., alter, adjust) the parameters of the components of the 3D printer (e.g., before, after, and/or during at least a portion of the 3D printing). The control (e.g., open loop control) may comprise a calculation. The control may comprise using an algorithm. The control may comprise feedback loop control. In some examples, the control may comprise at least two of (i) open loop (e.g., empirical calculations), and (ii) closed loop (e.g., feed forward and/or feed back loop) control. In some examples, the feedback loop(s) control comprises one or more comparisons with an input parameter (e.g., 1010) and/or threshold value (e.g., 1080). The setpoint may comprise calculated (e.g., predicted) setpoint value. The setpoint may comprise adjustment according to the closed loop and/or feedback control. The controller may use metrological and/or temperature measurements of at least one position of the target surface (e.g., melt pool). The controller may use porosity and/or roughness measurements (e.g., of the layer of hardened material). The controller may direct adjustment of one or more systems and/or apparatuses in the 3D printing system. For example, the controller may direct adjustment of the force exerted by the material removal mechanism (e.g., force of vacuum suction). For example, the controller may direct adjustment of a spot size and/or focus of a detected energy beam by adjusting the optical elements.

FIG. 19 shows an example of an optical detection system 1900 having a (e.g., gray field) detector 1925 housed within an enclosure 1926 of a chamber 1907. One or more energy beams (e.g., 1908 and/or 1901) can be incident on and interact with a target surface (e.g., a hardened material (e.g., 1906) and/or pre-transformed material of a material bed (e.g., 1904). The interactions can cause one or more characteristics of a radiative emission. For example, the transformation can cause chemical and/or physical changes in a pre-transformed material as it transitions to a transformed material that can cause corresponding radiative emissions (e.g., IR, visual, and/or UV radiation). In the example of FIG. 19, radiative emission 1902 is generated from the interaction of the energy beam 1908 with the target surface, and radiative emission 1903 is generated from the interaction of the scanning energy beam 1901 with the target surface. The radiative emission can be a result of any suitable interaction (e.g., chemical reaction, and/or physical reaction comprising reflection, refraction, or diffraction) with the target surface. Indirect radiative emissions can result from radiative emission (e.g., 1902 and/or 1903) interacting with a surface that is not the target surface. For example, indirect radiation (e.g., 1902 and/or 1903) can scatter (e.g., reflect, refract, and/or diffract) from a wall (e.g., wall of chamber 1907) 1930 of the enclosure, forming indirect radiation beams (e.g., 1912 and 1913, respectively). The indirect radiation beams cancan be incident on and detected by a (e.g., gray field) detector (e.g., 1925).

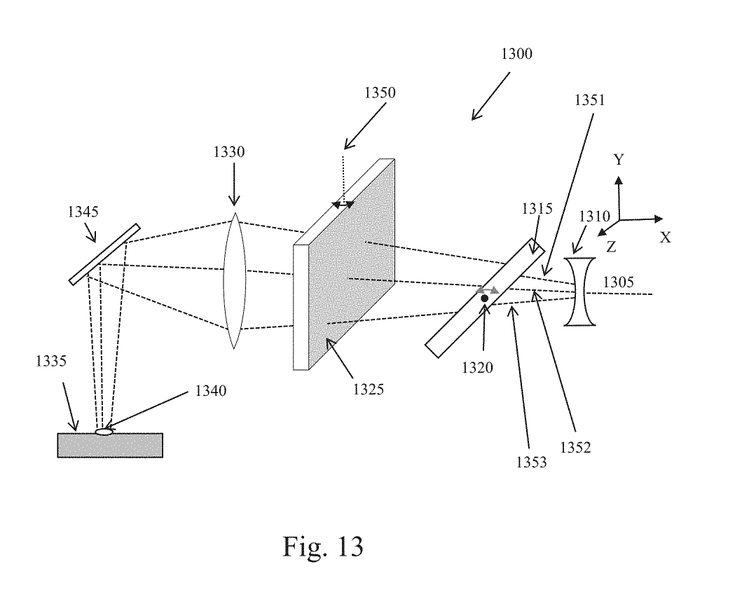

An astigmatism system (e.g., FIG. 13, 1300) may be coupled to the 3D printer. The astigmatism system may be disposed adjacent (e.g., in, or outside of) the processing chamber in which the irradiated beam generates the 3D object (e.g., FIG. 1, 126). The astigmatism system may be operatively coupled to an energy source, and/or to a controller. At least one element of the astigmatism system may be controlled before, after, and/or during at least a portion of the 3D printing (e.g., in real time). At least one element of the astigmatism system may be controlled manually and/or automatically (e.g., using a controller). The energy source may irradiate energy (e.g., FIG. 13, 1305 depicting an energy beam). The astigmatism system may be used to form an elongated cross-sectional beam (e.g., narrow, and/or long, FIG. 13, 1340) that irradiates the target surface (e.g., 1335). The energy beam may be elongated along the X-Y plane (e.g., FIG. 13). At times, the footprint of the energy beam may be elongated by an energy beam perforation (e.g., an elongated slit) that the energy beam may be allowed to pass through. At times, the movement of the energy beam may be controlled to perform a scan or a retro scan to form an elongated energy beam footprint.

In some embodiments, the astigmatism system includes two or more optical elements (e.g., lenses, FIG. 13,1310, 1330). The optical elements may diverge or converge an irradiating energy (e.g., beam) that travels therethrough. The optical elements may have a constant focus. The optical elements may have a variable focus. At times, the optical element may converge the rays of the energy beam. At times, the optical element may diverge the rays of the energy beam. For example, the first optical element may be a diverging lens. The astigmatism system may comprise one or more medias (e.g., 1315, 1325). The medium may have a high refractive index (e.g., a high refractive index relative to the wavelength of the incoming energy beam). At least one medium may be stationary or translating or rotating (e.g., rotating along an axis, FIG. 13, 1320, 1350). Translating and/or rotating may be performed before, after, or during at least a portion of the 3D printing. The first medium may translate and/or rotate along a different axis than the second medium. The translating axes of the mediums may be different than (e.g., perpendicular to) the traveling axis of the irradiating energy. For example, the first medium (e.g., 1315) may translate and/or rotate along the Z axis (e.g., 1320), the second medium (e.g., 1325) may translate and/or rotate along the Y axis (e.g., 1350), and the irradiating energy (e.g., 1305) may travel along the X axis. The distance between the media may be such that they do not collide with each other when translating and/or rotating (e.g., when both media are rotating simultaneously). The irradiating energy may be directed to the second medium after it emerges from the first medium. The first optical element (e.g., 1310) may direct the energy beam to a medium (e.g., an optical window, e.g., 1315). The medium may (e.g., substantially) allow the energy beam to pass through (e.g., may not absorb a substantial portion of the passing energy beam). Substantially may be relative to the intended purpose of the energy beam (e.g., to transform the pre-transformed material).

In some embodiments, the optical astigmatism of the irradiating energy refers to an elliptical cross section of the irradiating energy that differs from a circle. Without wishing to be bound to theory, the different paths (e.g., lengths thereof) of the various irradiating energy rays (e.g., 1351-1353), interacting with various thicknesses of the media (having an effective refractive index), may lead to an elongated cross section of the irradiating energy, and subsequently to an elongated footprint of the irradiating energy on the target surface. The relative position of the first media (e.g., optical window) and the second media may lead to an optical astigmatism. The degree and/or direction of the astigmatism may vary (e.g., before, after, and/or during at least a portion of the 3D printing) in relation to the relative positioning of the two media. The degree and/or direction of the astigmatism may due to the relative positioning of the two media. The angular position of the media may be controlled (e.g., manually, and/or automatically). For example, the angular position of the media may be controlled by one or more controllers. Controlling may include altering the angular position of the media relative to each other. Controlling may include altering the angular position not relative to each other (e.g., relative to the target surface and/or to the energy source). Controlling the degree of astigmatism may lead to controlling the length and/or width of the irradiating energy on the target surface. The irradiating energy may be directed to a second optical element (e.g., FIG. 13, 1330) from the (e.g., first or second) medium. The second optical element may be a converging lens. The converging lens may focus the irradiating energy after its emergence from the (e.g., first or second) medium. The converging lens may translatable (e.g., to vary the focus). The focusing power of the lens (e.g., converging lens) may be variable (e.g., electronically, magnetically, or thermically). The second optical element may be placed after the (e.g., first or second) medium. The energy beam may be directed (e.g., converged) on to a reflective element (e.g., mirror, FIG. 13, 1345) and/or a scanner. The energy beam may be directed (e.g., converged) on to a beam directing element. The beam directing (e.g., reflective) element may be translatable. The beam directing element may direct the energy beam to the target surface (e.g., material bed, FIG. 13, 1335). The directed energy beam may be an elongated energy beam. The mirror may be highly reflective mirror (e.g., Beryllium mirror).

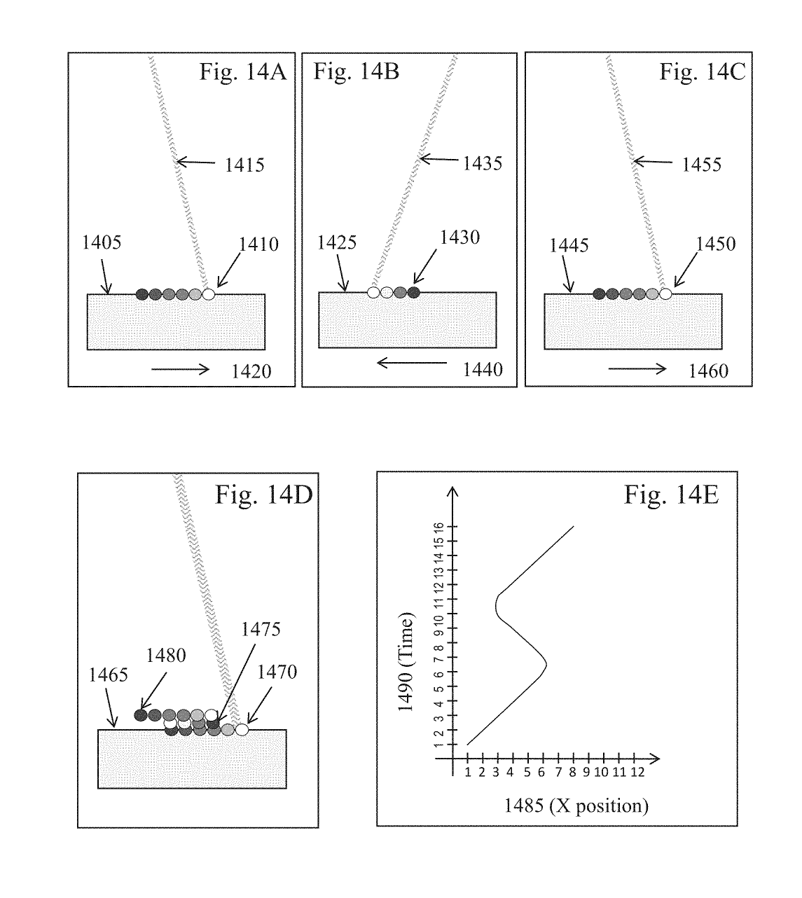

FIGS. 14A-14E illustrate an example of retro scan. A retro scan may include moving the irradiating energy back and forth in the same general plane (e.g., of the target surface) along a path. Moving the irradiating energy may include moving one or more steps in the forward direction. The steps may be continuous (e.g., and the steps may be arbitrary for the sake of illustration). The steps may be isolated. For example, the steps may be tiles (e.g., overlapping or non-overlapping tiles). For example, FIG. 14A illustrates an example of moving the irradiating energy (e.g., 1415) six steps (e.g., 1410) in a forward direction (e.g., 1420) on the target surface (e.g., 1405) along a line. FIG. 14B illustrates an example of moving the irradiating energy (e.g., 1435) four steps (e.g., 1430) in a backward direction (e.g., 1440) on the target surface (e.g., 1425) along the line. FIG. 14C illustrates an example of moving the irradiating energy beam (e.g., 1455) six steps (e.g., 1450) in the forward direction (e.g., 1460), on the target surface (e.g., 1445) along the line. In the retro scan procedure, the operation illustrated in FIG. 14A is executed, followed by the operation illustrated in FIG. 14B, which is subsequently followed by the operation in FIG. 14C. Moving the irradiating energy may include moving one or more steps selected from (i) moving in a forward direction to form a first forward path, (ii) irradiating to at least partially overlap the first forward path in a backwards direction to form a backwards path, and (iii) irradiating to at least partially overlap the backwards path in a forward direction. Operations (i) to (iii) can be conducted sequentially. In some embodiments, the backwards path overlaps the first forward path in part. In some embodiments, the second forward path overlaps the backwards path in part. Moving the energy beam may include overall moving in the forward direction (e.g., two steps forward and one step backward). For example, when the non-overlapping second forward path exceeds the first forward path in the direction of forward movement (e.g., difference between positions 7-8 on the target surface irradiated at time 15-16, and position 6 on the target surface irradiated at time 6, in FIG. 14E). For example, FIG. 14D illustrates an example of moving the energy beam in three iterations, which circles (e.g., 1480) show an expansion of the superposition of irradiated positions on the target surface 1465. In the first iteration, the energy beam moves six steps in the forward direction (e.g., 1480). In the second iteration, the energy beam moves four steps in the backward direction (e.g., 1475) from the previous iteration. In the third step, the energy beam moves six steps in the forward direction (e.g., 1470) from the earlier iteration, thus overall moving eight steps in the forward direction on the target surface (e.g., 1425). In the illustrated example, the earliest irradiation position (e.g. first step) is indicated by the darkest gray circle. The shades of gray are lightened to indicate the subsequent steps (from the earliest to the most recent irradiated position, e.g., step two to step six) in the iteration, and the last irradiation position is indicated by a white circle. FIG. 14E illustrates the graphical representation of the retro scan, wherein the graphical representation illustrates the position of the irradiating energy on the target surface (e.g., 1485) as time (e.g., 1490) progresses. The retro scan may be performed with irradiating energy (e.g., beam or flux) having an elliptical (e.g., circular) cross section. The retro scan may be performed with irradiating energy (e.g., beam or flux) having an oval (e.g., Cartesian oval) cross section. The retro scan may be performed continuously (e.g., during the 3D printing transformation operation, or a portion thereof). The retro scan may be performed during printing of the 3D object. The movement of the energy beam may be controlled statically (e.g., before or after printing of the 3D object). The movement of the energy beam may be controlled dynamically (e.g., during printing of the 3D object). The elongated energy beam may be superimposed by an oscillating signal (e.g., electronic signal). The oscillating signal may be generated by a scanner. The oscillating signal may further oscillate the retro scan movement to generate an elongated energy beam. The retro scan can be performed with any cross section of the irradiating energy (e.g., transforming energy) disclosed herein. For example, the retro scan can be performed using a circular cross section (e.g., focused, defocused; having small or large FLS), or an elliptical cross section (e.g., using the astigmatism mechanism).

One or more sensors (at least one sensor) can detect the topology of the exposed surface of the material bed and/or the exposed surface of the 3D object or any part thereof. The sensor can detect the amount of material deposited in the material bed. The sensor can be a proximity sensor. For example, the sensor can detect the amount of powder material deposited on the exposes surface of a powder bed. The sensor can detect the physical state of material deposited on the target surface (e.g., liquid, or solid (e.g., powder or bulk)). The sensor can detect the crystallinity of material deposited on the target surface. The sensor can detect the amount of material transferred by the material dispensing mechanism. The sensor can detect the amount of material relocated by a leveling mechanism. The sensor can detect the temperature of the material. For example, the sensor may detect the temperature of the material in a material (e.g., powder) dispensing mechanism, and/or in the material bed. The sensor may detect the temperature of the material during and/or after its transformation. The sensor may detect the temperature and/or pressure of the atmosphere within an enclosure (e.g., chamber). The sensor may detect the temperature of the material (e.g., powder) bed at one or more locations.

The at least one sensor can be operatively coupled to a control system (e.g., computer control system). The sensor may comprise a light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may include a temperature sensor, weight sensor, material (e.g., powder) level sensor, metrology sensor, gas sensor, or humidity sensor. The metrology sensor may comprise a measurement sensor (e.g., height, length, width, angle, and/or volume). The metrology sensor may comprise a magnetic, acceleration, orientation, or optical sensor. The sensor may transmit and/or receive a sound (e.g., echo), magnetic, electronic, or electromagnetic signal. The electromagnetic signal may comprise a visible, infrared, ultraviolet, ultrasound, radio wave, or microwave signal. The metrology sensor may measure the tile. The metrology sensor may measure the gap. The metrology sensor may measure at least a portion of the layer of material. The layer of material may be a pre-transformed material (e.g., powder), transformed material, or hardened material. The metrology sensor may measure at least a portion of the 3D object. The gas sensor may sense any of the gas delineated herein. The distance sensor can be a type of metrology sensor. The distance sensor may comprise an optical sensor, or capacitance sensor. The temperature sensor can comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may comprise a camera (e.g., IR camera, CCD camera). The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensors, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The weight of the material bed can be monitored by one or more weight sensors in, or adjacent to, the material. For example, a weight sensor in the material bed can be at the bottom of the material bed. The weight sensor can be between the bottom of the enclosure (e.g., FIG. 1, 111) and the substrate (e.g., FIG. 1, 109) on which the base (e.g., FIG. 1, 102) or the material bed (e.g., FIG. 1, 104) may be disposed. The weight sensor can be between the bottom of the enclosure and the base on which the material bed may be disposed. The weight sensor can be between the bottom of the enclosure and the material bed. A weight sensor can comprise a pressure sensor. The weight sensor may comprise a spring scale, a hydraulic scale, a pneumatic scale, or a balance. At least a portion of the pressure sensor can be exposed on a bottom surface of the material bed. In some cases, the weight sensor can comprise a button load cell. The button load cell can sense pressure from powder adjacent to the load cell. In another example, one or more sensors (e.g., optical sensors or optical level sensors) can be provided adjacent to the material bed such as above, below, or to the side of the material bed. In some examples, the one or more sensors can sense the powder level. The material (e.g., powder) level sensor can be in communication with a material dispensing mechanism (e.g., powder dispenser). Alternatively, or additionally a sensor can be configured to monitor the weight of the material bed by monitoring a weight of a structure that contains the material bed. One or more position sensors (e.g., height sensors) can measure the height of the material bed relative to the substrate. The position sensors can be optical sensors. The position sensors can determine a distance between one or more energy beams (e.g., a laser or an electron beam.) and a surface of the material (e.g., powder). The one or more sensors may be connected to a control system (e.g., to a processor, to a computer).

The systems and/or apparatuses disclosed herein may comprise one or more motors. The motors may comprise servomotors. The servomotors may comprise actuated linear lead screw drive motors. The motors may comprise belt drive motors. The motors may comprise rotary encoders. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators. The systems and/or apparatuses disclosed herein may comprise one or more pistons.

The exit opening of the material dispenser can comprise a mesh or a plane with holes (collectively referred to herein as “mesh”). The mesh comprises a hole (or an array of holes). The hole (or holes) can allow the material to exit the material dispenser. The hole (e.g., opening can have a FLS of at least about 0.001 mm, 0.01 mm, 0.03 mm, 0.05 mm, 0.07 mm, 0.09 mm, 0.1 mm, 1 mm, 2 mm, 3 mm, 4 mm, 5 mm, or 10 mm. The hole can have a FLS of at most about 0.001 mm, 0.01 mm, 0.03 mm, 0.05 mm, 0.07 mm, 0.09 mm, 0.1 mm, 1 mm, 2 mm, 3 mm, 4 mm, 5 mm, or 10 mm. The hole can have a FLS between any of the aforementioned values (e.g., from about 0.001 mm to about 10 mm, or from 0.1 mm to about 5 mm). In some embodiments, the hole can have a FLS of at least about 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm 950, μm, or 1000 μm. The hole in the mesh can have a FLS of at most about 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm 950, μm, or 1000 μm. The hole in the mesh can have a FLS of any value between the afore-mentioned fundamental length scales (e.g., from about 30 μm to about 1000 μm, from about 10 μm to about 600 μm, from about 500 μm to about 1000 μm, or from about 50 μm to about 300 μm). The FLS of the holes may be adjustable or fixed. In some embodiments, the opening comprises two or more meshes. At least one of the two or more meshes may be movable. The movement of the two or more meshes may be controlled manually or automatically (e.g., by a controller). The relative position of the two or more meshes with respect to each other may determine the rate at which the material passes through the hole (or holes). The FLS of the holes may be electrically controlled. The fundamental length scale of the holes may be thermally controlled. The mesh may be heated or cooled. The may vibrate (e.g., controllably vibrate). The temperature and/or vibration of the mesh may be controlled manually or by the controller. The holes of the mesh can shrink or expand as a function of the temperature and/or electrical charge of the mesh. The mesh can be conductive. The mesh may comprise a mesh of standard mesh number 50, 70, 90, 100, 120, 140, 170, 200, 230, 270, 325, 550, or 625. The mesh may comprise a mesh of standard mesh number between any of the aforementioned mesh numbers (e.g., from 50 to 625, from 50 to 230, from 230 to 625, or from 100 to 325). The standard mesh number may be US or Tyler standards. The two meshes may have at least one position where no material can pass through the exit opening. The two meshes may have a least one position where a maximum amount of material can pass through the exit opening. The two meshes can be identical or different. The size of the holes in the two meshes can be identical or different. The shape of the holes in the two meshes can be identical or different. The shape of the holes can be any hole shape described herein.

The methods described herein may comprise vibrating at least part of the material, or at least part of the material dispensing mechanism. The at least part of the material dispensing mechanism may comprise vibrating at least part of the exit opening of the material dispensing mechanism. The method may comprise vibrating the material in the material bed to level the top surface of the material bed. The method may comprise vibrating the enclosure, the substrate, the base, the container that accommodates the material bed, or any combination thereof, to level the material (e.g., at the top surface of the material bed). The vibrations may be ultrasonic vibrations. The leveling may be able to level the top surface of the material with a deviation from the average plane created by the top surface. The deviation from the average plane may be of any deviation from average plane value disclosed herein. The material dispensing method may utilize any of the material dispensing mechanism described herein. The material dispensing method may utilize gravitational force, and/or one that uses gas flow (e.g., airflow).

In some examples, the pressure system includes one or more pumps. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump, or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valveless pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump.

The systems, apparatuses, and/or methods described herein can comprise a material recycling mechanism. The recycling mechanism can collect unused pre-transformed material and return the unused pre-transformed material to a reservoir of a material dispensing mechanism (e.g., the material dispensing reservoir), or to the bulk reservoir that feeds the material dispensing mechanism. Unused pre-transformed material may be material that was not used to form at least a portion of the 3D object. At least a fraction of the pre-transformed material removed from the material bed by the leveling mechanism and/or material removal mechanism can be recovered by the recycling system. At least a fraction of the material within the material bed that did not transform to subsequently form the 3D object can be recovered by the recycling system. A vacuum nozzle (e.g., which can be located at an edge of the material bed) can collect unused pre-transformed material. Unused pre-transformed material can be removed from the material bed without vacuum. Unused pre-transformed (e.g., powder) material can be removed from the material bed manually. Unused pre-transformed material can be removed from the material bed by positive pressure (e.g., by blowing away the unused material). Unused pre-transformed material can be removed from the material bed by actively pushing it from the material bed (e.g., mechanically or using a positive pressurized gas). A gas flow can direct unused pre-transformed material to the vacuum nozzle. A material collecting mechanism (e.g., a shovel) can direct unused material to exit the material bed (and optionally enter the recycling mechanism). The recycling mechanism can comprise one or more filters to control a size range of the particles returned to the reservoir. In some cases, a Venturi scavenging nozzle can collect unused material. The nozzle can have a high aspect ratio (e.g., at least about 2:1, 5:1, 10:1, 20:1, 30:1, 40:1, or 100:1) such that the nozzle does not become clogged with material particle(s). In some embodiments, the material may be collected by a drainage mechanism through one or more drainage ports that drain material from the material bed into one or more drainage reservoirs. The material in the one or more drainage reservoirs may be re used (e.g., after filtration and/or further treatment).

In some cases, unused material can surround the 3D object in the material bed. The unused material can be substantially removed from the 3D object. Substantial removal may refer to material covering at most about 20%, 15%, 10%, 8%, 6%, 4%, 2%, 1%, 0.5%, or 0.1% of the surface of the 3D object after removal. Substantial removal may refer to removal of all the material that was disposed in the material bed and remained as material at the end of the 3D printing process (i.e., the remainder), except for at most about 10%, 3%, 1%, 0.3%, or 0.1% of the weight of the remainder. Substantial removal may refer to removal of all the remainder except for at most abbot 50%, 10%, 3%, 1%, 0.3%, or 0.1% of the weight of the printed 3D object. The unused material can be removed to permit retrieval of the 3D object without digging through the material bed. For example, the unused material can be suctioned out of the material bed by one or more vacuum ports (e.g., nozzles) built adjacent to the material bed, by brushing off the remainder of unused material, by lifting the 3D object from the unused material, by allowing the unused material to flow away from the 3D object (e.g., by opening an exit opening port on the side(s) or on the bottom of the material bed from which the unused material can exit). After the unused material is evacuated, the 3D object can be removed and the unused material can be re-circulated to a material reservoir for use in future builds.

In some embodiments, the platform may comprise a mesh. The base and/or substrate may comprise a mesh. The 3D object can be generated on a mesh. The mesh holes can be blocked. The mesh holes can be openable (e.g., by a controller and/or manually). A solid platform (e.g., base or substrate) can be disposed underneath the mesh such that the material stays confined in the material bed and the mesh holes are blocked. The blocking of the mesh holes may not allow a substantial amount of material to flow through. The mesh can be moved (e.g., vertically or at an angle) relative to the solid platform by pulling on one or more posts connected to either the mesh or the solid platform (e.g., at the one or more edges of the mesh or of the base) such that the mesh becomes unblocked. The one or more posts can be removable from the one or more edges by a threaded connection. The mesh substrate can be lifted out of the material bed with the 3D object to retrieve the 3D object such that the mesh becomes unblocked. Alternatively, or additionally, the platform can be tilted, horizontally moved such that the mesh becomes unblocked. The platform can include the base, substrate, or bottom of the enclosure. When the mesh is unblocked, at least part of the pre-transformed material flows from the material bed through the mesh while the 3D object remains on the mesh. In some instances, two meshes may be situated such that in one position their holes are blocked, and in the other position, opened. The 3D object can be built on a construct comprising a first and a second mesh, such that at a first position the holes of the first mesh are completely obstructed by the solid parts of the second mesh such that no material can flow through the two meshes at the first position, as both mesh holes become blocked. The first mesh, the second mesh, or both can be controllably moved (e.g., horizontally or in an angle) to a second position. In the second position, the holes of the first mesh and the holes of the second mesh are at least partially aligned such that the material disposed in the material bed is able to flow through to a position below the two meshes, leaving the exposed 3D object.

In some cases, cooling gas can be directed to the hardened material (e.g., 3D object) for cooling the hardened material during and/or following its retrieval. The mesh can be of a size such that the unused material will sift through the mesh as the 3D object becomes exposed from the material bed. In some cases, the mesh can be coupled (e.g., attached) to a pulley or other mechanical device such that the mesh can be moved (e.g., lifted) out of the material bed with the 3D part.

In some cases, a layer of the 3D object can be formed within at most about 1 hour (h), 30 minutes (min), 20 min, 10 min, 5 min, 1 min, 40 seconds (s), 20 s, 10 s, 9 s, 8 s, 7 s, 6 s, 5 s, 4 s, 3 s, 2 s, or 1 s. A layer of the 3D object can be formed within at least about 30 minutes (min), 20 min, 10 min, 5 min, 1 min, 40 seconds (s), 20 s, 10 s, 9 s, 8 s, 7 s, 6 s, 5 s, 4 s, 3 s, 2 s, or 1 s. A layer of the 3D can be formed within any time between the aforementioned time scales (e.g., from about 1 h to about 1 s, from about 10 min to about 1 s, from about 40 s to about 1 s, from about 10 s to about 1 s, or from about 5 s to about 1 s).

The final form of the 3D object can be retrieved soon after cooling of a final material layer. Soon after cooling may be at most about 1 day, 12 hours (h), 6 h, 5 h, 4 h, 3 h, 2 h, 1 h, 30 minutes, 15 minutes, 5 minutes, 240 s, 220 s, 200 s, 180 s, 160 s, 140 s, 120 s, 100 s, 80 s, 60 s, 40 s, 20 s, 10 s, 9 s, 8 s, 7 s, 6 s, 5 s, 4 s, 3 s, 2 s, or 1 s. Soon after cooling may be between any of the aforementioned time values (e.g., from about is to about 1 day, from about is to about 1 hour, from about 30 minutes to about 1 day, or from about 20 s to about 240 s). In some cases, the cooling can occur by method comprising active cooling by convection using a cooled gas or gas mixture comprising argon, nitrogen, helium, neon, krypton, xenon, hydrogen, carbon monoxide, carbon dioxide, or oxygen. Cooling may be cooling to a temperature that allows a person to handle the 3D object. Cooling may be cooling to a handling temperature. The 3D object can be retrieved during a time period between any of the aforementioned time periods (e.g., from about 12 h to about 1 s, from about 12 h to about 30 min, from about 1 h to about 1 s, or from about 30 min to about 40 s).

The generated 3D object can require very little or no further processing after its retrieval. In some examples, the diminished further processing or lack thereof, will afford a 3D printing process that requires smaller amount of energy and/or less waste as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the aforementioned values (e.g., from about 1.1 to about 10, or from about 1.5 to about 5). Further processing may comprise trimming, as disclosed herein. Further processing may comprise polishing (e.g., sanding). For example, in some cases the generated 3D object can be retrieved and finalized without removal of transformed material and/or auxiliary features. The 3D object can be retrieved when the three-dimensional part, composed of hardened (e.g., solidified) material, is at a handling temperature that is suitable to permit the removal of the 3D object from the material bed without substantial deformation. The handling temperature can be a temperature that is suitable for packaging of the 3D object. The handling temperature a can be at most about 120° C., 100° C., 80° C., 60° C., 40° C., 30° C., 25° C., 20° C., 10° C., or 5° C. The handling temperature can be of any value between the aforementioned temperature values (e.g., from about 120° C. to about 20° C., from about 40° C. to about 5° C., or from about 40° C. to about 10° C.).

The methods and systems provided herein can result in fast and efficient formation of 3D objects. In some cases, the 3D object can be transported within at most about 120 min, 100 min, 80 min, 60 min, 40 min, 30 min, 20 min, 10 min, or 5 min after the last layer of the object hardens (e.g., solidifies). In some cases, the 3D object can be transported within at least about 120 min, 100 min, 80 min, 60 min, 40 min, 30 min, 20 min, 10 min, or 5 min after the last layer of the object hardens. In some cases, the 3D object can be transported within any time between the above-mentioned values (e.g., from about 5 min to about 120 min, from about 5 min to about 60 min, or from about 60 min to about 120 min). The 3D object can be transported once it cools to a temperature of at most about 100° C., 90° C., 80° C., 70° C., 60° C., 50° C., 40° C., 30° C., 25° C., 20° C., 15° C., 10° C., or 5° C. The 3D object can be transported once it cools to a temperature value between the above-mentioned temperature values (e.g., from about 5° C. to about 100° C., from about 5° C. to about 40° C., or from about 15° C. to about 40° C.). Transporting the 3D object can comprise packaging and/or labeling the 3D object. In some cases, the 3D object can be transported directly to a consumer.

Systems and methods presented herein can facilitate formation of custom or stock 3D objects for a customer. A customer can be an individual, a corporation, organization, government, non-profit organization, company, hospital, medical practitioner, engineer, retailer, any other entity, or individual. The customer may be one that is interested in receiving the 3D object and/or that ordered the 3D object. A customer can submit a request for formation of a 3D object. The customer can provide an item of value in exchange for the 3D object. The customer can provide a design or a model for the 3D object. The customer can provide the design in the form of a stereo lithography (STL) file. The customer can provide a design where the design can be a definition of the shape and dimensions of the 3D object in any other numerical or physical form. In some cases, the customer can provide a 3D model, sketch, or image as a design of an object to be generated. The design can be transformed in to instructions usable by the printing system to additively generate the 3D object. The customer can provide a request to form the 3D object from a specific material or group of materials (e.g., a material as described herein). In some cases, the design may not contain auxiliary features or marks of any past presence of auxiliary support features.

In response to the customer request the 3D object can be formed or generated with the printing method, system and/or apparatus as described herein. In some cases, the 3D object can be formed by an additive 3D printing process. Additively generating the 3D object can comprise successively depositing and melting a powder comprising one or more materials as specified by the customer. The 3D object can subsequently be delivered to the customer. The 3D object can be formed without generation or removal of auxiliary features (e.g., that is indicative of a presence or removal of the auxiliary support feature). Auxiliary features can be support features that prevent a 3D object from shifting, deforming, or moving during formation.

The 3D object (e.g., solidified material) that is generated (e.g., for the customer) can have an average deviation value from the intended dimensions of at most about 0.5 microns (μm), 1 μm, 3 μm, 10 μm, 30 μm, 100 μm, 300 μm, or less. The deviation can be any value between the aforementioned values (e.g., from about 0.5 μm to about 300 μm, from about 10 μm to about 50 μm, from about 15 μm to about 85 μm, from about 5 μm to about 45 μm, or from about 15 μm to about 35 μm). The 3D object can have a deviation from the intended dimensions in a specific direction, according to the formula Dv+L/K_{Dv}, wherein Dv is a deviation value, L is the length of the 3D object in a specific direction, and K_{Dv} is a constant. Dv can have a value of at most about 300 μm, 200 μm, 100 μm, 50 μm, 40 μm, 30 μm, 20 μm, 10 μm, 5 μm, 1 μm, or 0.5 μm. Dv can have a value of at least about 0.5 μm, 1 μm, 3 μm, 5 μm, 10 μm, 20 μm, 30 μm, 50 μm, 70 μm, 100 μm, or 300 μm. Dv can have any value between the aforementioned values (e.g., from about 0.5 μm to about 300 μm, from about 10 μm to about 50 μm, from about 15 μm to about 85 μm, from about 5 μm to about 45 μm, or from about 15 μm to about 35 μm). K_{dv} can have a value of at most about 3000, 2500, 2000, 1500, 1000, or 500. K_{dv} can have a value of at least about 500, 1000, 1500, 2000, 2500, or 3000. K_{dv} can have any value between the aforementioned values (e.g., from about 3000 to about 500, from about 1000 to about 2500, from about 500 to about 2000, from about 1000 to about 3000, or from about 1000 to about 2500).

The intended dimensions can be derived from a model design. The 3D part can have the stated accuracy value immediately after its formation, without additional processing or manipulation. Receiving the order for the object, formation of the object, and delivery of the object to the customer can take at most about 7 days, 6 days, 5 days, 3 days, 2 days, 1 day, 12 hours, 6 hours, 5 hours, 4 hours, 3 hours, 2 hours, 1 hour, 30 min, 20 min, 10 min, 5 min, 1 min, 30 seconds, or 10 seconds. In some cases, the 3D object can be additively generated in a period between any of the aforementioned time periods (e.g., from about 10 seconds to about 7 days, from about 10 seconds to about 12 hours, from about 12 hours to about 7 days, or from about 12 hours to about 10 minutes). The time can vary based on the physical characteristics of the object, including the size and/or complexity of the object.

The system and/or apparatus can comprise a controlling mechanism (e.g., a controller). The methods, systems, and/or apparatuses disclosed herein may incorporate a controller mechanism that controls one or more of the components described herein. The controller may comprise a computer-processing unit (e.g., a computer) coupled to any of the systems and/or apparatuses, or their respective components (e.g., the energy source(s)). The computer can be operatively coupled through a wired and/or through a wireless connection. In some cases, the computer can be on board a user device. A user device can be a laptop computer, desktop computer, tablet, smartphone, or another computing device. The controller can be in communication with a cloud computer system and/or a server. The controller can be programmed to selectively direct the energy source(s) to apply energy to the at least a portion of the target surface at a power per unit area. The controller can be in communication with the scanner configured to articulate the energy source(s) to apply energy to at least a portion of the target surface at a power per unit area.

The controller may control the layer dispensing mechanism and/or any of its components. The controller may control the platform. The control may comprise controlling (e.g., directing and/or regulating) the speed (velocity) of movement. The movement may be horizontal, vertical, and/or in an angle. The controller may control the level of pressure (e.g., vacuum, ambient, or positive pressure) in the material removal mechanism material dispensing mechanism, and/or the enclosure (e.g., chamber). The pressure level (e.g., vacuum, ambient, or positive pressure) may be constant or varied. The pressure level may be turned on and off manually and/or by the controller. The controller may control the force generating mechanism. For example, the controller may control the amount of magnetic, electrical, pneumatic, and/or physical force generated by force generating mechanism. For example, the controller may control the polarity type of magnetic, and/or electrical charge generated by the force generating mechanism. The controller may control the timing and the frequency at which the force is generated. The controller may control the direction and/or rate of movement of the translating mechanism. The controller may control the cooling member (e.g., external, and/or internal). In some embodiments, the external cooling member may be translatable. The movement of the layer dispensing mechanism or any of its components may be predetermined. The movement of the layer dispensing mechanism or any of its components may be according to an algorithm. The control may be manual and/or automatic. The control may be programmed and/or be effectuated a whim. The control may be according to an algorithm. The algorithm may comprise a printing algorithm, or motion control algorithm. The algorithm may take into account the model of the 3D object.

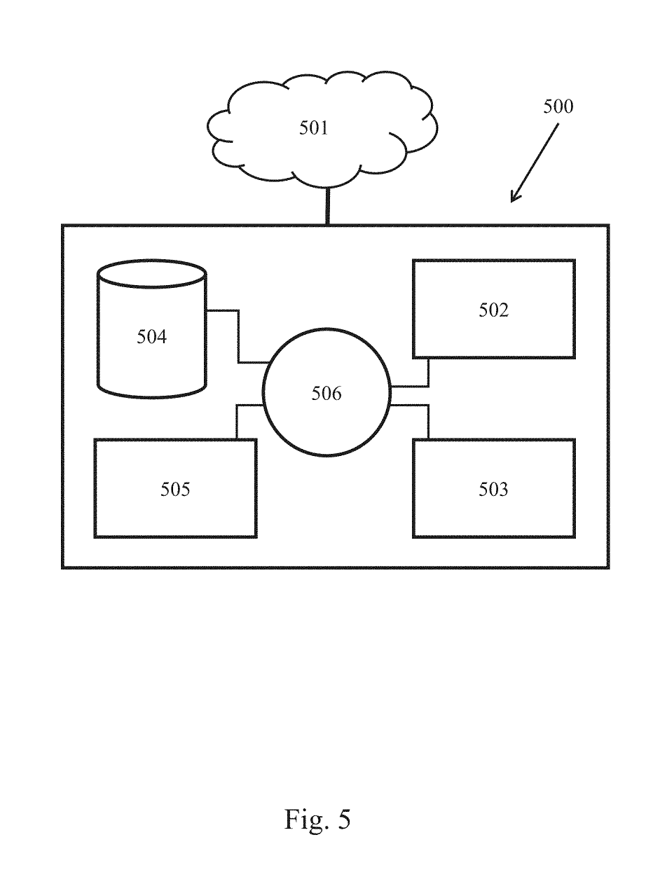

The controller may comprise a processing unit. The processing unit may be central. The processing unit may comprise a central processing unit (herein “CPU”). The controllers or control mechanisms (e.g., comprising a computer system) may be programmed to implement methods of the disclosure. The controller may control at least one component of the systems and/or apparatuses disclosed herein. FIG. 5 is a schematic example of a computer system 500 that is programmed or otherwise configured to facilitate the formation of a 3D object according to the methods provided herein. The computer system 500 can control (e.g., direct and/or regulate) various features of printing methods, apparatuses and systems of the present disclosure, such as, for example, regulating force, translation, heating, cooling and/or maintaining the temperature of a powder bed, process parameters (e.g., chamber pressure), scanning route of the energy source, position and/or temperature of the cooling member(s), application of the amount of energy emitted to a selected location, or any combination thereof. The computer system 500 can be part of, or be in communication with, a printing system or apparatus, such as a 3D printing system or apparatus of the present disclosure. The computer may be coupled to one or more mechanisms disclosed herein, and/or any parts thereof. For example, the computer may be coupled to one or more sensors, valves, switches, motors, pumps, or any combination thereof.

The computer system 500 can include a processing unit 506 (also “processor,” “computer” and “computer processor” used herein). The computer system may include memory or memory location 502 (e.g., random-access memory, read-only memory, flash memory), electronic storage unit 504 (e.g., hard disk), communication interface 503 (e.g., network adapter) for communicating with one or more other systems, and peripheral devices 505, such as cache, other memory, data storage and/or electronic display adapters. The memory 502, storage unit 504, interface 503, and peripheral devices 505 are in communication with the processing unit 506 through a communication bus (solid lines), such as a motherboard. The storage unit can be a data storage unit (or data repository) for storing data. The computer system can be operatively coupled to a computer network (“network”) 501 with the aid of the communication interface. The network can be the Internet, an Internet and/or extranet, or an intranet and/or extranet that is in communication with the Internet. The network in some cases is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 502. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 500 can be included in the circuit.

The storage unit 504 can store files, such as drivers, libraries, and saved programs. The storage unit can store user data, e.g., user preferences and user programs. The computer system in some cases can include one or more additional data storage units that are external to the computer system, such as located on a remote server that is in communication with the computer system through an intranet or the Internet.

The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network.

Methods as described herein can be implemented by way of machine (e.g., computer processor) executable code stored on an electronic storage location of the computer system, such as, for example, on the memory 502 or electronic storage unit 504. The machine executable or machine-readable code can be provided in the form of software. During use, the processor 506 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processor adapted to execute the code, or can be compiled during runtime. The code can be supplied in a programming language that can be selected to enable the code to execute in a pre-compiled or as-compiled fashion.

The processing unit may include one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The integrated circuit chip may comprise at least 0.2 billion transistors (BT), 0.5 BT, 1 BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The multiplicity of cores can be parallel cores. The multiplicity of cores can function in parallel. The multiplicity of cores may include at least 2, 10, 40, 100, 400, 1000, 2000, 3000, 4000, 5000, 6000, 7000, 8000, 9000, or 10000 cores. The multiplicity of cores may include at most 1000, 2000, 3000, 4000, 5000, 6000, 7000, 8000, 9000, 10000, or 40000 cores. The multiplicity of cores may include cores of any number between the afore-mentioned numbers (e.g., from 2 to 40000, from 2 to 400, from 400 to 4000, from 2000 to 4000, or from 4000 to 10000 cores). The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 1 Tera Flops (T-FLOPS), 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 5 T-FLOPS, 6 T-FLOPS, 7 T-FLOPS, 8 T-FLOPS, 9 T-FLOPS, 10 T-FLOPS, 20 T-FLOPS, 30 T-FLOPS, 50 T-FLOPS, 100 T-FLOPS, 1 P-FLOPS, 2 P-FLOPS, 3 P-FLOPS, 4 P-FLOPS, 5 P-FLOPS, 10 P-FLOPS, 50 P-FLOPS, 100 P-FLOPS, 1 EXA-FLOP, 2 EXA-FLOPS or 10 EXA-FLOPS. The number of FLOPS may be any value between the afore-mentioned values (e.g., from about 0.1 T-FLOP to about 10 EXA-FLOPS, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, or from about 10 T-FLOPS to about 30 T-FLOPS, from about 50 T-FLOPS to about 1 EXA-FLOP, or from about 0.1 T-FLOP to about 10 EXA-FLOPS). The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance UNPACK, matrix multiplication (e.g., DGEMM), sustained memory bandwidth to/from memory (e.g., STREAM), array transposing rate measurement (e.g., PTRANS), RandomAccess, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). UNPACK refers to a software library for performing numerical linear algebra on a digital computer. DGEMM refers to double precision general matrix multiplication. STREAM. PTRANS. MPI refers to Message Passing Interface.

The computer system may include hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by Nvidia, ATI Technologies, S3 Graphics, Advanced Micro Devices (AMD), or Matrox. The processing unit may be able to process algorithms comprising a matrix or a vector. The core may comprise a complex instruction set computing core (CISC), or reduced instruction set computing (RISC).

The computer system may include an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

The computer system may include configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration.

The computing system may include an integrated circuit that performs the algorithm (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the algorithm output in at most 0.1 microsecond (μs), 1 μs, 10 μs, 100 μs, or 1 millisecond (ms). The physical unit may produce the algorithm output in any time between the above mentioned times (e.g., from about 0.1 μs, to about 1 ms, from about 0.1 μs, to about 100 μs, or from about 0.1 μs to about 10 μs). In some instances, the controller may use calculations, real time measurements, or any combination thereof to regulate the energy beam(s). In some instances, the real-time measurements (e.g., temperature measurements) may provide input at a rate of at least about 0.1 KHz, 1 KHz, 10 KHz, 100 KHz, 1000 KHz, or 10000 KHz). In some instances, the real-time measurements may provide input at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processing unit may be at least about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may be at most about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may any value between the aforementioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s).

Aspects of the systems, apparatuses, and/or methods provided herein, such as the computer system, can be embodied in programming. Various aspects of the technology may be thought of as “product,” “object,” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

The memory may comprise a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. The memory and/or storage may comprise a storing device external to and/or removable from device, such as a Universal Serial Bus (USB) memory stick, or a hard disk. Many of these forms of computer readable media may be involved in carrying one or more sequences of one or more instructions to a processor for execution.

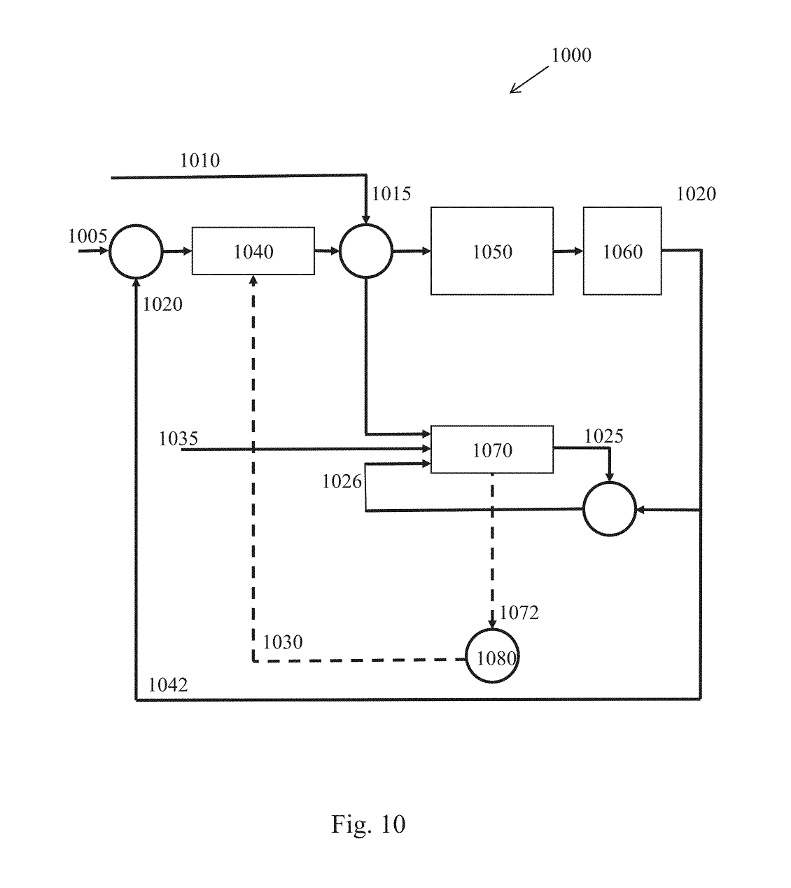

FIG. 10 shows a schematic example of a (e.g., automatic) controller (e.g., control system) 1000 that is programmed or otherwise configured to facilitate the formation of one or more 3D objects. In this example the control system 1000 includes a controller 1040, configured to control a (e.g., at least one) forming 3D object 1050, one or more sensors (e.g. temperature sensor) 1060, one or more computer models for the physical process of 3D printing 1070. The control system may optionally include a (e.g., at least one) feedback control loop such as 1030 or 1042.

In some embodiments, the controller (e.g., FIG. 10, 1040) outputs one or more parameters as part of the 3D printing instructions. At times, the output of the controller is based on one or more parameter inputs (e.g., of a different type). For example, the controller may receive a temperature input and output a power parameter. In some instances, the output parameter is compared with the same type of parameter that was input. For example, the output power parameter can be compared with a power input (e.g., 1015) to generate the printing instructions for the portion of the 3D object. At times, the comparison is a dynamic comparison in real time. At times, the comparison is prior or subsequent to the 3D printing.

The control system 1000 may be configured to control (e.g. in real time) a power, speed, power density, dwell time, energy beam footprint (e.g., on the exposed surface of the material bed), and/or cross-section of an energy beam radiation to a material bed (e.g. powder bed), to maintain a target parameter of one or more forming 3D objects. The target parameter may comprise a temperature, or power of the energy beam and/or source. In some examples, maintaining a target temperature for maintaining on one or more characteristics of one or more melt pools. The characteristics of the melt pool may comprise their FLS, temperature, fluidity, viscosity, shape (e.g., of a melt pool cross section), volume, or overall shape. The control system 1000 may be configured to control (e.g. in real time) a temperature, to maintain a target parameter of one or more forming 3D objects, e.g. a target temperature of one or more positions of the material bed to maintain on one or more melt pools. The one or more positions may comprise a position within a melt pool, adjacent to the melt pool, or far from the melt pool. Adjacent to the melt pool may be within a radius of at least about 1, 2, 3, 4, or 5 average melt pool diameters.

The one or more forming 3D objects can be formed (e.g., substantially) simultaneously, or sequentially. The one or more 3D objects can be formed in a (e.g., single) material bed. The one or more 3D objects can be formed above a (e.g., single) platform. In the example shown in FIG. 10, the controller receives three types of target inputs: (i) energy beam power (e.g., FIG. 10, 1010) (which may be user defined), (ii) temperature (e.g., 1005), and (iii) geometry (e.g., 1035). In some cases, the geometry comprises geometrical object pre-print correction. Examples of geometries and pre-print correction can be found in Patent Application Serial No. PCT/US17/054043 filed on Sep. 28, 2017, titled “THREE-DIMENSIONAL OBJECTS AND THEIR FORMATION,” which is entirely incorporated herein by reference. In some cases, the geometric information derives from the 3D object (or a correctively deviated (e.g., altered) model thereof). The controller may receive a target parameter (e.g., 1005) (e.g. temperature) to maintain at least one characteristic of the forming 3D object. Examples of characteristics of forming 3D objects include temperature and/or metrological information of a melt pool. The metrological information of the melt pool may comprise its FLS. Examples of characteristics of forming 3D objects include metrological information of the forming 3D object. For example, geometry information (e.g. height) of the forming 3D object. Examples of characteristics of forming 3D objects include material characteristic such as hard, soft and/or fluid (e.g., liquidus) state of the forming 3D object. The target parameter may be time varying or location varying or a series of values per location or time. The target parameter may vary in time and/or location. The controller may (e.g., further) receive a pre-determined control variable (e.g. power per unit area) target value from a control loop such as, for example, a feed forward control (e.g., 1010). In some examples, the control variable controls the value of the target parameter of the forming 3D object. For example, a predetermined (e.g., threshold) value of power per unit area may control the temperature of the melt pool of the forming 3D object.

A computer model (e.g. prediction model, statistical model, a thermal model) may predict and/or estimate one or more physical parameters (e.g., 1025) of the forming 3D object. There may be more than one computer models (e.g. at least 1, 2, 3, 4, 5, 6, 7, 8, 9 or 10 different models). The controller may (e.g., dynamically) switch between the computer models to predict and/or estimate the one or more physical parameters of the forming 3D object. Dynamic includes changing computer models (e.g., in real time) based on a user input, or a controller decision that may be based on monitored target variables of the forming 3D object. The dynamic switch may be performed in real-time (e.g., during the forming of the 3D object). Real time may be, for example, during the formation of a layer of transformed material, during the formation of a layer of hardened material, during formation of a portion of a 3D object, during formation of a melt pool, or during formation of an entire 3D object. The controller may be configured (e.g., reconfigured) to include additional one or more computer models and/or readjust the existing one or more computer models. A prediction of the one or more parameters of the forming 3D object may be done offline (e.g. predetermined) or in real-time. The at least one computer model may receive sensed parameter(s) value(s) from one or more sensors. The sensed parameter(s) value(s) may comprise temperature sensed within and/or near one or more melt pools. Vicinity may be within a radius of at least about 1, 2, 3, 4, or 5 average melt pool FLS from a forming melt pool. The computer model may use (e.g., in real-time) the sensed parameter(s) value(s) for a prediction and/or adjustment of the target parameter. The computer model may use (e.g., in real-time) geometric information associated with the requested and/or forming 3D object (e.g. melt pool geometry). The use may be in real-time, or off-line. Real time may comprise during the operation of the energy beam and/or source. Off-line may be during the time a 3D object is not printed and/or during “off” time of the energy beam and/or source. The computer model may compare a sensed value (e.g., by the one or more sensors) to an estimated value of the target parameter. The computer model may (e.g., further) calculate an error term (e.g., 1026) and readjust the at least one computer model to achieve convergence (e.g., of a desired or requested 3D model with the printed 3D object).

The computer model may estimate a target variable (e.g., 1072). The target variable may be of a physical phenomenon that may or may not be (e.g., directly) detectable. For example, the target variable may be of a temperature that may or may not be (e.g., directly) measurable. For example, the target variable may be of a physical location that may or may not be (e.g., directly) measurable. For example, a physical location may be inside the 3D object at a depth, that may be not directly measured by the one or more sensors. An estimated value of the target variable may be (e.g., further) compared to a critical value of the target variable. At times, the target value exceeds the critical value, and the computer model may provide feedback to the controller to attenuate (e.g., turn off, or reduce the intensity of) the energy beam (e.g., for a specific amount of time). The computer model may set up a feedback control loop (e.g., 1030) with the controller. The feedback control loop may be for the purpose of adjusting one or more target parameters to achieve convergence (e.g., of a desired or requested 3D model with the printed 3D object). In one embodiment, the computer model may predict (i) an estimated temperature of the melt pool, (ii) local deformation within the forming 3D object, (iii) global deformation and/or (iv) imaging temperature fields. The computer model may (e.g. further) predict corrective energy beam adjustments (e.g. in relation to a temperature target threshold). The adjustment predictions may be based on the (i) measured and/or monitored temperature information at a first location on the forming 3D object (e.g. a forming melt pool) and/or (ii) a second location (e.g. in the vicinity of the forming melt pool) and/or (iii) geometric information (e.g. height) of the forming 3D object. The energy beam adjustment may comprise adjusting at least one control variable (e.g. power per unit area, dwell time, cross-sectional diameter, and/or speed). In some embodiments, the control system may comprise a closed loop feed forward control, that may override one or more (e.g., any) corrections and/or predictions by the computer model. The override may be by forcing a predefined amount of energy (e.g. power per unit area) to supply to the portion (e.g., of the material bed and/or of the 3D object). Real time may be during formation of at least one: 3D object, slice (e.g., layer) within the 3D object, dwell time of an energy beam along a path, dwell time of an energy beam along a hatch line, dwell time of an energy beam forming a melt pool, or any combination thereof. The control may comprise controlling a cooling rate (e.g., of a material bed or a portion thereof); control the microstructure of a transformed material portion, or control the microstructure of at least a portion of the 3D object. Controlling the microstructure may comprise controlling the phase, morphology, FLS, volume, or overall shape of the transformed (e.g., and subsequently solidified) material portion. The material portion may be a melt pool.

The computer system can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms that have been pre-programmed. The feedback mechanisms may rely on input from sensors (described herein) that are connected to the control unit (i.e., control system or control mechanism e.g., computer). The computer system may store historical data concerning various aspects of the operation of the 3D printing system. The historical data may be retrieved at predetermined times and/or at a whim. The historical data may be accessed by an operator and/or by a user. The historical and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output the amount of oxygen, water, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

The system and/or apparatus described herein (e.g., controller) and/or any of their components may comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen. The system and/or apparatus described herein (e.g., controller) and/or any of their components may comprise Bluetooth technology. The system and/or apparatus described herein (e.g., controller) and/or any of their components may comprise a communication port. The communication port may be a serial port or a parallel port. The communication port may be a Universal Serial Bus port (i.e., USB). The system and/or apparatus described herein (e.g., controller) and/or any of their components may comprise USB ports. The USB can be micro or mini USB. The USB port may relate to device classes comprising 00 h, 01 h, 02 h, 03 h, 05 h, 06 h, 07 h, 08 h, 09 h, 0Ah, 0Bh, 0Dh, 0Eh, 0Fh, 10 h, 11 h, DCh, E0 h, EFh, FEh, or FFh. The system and/or apparatus described herein (e.g., controller) and/or any of their components may comprise a plug and/or a socket (e.g., electrical, AC power, DC power). The system and/or apparatus described herein (e.g., controller) and/or any of their components may comprise an adapter (e.g., AC and/or DC power adapter). The system and/or apparatus described herein (e.g., controller) and/or any of their components may comprise a power connector. The power connector can be an electrical power connector. The power connector may comprise a magnetically coupled (e.g., attached) power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

The systems, methods, and/or apparatuses disclosed herein may comprise receiving a request for a 3D object (e.g., from a customer). The request can include a model (e.g., CAD) of the desired 3D object. Alternatively, or additionally, a model of the desired 3D object may be generated. The model may be used to generate 3D printing instructions. The 3D printing instructions may exclude the 3D model. The 3D printing instructions may be based on the 3D model. The 3D printing instructions may take the 3D model into account. The 3D printing instructions may be based on simulations. The 3D printing instructions may use the 3D model. The 3D printing instructions may comprise using an algorithm (e.g., embedded in a software) that takes into account the 3D model.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. An apparatus for printing a three-dimensional object comprising at least one controller that is operatively coupled to one or more of a target surface, an energy source, an optical fiber, and a detector, which controller is programmed to:
(I) direct a first energy beam to transform a pre-transformed material to a transformed material as part of the three-dimensional object disposed, which transform is at or adjacent to a target surface, which transformed material and/or target surface generates (i) a second energy beam that is different from the first energy beam and/or (ii) a thermal radiation; and
(II) direct one or more of (i) the second energy beam and (ii) the thermal radiation, to an optical fiber.

2. The apparatus of claim 1, wherein the optical fiber is operatively coupled to a detector.

3. The apparatus of claim 2, wherein the at least one controller is operatively coupled to the detector and directs the detector to produce a result.

4. The apparatus of claim 3, wherein the at least one controller directs an alteration of the energy beam based on the result.

5. The apparatus of claim 1, wherein direct one or more of (i) the second energy beam and (ii) the thermal radiation, to an optical fiber is through one or more optical elements.

6. The apparatus of claim 5, wherein at least one of the one or more optical elements comprises a high thermal conductivity optical element.

7. The apparatus of claim 5, wherein the one or more optical elements comprises sapphire, crystal quartz, zinc selenide (ZnSe), magnesium fluoride (MgF₂), calcium fluoride (CaF₂), fused silica, borosilicate, silicon fluoride, or Pyrex®.

8. The apparatus of claim 2, wherein the detector is configured to detect a temperature of a position of (a) a footprint of the energy beam on the pre-transformed material and/or the target surface, and/or (b) a vicinity of the footprint in (a).

9. The apparatus of claim 8, wherein the vicinity of the footprint in (a) extends to at most six fundamental length scales of the footprint in (a).

10. The apparatus of claim 8, wherein configured to detect a temperature is indirectly through measurement of at least one characteristic of the returning radiation.

11. The apparatus of claim 2, wherein the detector is configured to output a result, and the at least one controller is configured to direct adjusting at least one characteristic of the energy source and/or energy beam considering the result.

12. The apparatus of claim 2, wherein the detector is configured to output a result, wherein the at least one controller is configured to direct adjusting at least one characteristic of the printing considering the result.

13. The apparatus of claim 12, wherein the adjusting and/or considering is in real time during the printing.

14. The apparatus of claim 12, wherein the adjusting and/or considering comprises using a control scheme that includes open loop and/or closed loop control.

15. The apparatus of claim 12, wherein the adjusting and/or considering comprises using a control scheme that includes feedback and/or feed-forward control.

16. The apparatus of claim 2, wherein the detector comprises an optical detector.

17. The apparatus of claim 1, wherein the second energy beam has a different wavelength, polarity, intensity, and/or beam profile, than the first energy beam.

18. The apparatus of claim 1, wherein the second energy beam is a returning portion of the first energy beam from an irradiation position.

19. The apparatus of claim 18, wherein the returning portion is from the first energy beam irradiating the pre-transformed material and/or the target surface.

20. The apparatus of claim 18, wherein the returning portion is from a deflection of the first energy beam using one or more optical elements, which deflection occurs in a first portion of an optical path preceding a second portion of the optical path of the first energy beam, which optical path follows irradiating the pre-transformed material.

21. The apparatus of claim 1, wherein the second energy beam is a returning portion a thermal radiation emerging from an irradiated portion of the pre-transformed material and/or target surface, which irradiated is by the energy beam.

22. The apparatus of claim 1, wherein the optical fiber is included in an optical fiber bundle, wherein the optical fiber bundle comprises a plurality of optical fibers.

23. The apparatus of claim 22, wherein the plurality of optical fibers is operatively coupled to one or more single pixel detectors.

24. The apparatus of claim 22, wherein the plurality of optical fibers comprises a central fiber and engulfing fibers that engulf the central fiber.

25. The apparatus of claim 24, wherein the central fiber is coupled to a first detector and the engulfing fibers are connected to a second detector.

26. The apparatus of claim 25, wherein the first detector and/or the second detector is a single pixel detector.

27. The apparatus of claim 25, wherein the first detector is configured to detect a first radiation emerging from the footprint of the energy beam, and the second detector is configured to detect a second radiation emerging from a vicinity of the footprint of the energy beam.

28. The apparatus of claim 27, wherein the first radiation correlates to a first temperature, and wherein the second radiation correlates to a second temperature.

29. The apparatus of claim 28, wherein the at least one controller controls at least one characteristic of the first energy beam based on the first temperature, second temperature, or on a variation between the first temperature and the second temperature.

30. The apparatus of claim 29, wherein the at least one characteristic comprises power density, focus, cross section, beam profile, velocity of translation along the target surface, dwell time, intermission time, or power density profile over time.

31. The apparatus of claim 29, wherein the at least one characteristic of the first energy beam is controlled in real time during the printing.

32. The apparatus of claim 1, wherein the at least one controller is configured to direct translating the target surface laterally during the printing in relation with a translation of the first energy beam.
